(19) United States
(12) Patent Application Publication
(10) Pub. No.: US 2025/0386085 A1
(43) Pub. Date: Dec. 18, 2025

(54) ARRAY CAMERA METHODS AND ARRANGEMENTS

(71) Applicant: Transformative Optics Corporation, Portland, OR (US)

(72) Inventor: David J. Brady, Tucson, AZ (US)

(21) Appl. No.: 19/234,706

(22) Filed: Jun. 11, 2025

Related U.S. Application Data
(60) Provisional application No. 63/659,125, filed on Jun. 12, 2024.

(51) Int. Cl. H04N 23/45; G03B 13/34; H04N 23/55; H04N 23/90; H04N 23/951; H04N 25/11

(52) U.S. Cl. CPC H04N 23/45; H04N 23/90; H04N 23/951; G03B 13/34; H04N 23/55; H04N 25/11

(57) ABSTRACT

Detailed camera systems and methods achieve rich light field sampling within limited cost and power constraints. Exemplary arrangements include designs for heterogeneous array cameras, including multifocal arrays, arrays matching depth of field to have uniform pixel density, array-aware focus, exposure and frame rate control, multispectral arrays, and multiscale arrays. One embodiment incorporates lens assemblies of two different types: a first type in which all lens elements move under control of a focus actuator, and a second type in which only some of the lens elements move under control of a focus actuator—the others are stationary. A great number of other features and arrangements are also detailed.

### RELATED APPLICATION DATA

This application claims priority from copending provisional application 63/659,125, filed Jun. 12, 2024.

The present technology is also related to that detailed in copending provisional applications 63/740,985, filed Dec. 31, 2024, 63/761,969, filed Feb. 22, 2025, and 63/788,687, filed Apr. 14, 2025.

The above-referenced applications are incorporated by reference, as if fully set forth herein.

### INTRODUCTION

This disclosure concerns, in part, array camera systems. Known array camera systems employ multiple imagers to capture pixel data across a field of view, and enable the collected pixel data to be combined and rendered to yield desired frames of imagery at desired resolutions. Applicant's previous Mantis array camera systems are exemplary.

The present disclosure improves and extends the prior art in various respects, e.g., detailing how to capture as much information as possible (richer light field sampling), and how to evaluate the relationships between the captured data and the object(s) of interest, within limited cost and power consumption constraints.

Among the novel arrangements detailed herein are designs for heterogeneous array cameras, including multifocal arrays, arrays matching depth of field to have uniform pixel density, array-aware focus, exposure and frame rate control, multispectral arrays, and multiscale arrays.

One particular arrangement is a heterogeneous camera array comprising plural imagers. One or more of the imagers produces monochromatic (panchromatic) data, one or more of the imagers includes a filter array and produces plural differently-filtered channels of data, one or more of the imagers has a first effective focal length (hereafter simply “focal length”), one or more of the imagers has a second focal length different than the first focal length, one or more of the imagers produces data at a first frame rate, and one or more of the imagers produces data at a second frame rate different than the first frame rate.

Another particular arrangement is a heterogeneous camera array in which plural of the imagers produce monochromatic data, plural of the imagers include a filter array and produce plural differently-filtered channels of data, plural of the imagers produce data at a first frame rate, and plural of the imagers produce data at a second frame rate different than the first frame rate.

Still another particular arrangement is a heterogeneous camera array comprising N camera modules of M different capture configurations, where M is at least 4, and N is at least 2, 3, 5 or 10 times greater than M. In some arrangements, first and second imagers (or capture modules) of an array camera system each includes a lens assembly that comprises plural lens elements and a variable focus actuator. In some such embodiments, the variable focus actuator of the first imager serves to move one or more—but not all—of the lens elements of the first imager lens assembly. In certain embodiments, the variable focus actuator of the second imager serves to move all of the lens elements of the second imager lens assembly.

A great variety of other novel arrangements are also detailed.

The foregoing and other features and advantages of the present technology will be more readily apparent from the following detailed description, which proceeds with reference to the accompanying drawings.

### BRIEF DESCRIPTION OF THE DRAWINGS

FIG. 1 shows a prior art ISP pipeline.

FIG. 2 shows an ISP pipeline for a computational photography system.

FIG. 3 shows demosaiced raw pixels of a color scene (left) along with a view of the scene and a detail of the scene estimated with 4_Lanczos4 upsampling.

FIG. 4 shows the Red channel of the image shown in FIG. 3.

FIG. 5 is an example of 16×16 element blocks drawn from FIG. 4

FIG. 6 shows blocks from FIG. 5 represented as 256 element vectors. The vectors are vertically offset for clarity.

FIG. 7 shows a subset of the 899×256 matrix formed by all block elements drawn from FIG. 4.

FIG. 8 shows principal components of the 16×16 blocks of the red channel of the image shown in FIG. 3.

FIG. 9 shows a rate distortion curve for the red channel of the image shown in FIG. 3 represented on the PCA basis.

FIG. 10 shows principal component singular values for random measurement strategies. The top curve is the PCA spectrum of the original image. The second highest curve reflects 4× compression using uniformly distributed bipolar weights. The third highest curve reflects 4× downsampling by adding the signals from randomly selected groups of 4 pixels within each block. The lowest curve reflects 4× compression with uniformly distributed positive weights.

FIG. 11 shows principal component singular values for spectral measurement strategies. The top curve is the PCA spectrum of the original color image. The second highest curve reflects measurement using a Bayer RGB color filter array. The three lower curves are the PCA spectral of the red, green and blue channels individually.

FIG. 12 shows representative pixel spectra from the Indian Pines hyperspectral image (top), principal component spectrum of the pixel spectra (center) and the seven lowest order PCA loadings (bottom). The loadings are shifted vertically for visual clarity.

FIG. 13 is an RGB photo of colored beads.

FIG. 14 shows representative pixel spectra from the bead data cube (top), principal component spectrum of the pixel spectra (center) and the five lowest order PCA loadings (bottom).

FIG. 15 shows the 16 lowest order loadings for PCA of 16 pixel by 31 spectral channel PCA of the bead data set.

FIG. 16 shows coding for multiframe multiplexing. The image (a) and its horizontal mirror image are each multiplied by a random binary codes drawn from [0; 1] and then added together, as shown in (b). (c) is a low pass filtered image of (b) multiplied by (code 1-0.5). (d) is a low pass filtered image of (b) multiplied by (code 2-0.5).

FIG. 17 shows coding strategies for compressive temporal imaging. The left image corresponds to a utter shutter or strobe, the center to a moving coded aperture and the right to a random space-time detection or illumination mask.

FIG. 18 shows example reconstructions for a neural reconstruction of 28× compressive sampling of the MNIST digits using CACTI and flutter shutter. The top row is ground truth. The second row assumes that a random code is used for each temporal frame, the imager takes a snapshot by integration along the temporal axis. The third row uses simple CACTI and the fourth row uses the utter shutter code of FIG. 17.

FIG. 19 shows serial time-encoded amplified microscopy (STEAM) architecture. (Reprinted from [345].) FIG. 20 shows sampling patterns for global shutter, progressive rolling shutter and interlaced rolling shutter with 50% exposure duty cycle.

FIG. 21 shows short exposure measurements of a simple 1D spatial/temporal signal (illustrated at top) using a global shutter (second row), progressive rolling shutter (third row) and interlaced rolling shutter (fourth row).

FIG. 22 shows data cube coverage for interlaced rolling shutter (top) and random row rolling shutter (bottom).

FIG. 23 shows simulated measurements and reconstructions for progressive (top), random row (center) and designed rolling shutter sampling. Measurements are in (a), ground truth in (b), linear interpolation reconstruction in (c), total variation reconstruction in (d) and neural estimator in (e). (Reprinted from supplementary material in

.)

FIG. 24 shows globally tone mapped image using correction for various values of γ.

FIG. 25 shows output pixel value relative to saturation as a function of input pixel value for γ equal to 2 (bottom curve), 1, 0.5 and 0.25 (top curve).

FIG. 26 shows algorithmically tone mapped images.

FIG. 27 shows image pairs drawn from the CiFAR10 image dataset [184]. The left image in each pair is in focus, the right image is defocused by a Gaussian filter with φ randomly drawn from [0; 3].

FIG. 28 shows a scatter plot of neural estimated defocus and ground truth for a network trained on the CIFAR10 dataset.

FIG. 29 shows geometry for ranging using stereo images.

FIG. 30 shows geometry for 3D object characterization using structured illumination.

FIG. 31 shows geometry in an epipolar plane for scanning with an illumination pencil beam.

FIG. 32 shows an image of a periodic object. The plots at the bottom show cross sections in the near, middle and far field.

FIG. 33 shows example height and reflectance pattern for a model object. The z-axis plots height and the surface color map is reflectance.

FIG. 34 shows example reconstructions for neural estimation with coded illumination.

FIG. 35 shows example height reconstructions (left) and cross sections through selected rows (right). The solid lines are the ground truth and the dotted figures are estimates from the UNet.

FIG. 36 shows design analysis of a simple single glass (BK7) singlet lens.

FIG. 37 shows MTF and spot diagram for the lens of FIG. 36 rescaled by 0.1×.

FIG. 38 shows optical layout of a five element wide-field of view lens. (Reprinted from [386].)

FIG. 39 shows design analysis of a compound lens with 62.5 mm focal length.

FIG. 40 shows an example design of a monocentric multiscale imaging system. (Reprinted from [261].)

FIG. 41 shows a cost curve developed from lens design. (Reprinted from [39].) FIG. 42 shows the imaging side of a simple smartphone (generated by DALL-E).

FIG. 43 shows a smartphone with a microcamera array (generated by DALL-E).

FIG. 44 shows a wide angle view of a baseball game (generated by DALL-E).

FIG. 45 shows details at a baseball game (generated by DALL-E).

FIG. 46 shows vertical fields of view of ballpark cameras.

FIG. 48 shows an approaching drone fleet (generated by DALL-E).

FIG. 49 shows the Starlink-2256 satellite, captured by a single William Optics telescope at 200 FPS. (Left) The cumulative SNR and single-pixel SNR obtained from averaged single-pixel signal and noise values. (Right) Average of about 600 frames corresponding to an effective exposure of 3 s. The faint diagonal line is the satellite passing by Sirius, the brightest star in the night sky. (Reprinted from [12].)

FIG. 50 shows sensor layout for a large scale multiscale imager.

FIG. 51 shows cars along a highway (generated by DALL-E).

FIG. 52 shows imager field of view along a corridor.

FIG. 53 shows a spinning baseball at release (generated by DALL-E).

FIG. 54 shows smart headlights (generated by DALL-E).

FIG. 55 shows automotive lidar (generated by DALL-E).

FIG. 56 shows ranging by illumination with a uniformly redundant array.

FIG. 57 is used to explain effective focal length.

### DETAILED DESCRIPTION

This disclosure builds on, and should be read in the context of, applicant's previous work-particularly the applications identified in the Related Application Data paragraphs above, patent publications US20200059606, WO2020061732, WO2024147826, U.S. Pat. Nos. 9,395,617, 10,462,343, 10,477,137, 10,944,923, 11,523,051 and 12,047,692, patent application Ser. No. 19/013,418, filed Jan. 8, 2025, and the papers: Pang and Brady, “Distributed Focus and Digital Zoom,” arXiv preprint, arXiv: 1909.06451 (2019); Brady, D.J., Pang, W., Li, H., Ma, Z., Tao, Y. and Cao, X., “Parallel Cameras,” Optica, 5 (2), pp. 127-137 (2018); and Brady et al, “Smart cameras,” ar Xiv preprint arXiv: 2002.04705, Feb. 11 2020. These documents are incorporated here by reference.

Applicant teaches and intends that the technology detailed below be implemented in the systems disclosed in the documents of the preceding and introductory paragraphs, and that the technology disclosed in such paragraphs be implemented in the systems disclosed below.

Much of the following disclosure is drawn from a draft academic text concerning computational optical imaging. Such text and the below excerpts are copyrighted by the author, David Brady. David Brady has no objection to the facsimile reproduction by anyone of a published patent document containing the included excerpts, or of the associated Patent and Trademark Office patent file or records, but otherwise reserves all copyright rights. Earlier portions of the text are omitted from this disclosure as they largely review prior art already familiar to the artisan. The footnoted articles cited below are hereby incorporated by reference, as if bodily set forth herein.

### Multiframe Fusion

Multiframe image fusion is an important technology in computational imaging. Multiframe fusion is core to panoramic image stitching, but as discussed below, it is also essential to high dynamic range imaging, focal stacking, multispectral imaging, high frame rate imaging and other applications. We defer discussion of the motivation and design of multiframe capture systems to that later disclosure; the goal of this section is simply to introduce historic and emerging multiframe fusion algorithms.

Artisans are familiar with how to find key points and align images taken from different perspectives. Once we have used homography to transform an image taken from one perspective onto the view point of another camera, one can align the images at the keypoints and add them together to create a combined image.

Conventionally, the two images being combined have substantially the same field of view. However, the same methods may be applied to images with much less overlap. Panoramic stitched images are created by matching keypoints at the edges of such images. Once one of the images is transformed to the view point of the other image, the images may be blended to create a wider field of view panograph. In some arrangements, each fused pixel uses the value of just one the original images. More sophisticated blending algorithms combine data from multiple pixels or pixel neighborhoods. Multiresolution splices are used in classic algorithms [45]. This approach creates a blending mask to define the transition region between the images. Mask values indicate how much of each source image should contribute to the final blended image at each point. The mask itself can be smoothly varied using splines, ensuring that the transition between images is smooth.

As with other areas of image processing, neural methods are impacting image fusion. A review of early methods is presented in [34]. As suggested there, neural methods enable revolutionary perspectives. Where alignment and blending are pixel-based, neural methods may be feature-based. This allows neural methods to combine frames of diverse data types, including combining multiresolution, multispectral, multitemporal and multifocal frames. Instead of stitching an identical set of narrow field frames to create a panorama, multiresolution processing may use a wide field low resolution camera as a reference point in combining unconnected high resolution frames [336].

Neural methods may be used to solve the various steps in multiframe fusion, as in keypoint matching [382], homography estimation and blending or neural methods may implement end-to-end multiframe fusion. End-to-end systems are impacted by the emergence of transformer neural networks. Transformers emerged in the context of large language models as a mechanism for relating the local identity of features with their long-range context. This makes sense for sequential signals, like speech, which require word interpretation in the context of sentence and paragraph meaning. More broadly, these methods suggest signal analysis using large-scale algorithms with multiple functions.

In imaging systems, features arise over a wider spatial range than words and features embedded in a higher dimensional space than serial audio. This leads to potential explosion in complexity. Shifted window vision transformers manage this complexity by considering image features through a multiscale process. Huang et al. further reduce complexity by using physical camera geometry to limit the range of attention in transformer networks [156]. As an example, Huang's network can be employed to create a high resolution image from a low resolution color photograph and a high resolution monochrome (panchromatic) photograph. This is achieved by abstracting features from each image using a convolutional network. Features in corresponding physical neighborhoods are scored and used to generate combined features, which are then decoded to construct a jointly estimated data. This approach can be applied to images taken under diverse circumstances, including different manifolds in time, spectra and polarization. Relatedly, a color image can be reconstructed from four frames, captured by a monochrome, green-specific, red-specific and blue-specific camera. Separating capture onto these manifolds enables independent control of focal state and exposure-time, potentially improving the dynamic range and focus of each channel. Additionally, since a monochrome channel has greater quantum efficiency, it can capture data at a higher frame rate. The design space opened by these approaches is explored in a following discussion. As discussed there, one may now choose between sampling smooth planar manifolds in the spatio-temporal-spectra-polarization optical data cube or interlaced sampling.

While transformer networks provide a powerful platform for estimating a scene from disjoint data, they encompass substantial computational complexity. As discussed in the complexity increases in the product of image pixel count, the number of images fused, the feature neighborhood and the object dimension. This leads to 2-3 orders of magnitude more processing steps per pixel than simple ISP compression. In a video array camera system one ought not recompute the stitching structure on every frame. One may best consider transformer-based systems as an expression of an endpoint of potential processing strategies.

Associated image signal processing, including demosaicing, color adjustments, gain, denoising and compression, is best implemented on application specific integrated circuits (ASICs). While the development of

active pixel sensors is justly heralded as an enabling technology for computational photography, the development of imaging signal processing ASICs is less renowned but of equal importance. Video rate image signal processing ASICs were first developed in the 1980's [335], but since compression is the primary

computing task of such devices, the video image signal processing pipeline (ISP) matured with compression standards developed in the 1990s [23].

Conventional ISP image enhancements exclusive of compression are discussed in [98]. Recent studies focus on replacing the conventional sequence of denoising, dynamic range and color adjustment and interpolation with

neural processing [307]. This transition and integration of the computational imaging methods described herein can benefit from innovation in ASIC design. In the case of mobile devices, tensor processing units (TPU) for image coprocessing are increasingly common and diverse designs for heterogeneous neural ISP ASICs are emerging [206].

An important point for this section is that multiframe image fusion is a novel ISP task. Integration of this task into the core of camera design and operation changes the basic data flow of ISP function. This transition is analogous to the transition of computer design from vector processing CPUs to multiprocessor/multicore design.

This transition became deeply embedded in computer design over a generation ago [259], but is just occurring now in camera design. One may, in fact, view the emergence of GPU and TPU processing as part of the ever continuing trend to increased parallelism.

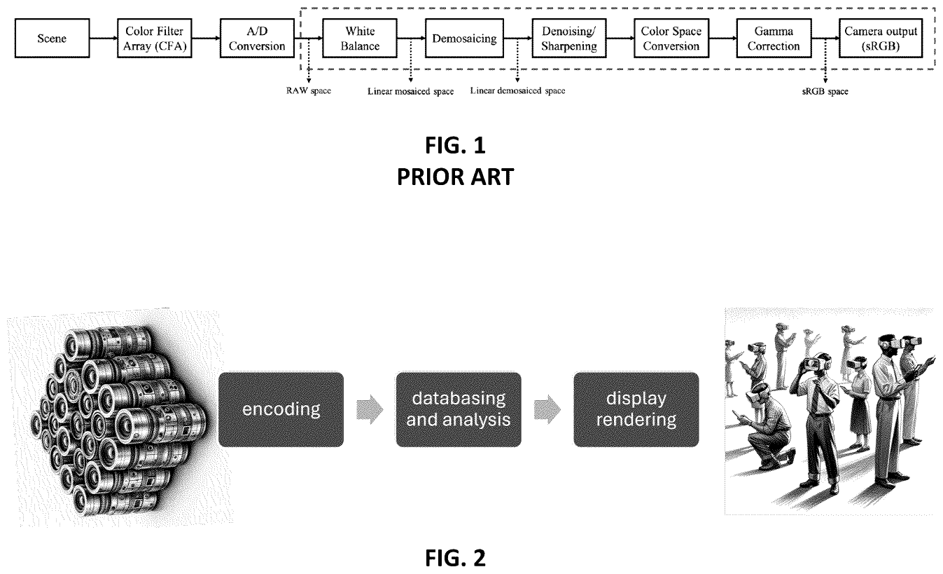

A conventional ISP (e.g., FIG. 1), in contrast, remains a serial pipeline. The core assumption is that the captured focal image, after some modest color and gain adjustments, is the display image. The ISP is a serial mapping of the captured image to the display; a 4K 30 frames per second camera encodes a standard compressed 4K 30 frames per second image to the display. The fundamental premise of computational imaging, in contrast, is that there is no ismorphic pixel by pixel mapping between sensor data and the display.

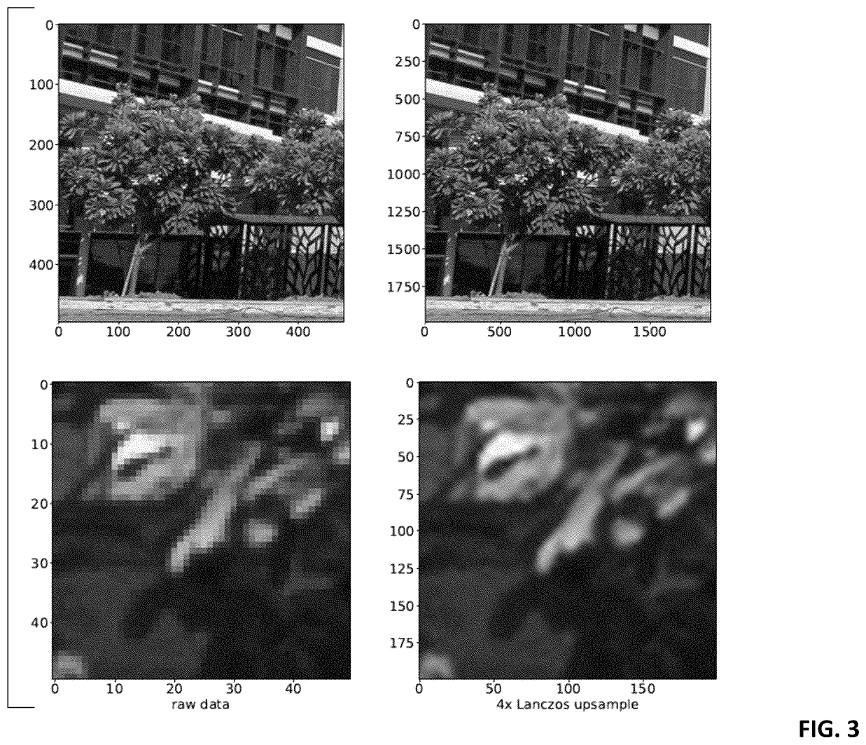

FIG. 2 presents a conceptual model for the computational photography ISP pipeline. A multiscale sensor array captures data. Multiscale in this case means that the array may consist of an array of microcameras with various characteristics (different color sampling, different frame rates, different focal lengths, etc.). At the fine scale, each camera captures focal images, but on the broader scale the ISP combines all of this data. The purpose of the first stage of the ISP is simply to compress the array data stream into a manageable data load. This data is transferred to an intermediate data layer for analysis and storage. A critical issue here is that the sensor system likely captures substantially more data than is needed for any given analytical or display task. When data is needed for analysis or display, a render layer in the ISP requests the relevant data and processes it for display. Multiple independent display and analysis agents may request different renderings from the data stream in parallel.

Since much of the captured data may never be needed for analysis or display, this architecture ideally delays image tasks, such as multiframe fusion, tone mapping and color estimation, focal stacking, etc., until the display end of the ISP. This approach is in contrast with conventional ISP, which fully processes sensed data prior to compression and encoding. This delayed processing approach, however, enables processing intensive operations, such as transformer networks without expending massive processing power per sensed pixel.

The array camera ISPs discussed here are not yet commercially available. They rely on sophisticated models for the data encoding layer. Neural radiance fields and 3D Gaussian splatting are recent examples of strategies to represent multiframe data. Although these techniques have primarily been applied to representations of diverse viewpoints, the data structure approach underlying them is consistent with the emerging array camera ISP. While representations derived from these approaches must be integrated with the physical designs discussed in this disclosure to achieve functional computational imagers, we maintain our focus on the physical layer in the discussion that follows.

### Measurement Design

### Shuffling, Slicing and Parallel Processing

As indicated, a core issue in imaging design is that measurements are embedded in a lower dimensional space than objects. The spatial transformation between object space and image space in focal systems is three dimensional. In addition to spatial dimensions, optical fields include spectral, polarization and temporal information. A challenge of camera design is to maximize sensitivity to desired optical information spanning the full six dimensional data cube using measurements on 2D focal plane arrays. The data cube is also sometimes called the light field, and cameras designed to capture it are called light field cameras.

Nominally, one might attempt to measure the light field by independently sampling each voxel. This approach is both impossible and unwise.

In the present discussion we consider how to balance the conflict between measurements that might be mathematically attractive and measurements that are physically possible or convenient. The three basic approaches to light field sampling are
1. Interleaved sampling, or shuffling. Snapshot compressive imaging consists of collapsing the multidimensional data cube onto 2D sensor arrays with spatially varying coding patterns. The Bayer color filter array is a ubiquitous example of this approach. Micropolarizer arrays may similarly be used for polarization imaging [128, 401] and microlens arrays in integral or plenoptic [5, 250] cameras take this approach with respect to focus.
2. Temporal scanning, or slicing. Sweeping the focal, spectral and temporal sampling parameters of a camera over multiple exposures captures slices of the data cube. For example, a tunable filter can be used to capture color planes sequentially or focal sweeping can be used to capture focus planes.
3. Parallel sampling. Camera arrays can be used to capture either slices or diverse interleaved samples of the data cube.

These approaches are not orthogonal and can be used in various combinations. Matching these strategies to available resources and desired sensitivity is important to computational imaging system design.

We describe and analyze examples of these approaches in the discussion that follows. We begin by abstractly reconsidering the mathematical structure of image measurement. Subsequent sections review sampling strategies to capture color, video, dynamic range and depth. Adaptive control of exposure, focus and illumination is useful to efficient data cube acquisition. For reasons discussed, array cameras are also a particularly powerful tool for light field imaging. Granularity, meaning how much data should each subaperture of a parallel sampling system capture, is an important design issue. A later discussion presents examples in heterogeneous array design.

### Feature-Specific Measurement

We define the optical data cube, or light field, for a system to be the set of all possible measurements that the system could make on the optical field. The data cube is a superset of the measurements actually made by the system because making one measurement typically precludes making another. Taking an actual picture involves setting the focus, exposure and color filter, despite the fact that these settings impact the measured data. This section discusses mathematical tools for evaluating the impact of these settings and strategies for optimizing sampling. We apply these tools in the context of specific measurement systems in subsequent sections.

We may represent the data cube as ƒ(θ, λ, p, t), where (θx, θy, θz) is the object distribution viewed from viewpoint p in projective coordinates. We could represent that data cube using coherence functions or wave fields, but for present purposes we assume that we are observing an incoherent radiator fully defined by its volumetric spectral radiance. One could also expand the data cube to include polarization. Continuing with our present definition, we further assume measurements are linear in the radiance such that:

$$g ( ϕ , p ) = \int f ( θ , λ , p , t ) h ( ϕ , θ , λ , p , t ) d θ d λ dt$$

where θ represents 3D projective spatial coordinates and φ parameterizes a 2D focal plane. Imaging system design consists largely of selection of h and an algorithm for estimation of f from g. In the context of cameras, we have assumed that our goal is simply to make h as compact as possible over its sampling range. This strategy, however, does not work for multidimensional objects. The primary challenge of light field imaging is that one is either physically unable or practically unwilling to completely and uniformly sample f. One addresses this challenge by selecting h to optimize system performance.

Selection of h balances physical feasibility and computational simplicity. To measure color features, for example, a common selection uses mosaicked color filter arrays. This choice is physically simple and allows simple linear interpolation to recover the 3D RGB data cube from 2D data. In another example, panoramic imagers often use array cameras. This choice decreases physical lens complexity but increases computational requirements. In each case other choices could be made; for example one can alternatively use array cameras to measure color and one can attempt to capture panorama with fish-eye lenses. In subsequent discussion we will discuss tradeoffs in each of these particular applications. The goal of the present discussion is to consider general evaluation criteria behind these selections. The fidelity of the reconstructed signal f is one such criteria, but one may also consider system size, weight, power, cost, computational complexity and data bandwidth.

Feature-specific imaging is one approach to maximizing measurement efficiency. Under this approach, one attempts to tailor h to match specific features. A feature is distribution over the object data cube, ψ(θ, λ, p, t). The feature may be drawn from a set of basis functions or may be discovered based on some structure of interest. A feature specific imaging system takes measurements g=rf(x)ψ(x)dx projecting the scene onto the features. Features may be drawn from a wavelet or DCT basis or may be learned on a neural compressor. In this sense, one can consider feature specific measurement as the first layer in an encoding network. An underlying idea is that while any measurement system consists of measuring projections of the scene using sampling functions, deliberate design of these sampling functions within measurement constraints may improve system performance.

The idea of representing a signal on a minimal feature set is familiar. Principal component analysis (PCA) and independent component analysis (ICA) are popular strategies for selecting such a feature set. Here we use PCA as an illustrative example. PCA considers the set of possible images as a stochastic process. To model this process, let fᵢ be a representative set of images. Here we consider fᵢ to be an N dimensional vector of pixel values, such that the value of the jₜₕ pixel in the it image is fᵢⱼ. Since the image is drawn from a random process, we may define the expected value, μⱼ, and the variance,

$${σ}_{j}^{2} ,$$

of the jₜₕ pixel. These values may be estimated from sample data according to:

$${μ}_{j} = \frac{1}{M} {\sum }_{i} {f}_{ij} and$$

$${σ}_{j}^{2} = \frac{1}{M} {\sum }_{i} {\vert {f}_{ij} - {μ}_{j} \vert}^{2}$$

where we assume M sample images are given. Constructing the M×N matrix F in which each row corresponds to one of the characteristic images, the mean and variance may equivalently be expressed as

$$μ = \frac{1}{M} {F}^{†} 1$$

where 1 is the M dimensional vector of ones, and

$$Σ = \frac{1}{M} {F}^{†} F - {μμ}^{†}$$

where Σ is the covariance matrix such that

$${σ}_{j}^{2} = {Σ}_{jj} .$$

The pixel basis is just one representation of f. One may express the image on a different basis such as

f=Σₗuₗvₗ,

where vₗ are the orthonormal basis vectors of the new basis and vₗ are the components of the image f on the new basis. Note that the mean and variance of the image is

$$〈 {v}_{l} 〉 = {μ}^{†} {v}_{l} and {σ}^{2} = \frac{1}{M} {v}_{l}^{†} {F}^{†} {Fv}_{l} .$$

Principal component analysis begins with the question “which basis vector vₗ produces the greatest variance σ²?” The answer to this question is found using the singular value decomposition of F. The answer is somewhat simpler if we limit our attention to the mean subtracted image space F̅=F−mu. The SVD of F=UAV′ consists of a unitary M×M matrix U and a unitary N×N matrix V connected by the diagonal M×N matrix A, with the diagonal elements/representing the singular values corresponding to the lₜₕ singular vectors. The singular values are nonnegative and ordered from greatest to least. Using SVD, the variance for basis vector vₗ is

$${σ}^{2} = \frac{1}{M} {v}_{l}^{†} V {Λ}^{†} Λ {V}^{†} {v}_{l} = \frac{1}{M} {\sum }_{n} {λ}_{n}^{2} {\vert {v}_{n}^{†} {v}_{l} \vert}^{2} .$$

σ² is maximal if vₗ corresponds to the lowest order singular vector and the sequence of vectors with successively greater variance corresponds identically to the spectrum of singular vectors. In the language of principal component analysis, the object space singular vectors are the principal component loadings and the data side vectors UA are the principal components of \tilde{F}. If one chooses to represent the images fᵢ on a subset of a basis, then the mean square error in the representation will be equal to the sum of the variances of the omitted basis functions. This means that the first L PC loadings represent a minimum mean square error representation of the image on L basis vectors. For this reason, principal component analysis is often used to reduce the dimensionality of data.

One can find the principal components of a class of images by gathering and analyzing a representative sample of the class. If the images are megapixel scale, however, then the features ψ(x) will also be distributions on this scale. To address this, one can break the images into blocks and looks for features of more modest size.

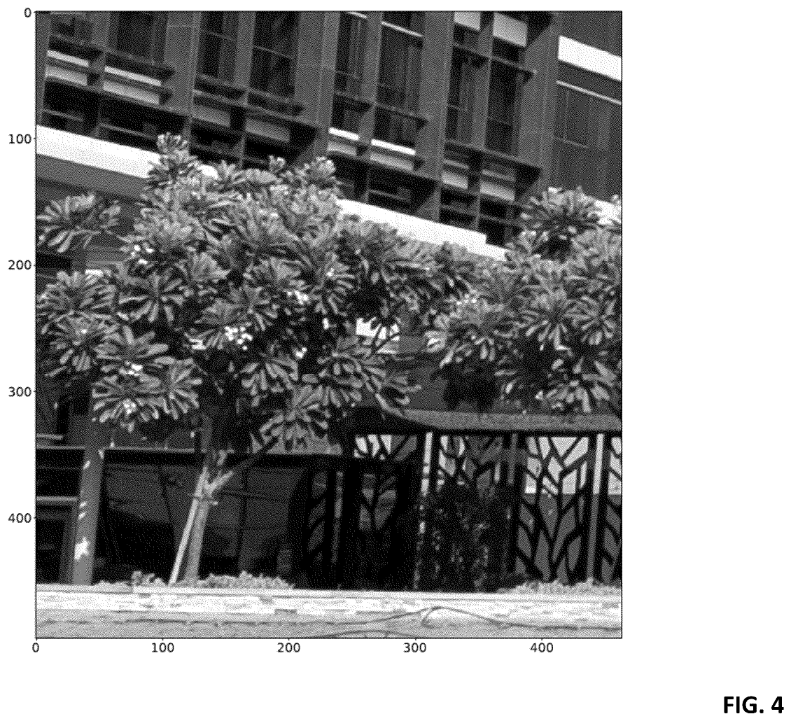

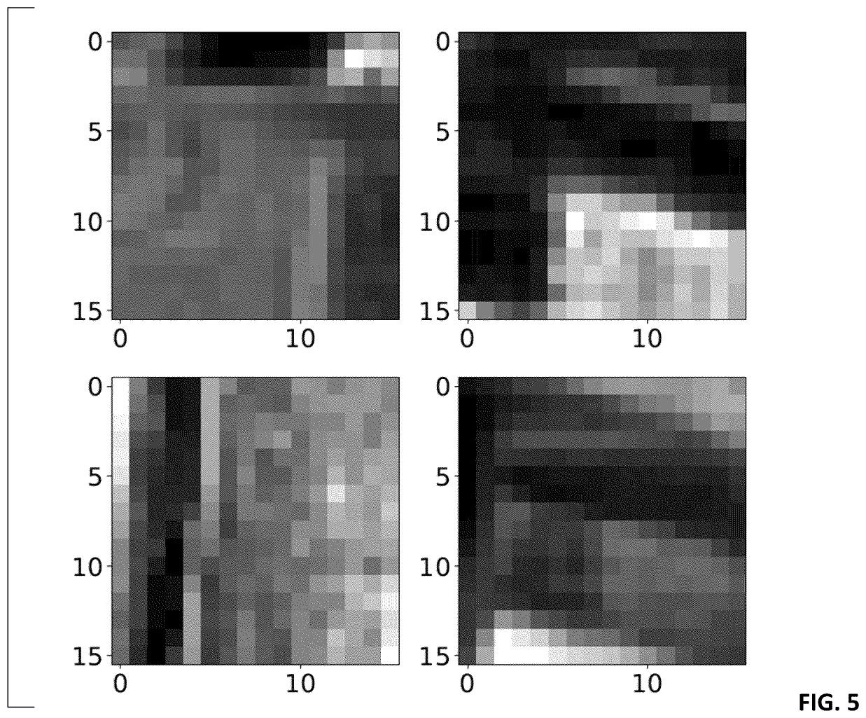

Using this approach, one may even train the features of an image on the image itself. For example, the trees and the building shown in FIG. 3 constitute a 496×464 pixel RGB image. For simplicity, we initially consider PCA analysis of just the red channel of this image, which is shown in FIG. 4.

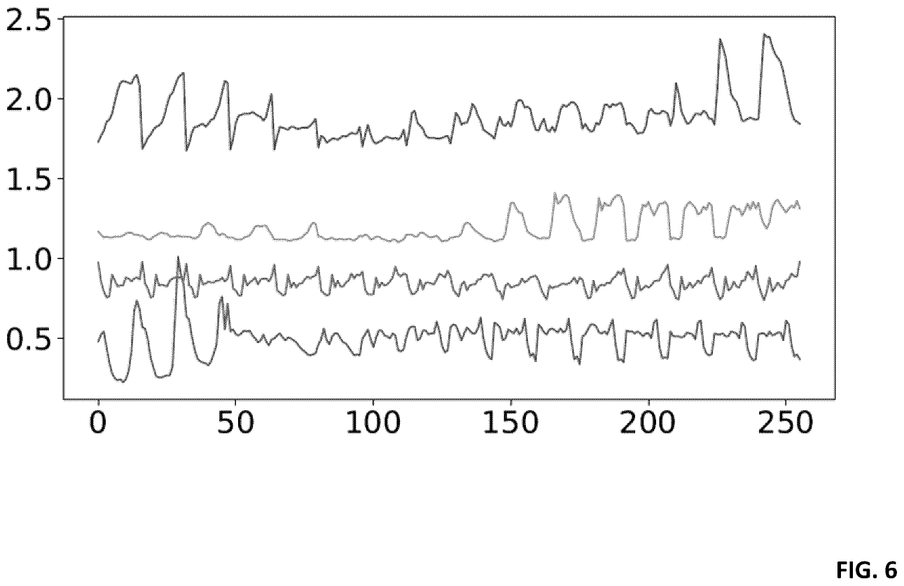

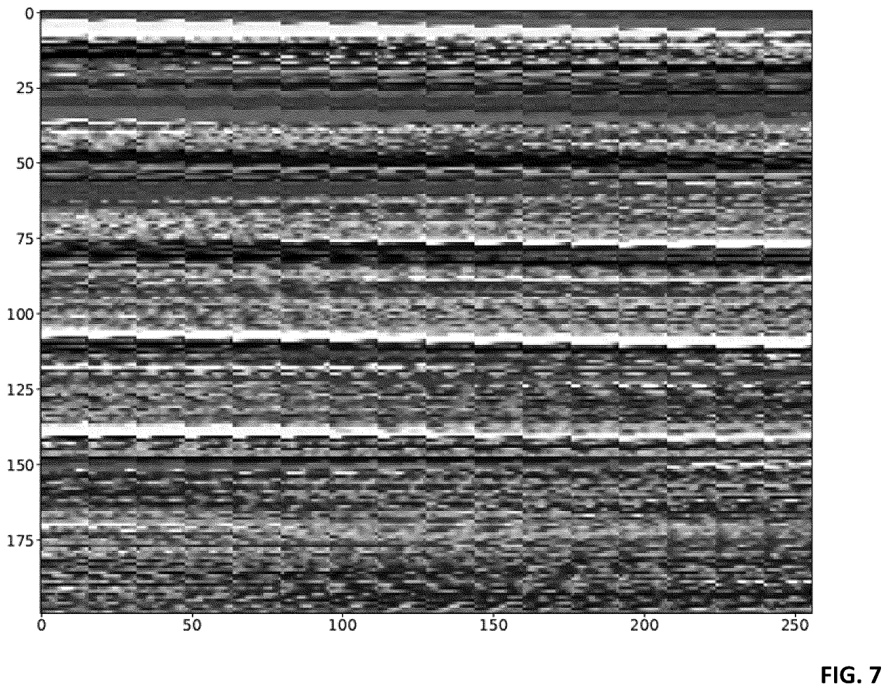

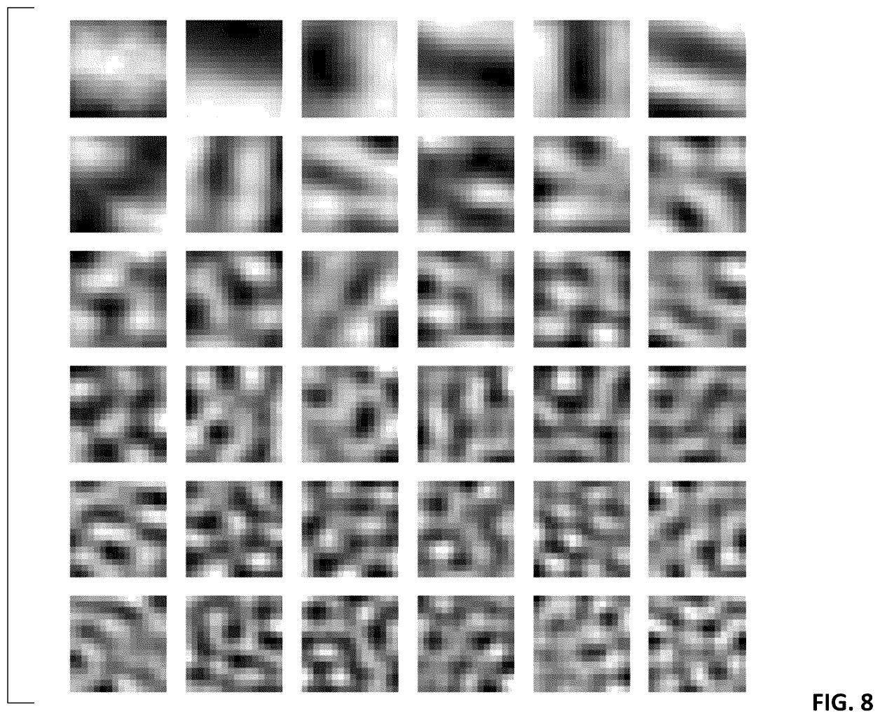

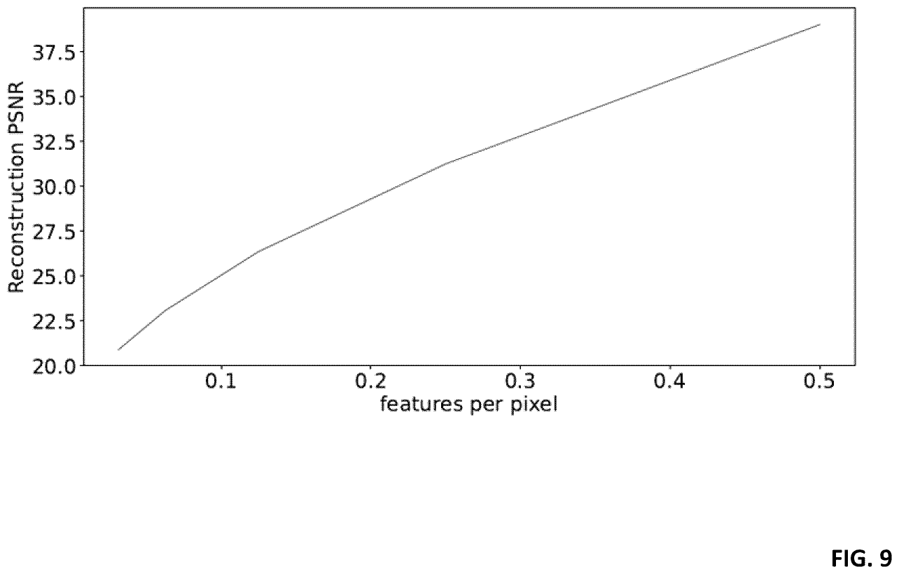

Breaking this image in 16×16 pixel blocks yields 899 example vectors of the distribution of possible blocks. 4 example blocks present in the image are shown as 16×16 element subimages in FIG. 5. For PCA analysis, these blocks are reshaped into 256 element vectors, as shown in FIG. 6. The set of all such vectors forms F, a subset of which is shown in FIG. 7. FIG. 8 shows the 36 lowest order PC loadings (out of 256) found by singular vector analysis of F. Each component is represented by a 16×16 pixel feature. Notice that the principal component loadings appear similar to a Fourier basis, which is a commonly observed characteristic for principal components on natural images, which tend to cluster information around low spatial frequencies.

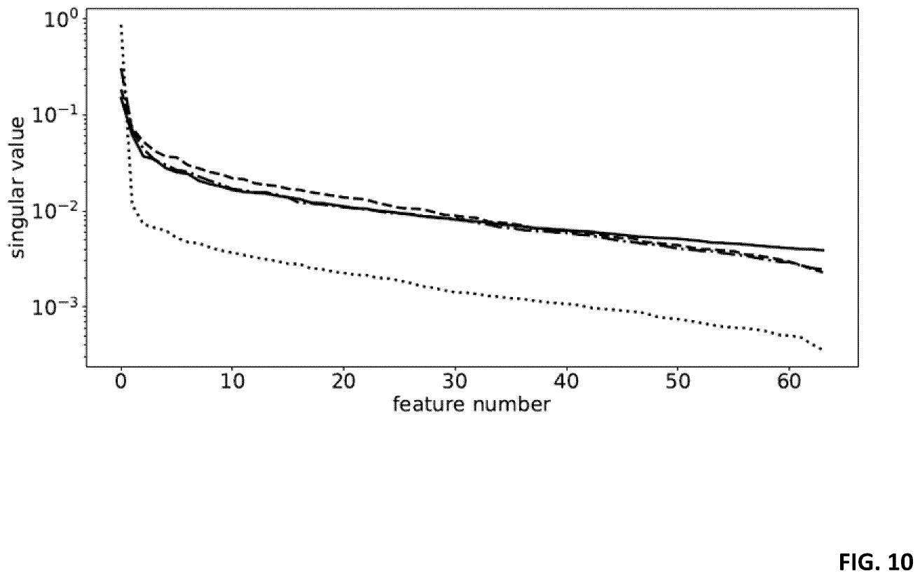

Assuming that one could select measurement kernels h to correspond directly to the PC loadings, one could set compression levels and system performance by simply choosing how many features to measure. FIG. 9 is a rate distortion curve for the above image and PCA distribution. The “features per pixel” measure along the x-axis corresponds to the number of PCA loadings used to represent each 16×16 pixel block in the images, the vertical axis is the PSNR value of the resulting reconstruction. Note that the learned PCA basis yields outstanding PSNR. In general, however, it is not physically possible to directly measure projections onto the PCA basis.

The form of measurement transformations in imaging systems is limited by bandpass limitations and, ultimately, by the constant radiance theorem [31, 33]. The fact that only the irradiance is measurable is, however, the most fundamental restriction on optical measurement. Letting measurement take the form g=Hf and leaving discussion of actual measurement strategies to subsequent sections, we consider abstract constraints such as non-negativity, hᵢⱼ>0, and energy conservation.

Σⱼhᵢⱼ<1.

Given a representative distribution of images and knowing the forward model H, one can create a set measurements G=HF and perform principal component analysis on G. When we actually make measurements, a second form of randomness arises from noise.

Principal component analysis can be used to evaluate measurement strategies. Measurements take the form of linear projections of the object components fᵢ, such that gᵢ=Hfᵢ. Just as F samples the space of possible object states, G=HF samples the range of the measurement space. The forward model H projects the object space on to the measurement space. H may decrease the linear span of the principal components of F, but cannot increase the span of the system. While the linear span of the principal components is an imperfect measure of the information capacity of the system, without prior constraints suggesting that the data value of one feature exceeds that of another the number of principal components needed to describe a system with given SNR is a useful measure. One can, for example, evaluate the effectiveness of a measurement strategy by observing its impact on the PCA spectrum. The PCA spectrum is the ordered list of SVD eigenvalues, with each eigenvalue corresponding to the signal variance for that component. Normalizing the spectrum by the sum of the eigenvalues, each component describes the fraction of the total signal variance explained by that loading. Except for the impact of noise, a measurement cannot increase the variance of the signal. Since measurement projects the signal onto a reduced vector space, the typical effect is to reduce the signal variance.

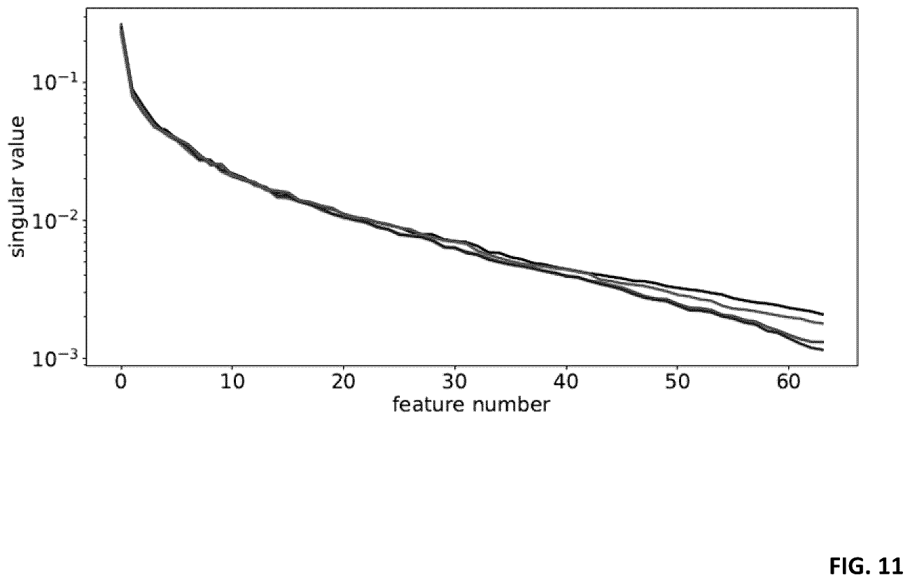

As an example, FIG. 10 plots the PCA spectrum of G for the object space of FIG. 8. The solid curve assumes that H=I; the identity mapping. Here we immediately confront a primary reason that optical systems cannot directly measure PCA components; the weights of H are real and nonnegative. If we select the weights to be uniformly distributed between 0 and 1, as in the lowest curve in FIG. 10, then the lowest order singular vector of H, and ultimately the lowest order principal component of G corresponds to the mean of the signal. As is the case with rotational shear interferometer based imaging, in a shot noise environment the noise in this system is dominated by the noise coming from lowest spatial frequency. The curves in FIG. 10 are normalized by the sum of the spectrum, for random positive weights PCA components beyond the lowest order have singular values reduced by Mx, where is M is the number of measurements. In the present example, M=64. One can implement negative weights in the measurement system electronically. One can consider neuromorphic focal planes that measure weighted sums of pixel values. Such a system could produce the measurement PCA spectrum shown in the dashed curve of FIG. 10, for which the weights hᵢⱼ are uniformly drawn from the range [−.5,.5]. Alternatively, one could measure sparse random linear combinations of the components of fᵢ. In the dash-dot curve of FIG. 10, each measurement consists of the sum of four randomly selected pixels drawn from each 16×16 block of the image. Each pixel is selected only once, such that the rows of H are orthogonal. The measurement matrix is size 64×256. Such sparse kernel strategies enable compressive measurement without radically reducing the PCA spectrum of the system.

As illustrated by this example, feature analysis is a powerful tool in evaluating measurement strategy. Ultimately, the performance of a computational imaging system should be evaluated through end-to-end functional analysis, but developing and testing an inversion strategy for every coding strategy is unnecessarily convoluted. PCA, or other feature analysis strategies, enable quick and simple algorithm-independent evaluation of measurement strategies. Measurement strategies cannot improve the PCA spectrum of an identity-matrix-based measurement. The quality of a measurement strategy can be evaluated by how well it maintains the underlying object PCA spectrum.

As an example, consider spectral imaging. One wishes to characterize f(x, λ), where x spans the 2D plane, but one is only able to make measurements of the form

g(x)=∫ƒ(x)h(x,λ)dλ.

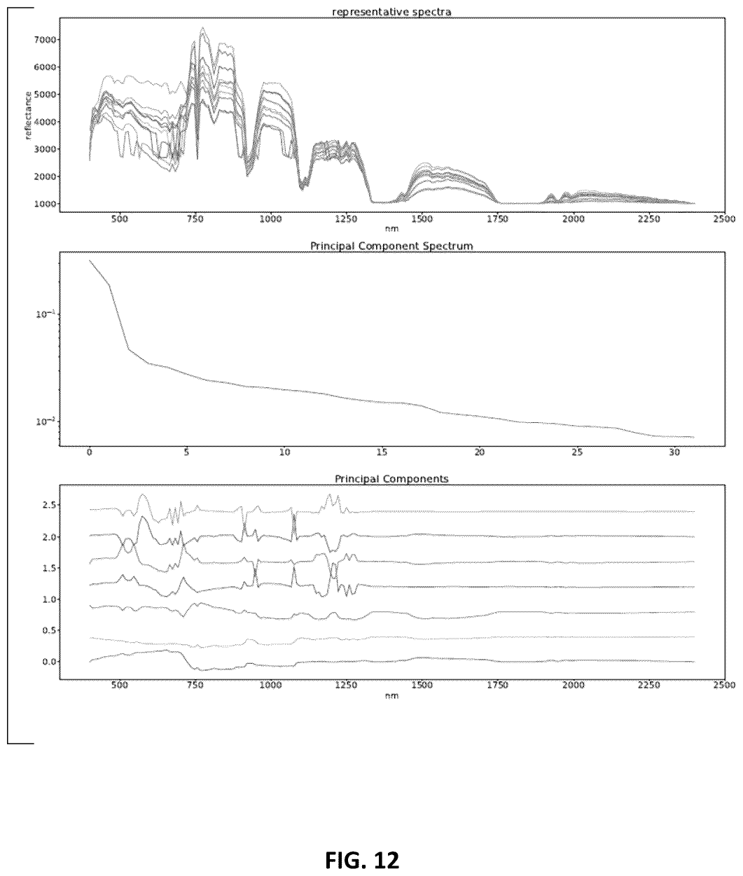

We discuss spectral imaging in more detail below; here we use it only as an example of the use of PCA analysis to evaluate measurement strategy. FIG. 11 compares the PCA spectra for G=HF for the RGB color image of FIG. 3 sampled in three different ways. The components of F correspond to 8×8×3 data blocks drawn from the image, which contains 3596 such blocks. The top curve is the PCA spectrum of F. The bottom three curves are the PCA spectra for the red, green and blue channels individually (e.g. we assume that g (x) in each case is a measure of only a single spectral channel). The red and green PCA spectra overlay and are indistinguishable in this example. The reduction in the PCA values is due to the fact that information is lost by measuring only a monochrome image. However, if the spectral images were entirely independent, one would expect the number of PCA components at each variance level to triple, which does not occur here. The second highest trace corresponds to the PCA spectrum for the images measured using the Bayer RGB color filter array. Since the underlying picture was actually taken using Bayer array, this trace is very close to the object PCA spectrum.

The point of the analysis thus far is to emphasize (1) that multiplex measurement comes at a cost to the feature sensitivity of the system but (2) multiplexing is necessary to efficient measurement and measurement of multi-dimensional objects.

Spectral analysis can be performed using MTF and SVD tools to characterize measurement systems. These tools, powerful as they are, are not useful in explaining why we may choose to subsample spatial, temporal and spectral degrees of freedom. Learned features derived from the actual statistics of target images fill this gap and enable us to design efficient more efficient measurements. We consider a problem using features drawn from a single image, but the methods discussed here can be generalized to analyze measurement of broad classes of image data.

### Spectral Imaging

Color imaging, in which one seeks to characterize the 3D data cube f(x, y, 1), is the most common example of 3D optical imaging. Physical mechanisms for spectral discrimination, as reviewed in detail in include refractive and diffractive dispersion, interferometry, optical resonance and materials absorption. The utility of a spectral coding scheme can be characterized by resolving power (a measure of the number of different spectral features one can discriminate), etendue (a measure of the numerical aperture of the spectral instrument) and system volume. Various forms of spectral measurement are known. For instance, there are absorptive filters using dyes (e.g., RGB filters); there are coded aperture filters with dispersive elements; and there is interferometric measurement by Fourier transform spectroscopy. Given such background, we focus on which spectral features should be measured, rather than on how to measure them.

As in most tomographic imaging examples, the core problem is that the measurements used to characterize f are embedded in 2D. Three basic strategies for capturing spectral data are considered. A first strategy interlaces color sampling across the measurement plane (e.g., using mosaiced sampling that employs a spectral filter on each measurement pixel). A simple forward model for this approach is:

$$g ( x , y ) = \int f ( x , y , λ ) t ( x , y , λ ) d λ$$

The spectral sampling function tₙₘ(λ) may be encoded at different pixels by placing micro-filters over each physical pixel, or by application of coded apertures [9, 52]. The second strategy consists of making distinct measurements for different wavelength channels. The forward model for this case is:

$${g}_{n} ( x , y ) = \int f ( x , y , λ ) {t}_{n} ( λ ) d λ$$

Measurements can be made with a diversity of spectral filters tₙ(λ) by temporally modulating the filter response (using, for example, a liquid crystal tunable filter) or by building an array of cameras with different filters [112, 316]. A third technique, pushbroom spectral imaging, measures slices of the spectral data cube drawn from yλ planes. Its forward model is:

$${g}_{n} ( y , λ ) = \int f ( x , y , λ ) {t}_{n} ( x ) dx$$

Ideally,

tₙ(x)=δ(x−nΔ)

such that the pushbroom sweeps planes through the data cube in sequence. This system can be constructed using a slit spectrometer, the yλ plane is isolated by the slit and dispersed onto a 2D detector using a grating or prism [33].

There are advantages and disadvantages to each spectral image sampling strategy. Color filter array sampling is mathematically straightforward and produces compact imaging systems but reduces the spatial sampling rate in transverse image channels. It is also physically more challenging to construct. Slicing the datacube using either a filter or a slit either gives up temporal resolution by requiring a scan to collect the data cube or requires an array of parallel imagers. Such methods are computationally more challenging because they require fusion of data collected at diverse points in space or time. Our goal is not to establish any of these methods as optimal. In fact, as we shall shortly see, combinations of these methods may outperform simpler approaches. Our goal is rather to develop methods for evaluating sampling strategy in the context of computational imager design and to provide tools to confidently analyze such systems.

Nominally, it may seem that interlaced sampling is better than sampling slices of the data cube. To explain this point, we turn briefly to the concepts of Shannon information and channel capacity. The information capacity of a channel is equal to the product number of the number independent modes transmitted through a channel and the logarithm of the dynamic range in measuring each mode. This result, however, assumes that the mode amplitudes are independent and that the amplitudes are uniformly distributed over the dynamic range. If m is a potential measurement value for a particular signal component, the mean information obtained by measuring the component is:

$$I = - {\sum }_{m} p ( m ) log p ( m )$$

$$I = - {\sum }_{m} p ( f ( B ) = m \vert f ( A ) ) log p ( f ( B ) = m \vert f ( A ) )$$

The mean information obtained in measuring f(B) is maximal if

p(f(B)=m|f(A))=1/M,

where M is the number of possible measurement values. In this case

I=log M.

### However, if the

p(f(B)=m|f(A))

is concentrated around the value of f(A), the information obtained by measuring f(B) may be much less.

In considering the mutual information of points A and B one may consider the distance between these points in the embedding space. One may safely assume that

p(f(B)=m|f(A))

is highly concentrated on f(A) as the distance between B and A approaches zero and that as this distance approaches infinity

p(f(B)=m|f(A))→p(f(B)),

meaning that the measurement at B becomes independent of the measurement at A. For this reason, if one is allowed to make only M measurements on a data cube, then the information obtained from these measurements may be maximized if the mean separation between the measurements is maximized. Since interlaced sampling disperses measurements over the full data cube with maximal separation, interlaced sampling may maximize the initial rate of information transfer. This supposition is confirmed by the singular value spectra of FIG. 11, which shows that interlaced sampling of a single frame with a color filter array essentially matches the spectrum obtained by measuring three frames of spectral slices. Conversely, however, this means that if one chooses to measure the full data cube by, for example, shifting the spatial position of the interlaced sampling system, the information rate of the second and third frames measured by the interlaced system is less than the rate for a scanned spectral slice imager in those frames.

If the goal is to measure as much information as possible in a single frame, interlaced sampling seems like a clear winner. The constraint that measurements correspond to just single voxels in the data cube is unfortunate; more commonly one may choose each measurement to consist of multiplexed groups of voxels or projections through the data cube. For three color imaging, cyan, yellow and magenta filters, consisting of combinations of red, green and blue, may be selected to increase sensitivity and quantum efficiency [4]. For multispectral or hyperspectral imaging, multiplex projections may similarly provide higher sensitivity. In each case, these projections are spread densely across the data cube to, potentially, maximize information transfer. However, there are reasons to consider localized sampling strategies. One reason may be that data is not distributed uniformly over the data cube. If, for example, image features of interest are disproportionately concentrated in the red channel or if the blue channel has as substantially different probability distribution than the green and red channels, more information may be obtained measuring slices or compact manifolds in the data cube. In making this choice, one should also consider the cost of measurement. Information transfer measures the value of data, but physical design should also consider the cost of making a measurement. In spectral imaging there is typically an implicit assumption that time is valuable. If one has unlimited time to make a measurement (e.g. the object is static), then all measurement strategies may obtain the same information. In addition to time, there may be a cost to making achromatic lenses and broadband sensors. Systems that can adapt focus and exposure time to different spectral bands may then obtain the data cube at lower cost. Consider the pulse oximeter as an example. Pulse oximetry measures the oxygen saturation level (SpO2) in blood [237]. Hemoglobin, the protein in red blood cells that carries oxygen, absorbs light differently depending on whether it's oxygenated or deoxygenated. By shining light through the skin and measuring how much light is absorbed, the oximeter can determine the percentage of hemoglobin that's oxygenated. In principle, one could measure a full absorption spectrum, but since one is only interested in a single parameter, chooses only to measure the differential spectrum between a red band and a near-infrared band with maximal absorption disparity. Pulse oximetry also isolates the signal from other absorption features by temporally filtering on the periodic pulse associated with blood flow. This two band differential spectroscopy method is the most common quantitative use of spectral measurement. Spatio-spectral encoding and

detection strategies can be used to code differential spectroscopy for tomographic imaging [26]. For present purposes, a main point is that in this, as well as most other spectral imaging applications, the designer is wiser to focus on measuring features of most relevance to the imaging purpose, rather than uniformly sampling the data cube.

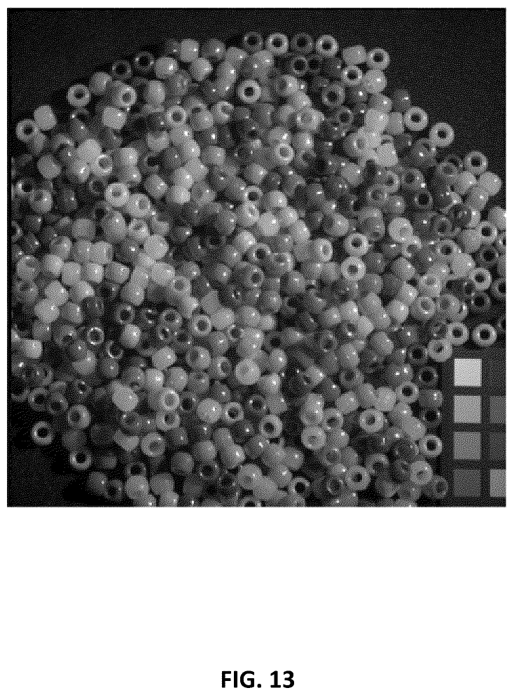

Consider coded aperture snapshot tomography of the earth-observing NASA AVIRIS spectral dataset. AVIRIS is a pushbroom dispersive spectrometer flown on aircraft; it captures spatio-spectral 2D slices, filling in the 3D datacube as the aircraft scans the ground. This particular dataset consists of a 145×145 pixel grid sampling 220 spectral channels between 400 and 2400 nm. Applying PCA to this data set yields results shown in FIG. 12. The band from beyond 1.75 microns is relatively dark. Nulls in the measured spectra around 900, 1100, 1300, and 1700 nm correspond to absorption bands in the atmosphere, obviously there is little reason for the instrument to draw measurements from these bands. The PCA spectrum shows that approximately 50% of the observed variation arises from just the first two components. The first three PCA loadings reflect broad features.

Beginning with the fourth component, however, PCA components include sharp spectral features that justify the 10 nm spectral resolution of the instrument. Even out to the 20th order the explained variance of component the exceeds 1%. While a compressive spectrometer could be employed to capture this data, the A VIRIS pushbroom instrument is a reasonable choice for this application. The aircraft is moving and the scene is not changing on the time scale of aircraft motion, so capturing the 3D data cube is not a challenge. While dark regions are oversampled, the simple instrument design makes these regions readily accessible, and eliminating sampling is not worth the challenges involved. Despite this simplicity, however, we now wish to argue the counterpoint that AVIRIS alone is not ideal.

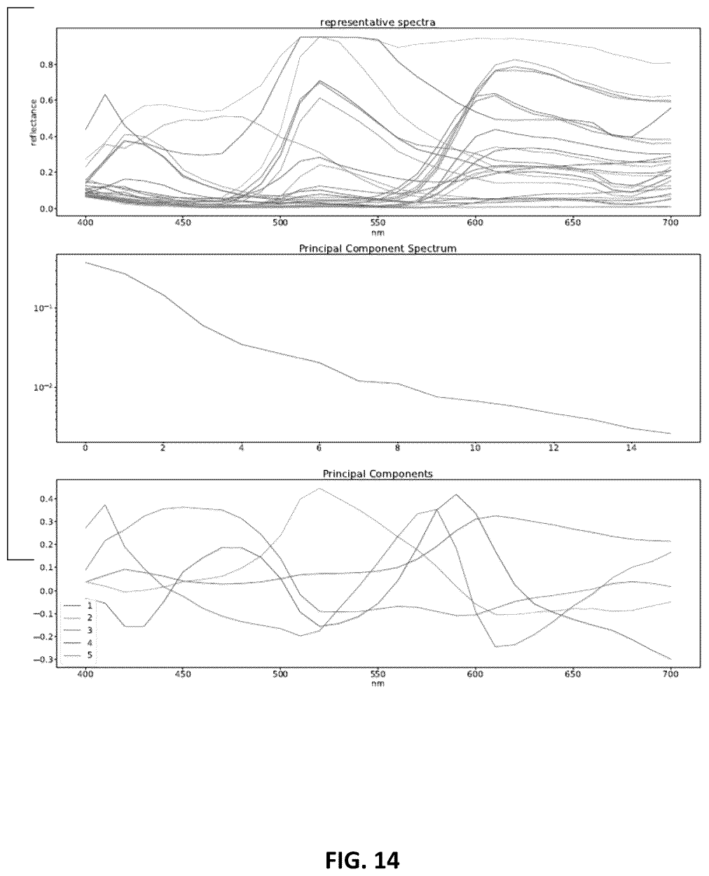

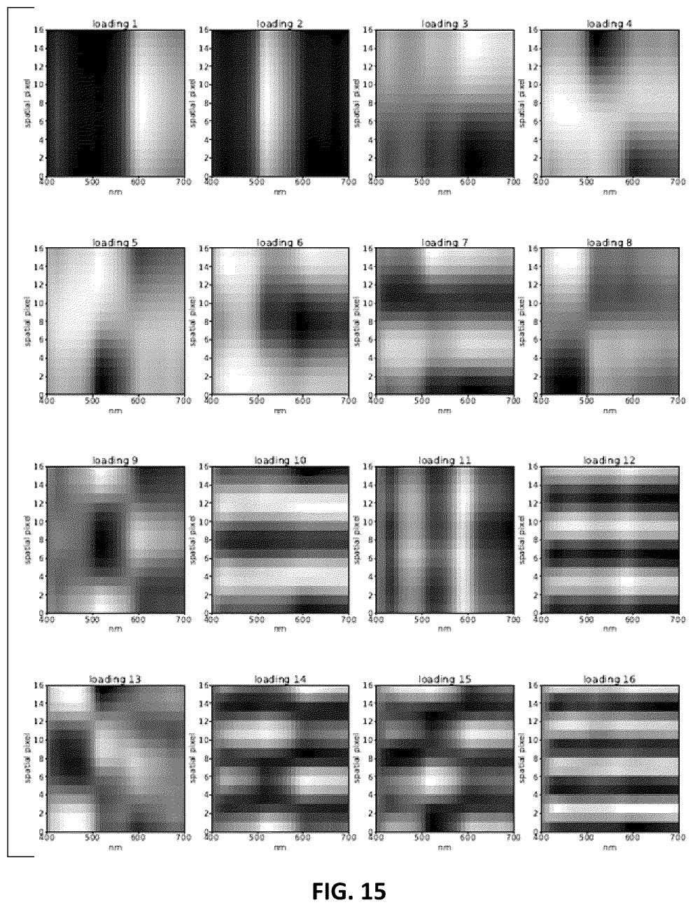

Our counter argument begins in consideration of the set of beads shown in the RGB photograph of FIG. 13. The photo is from the spectral imaging study described in [388], which captured reflectance spectral data cubes for various common objects illuminated with white light. As with the AVIRIS data cube, one may select a representative array of pixel spectra to find for PCA. The bead data cube was captured using a liquid crystal tuneable filter operating in 10 nm steps between 400 nm and 700 nm, yielding spatial images at 31 distinct wavelengths. The image consists of 512×512 spatial pixels, of which 4000 were randomly selected from the central 384×384 pixel region. Representative pixel spectra, PCA eigenvalues and the first five PCA loadings are illustrated in FIG. 14. The reader will notice that the first three loadings correspond to red, green and blue filters. However, eigenvalues remain above 1% to the 10th component, suggesting that physically useful information is obtained by measuring more channels. In fact, 30% of the explained variance in the signal corresponds to components beyond the first three.

Yasuma et al. suggest that color filter arrays with seven spectral channels may be ideal for digital photography. The question of which filters to use and why raises diverse issues. Imagining that the purpose of photography is to present images that match human vision, digital cameras have long viewed three color capture as sufficient. The human fovea has three categories of cone cells with sensitivity peaks in the red, green and blue spectral region. However, translation of the neural response to these cells into color is nonlinear and not completely understood. Human perception of color is well beyond the scope of this document. However, we can make two points. First, the better a camera captures the underlying physical information of the optical field, the more likely it is that one can process the field to match human perception. Despite the fact that human vision is trichromatic, having multispectral data may assist a rendering system in producing visually acceptable images. Second, a goal is ultimately not to match human perception but to greatly exceed it. We seek to capture the light field, e.g. all possible optical information. We build cameras with better temporal and spatial resolution than humans, we should build better spectral resolution as well. With this in mind, it is likely that photography of natural reflective scenes will benefit from more diverse color sampling.

The number of spectral channels is not the most interesting use of the bead data, however. A more interesting issue arises from consideration of the structure of the principal components. In deriving FIG. 14 we have arbitrarily assumed that we are interested in the principal components of pixel spectra. This approach effectively assumes that the spectrum of each pixel is independent from every other pixel, an assumption that we know to be untrue. In deriving the principal components, one may like to find the components of the image as a whole, but just as the pixels are not independent from their neighbors, one can also expect that there for a sufficient distance between pixels information becomes decorrelated. For this reason, we felt that it may be sufficient to consider 16×16 element blocks as representative in FIG. 8. Taking a similar approach here, one may consider the principal components of 16×16×31 blocks of the image data cube for our bead data. However, such features, containing 7936 elements, may be numerically challenging to calculate and difficult to visualize. For illustrative purposes, we take the simpler approach of considering 2D spatio-spectral slices of the data cube. Specifically, we find the principal components of randomly selected slices of 16 pixels along a line with 31 spectral values at each pixel.

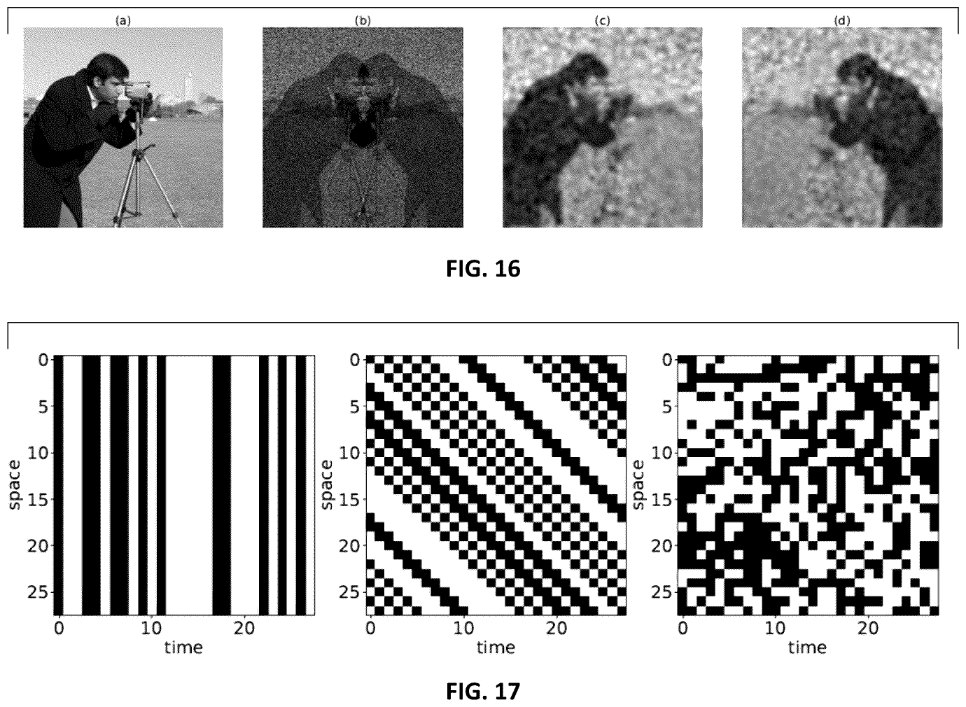

The 16 lowest order PCA loadings for such slices from the bead data set are shown in FIG. 15. While this is a rudimentary analysis, it nevertheless illustrates the simplest strategy for improving AVIRIS sampling, as well as improving many other spectral imaging systems.

The PCA components illustrated in FIG. 15 have naturally separated into low spatial frequency spectral projections (loadings 1-4) and high spatial frequency/low spectral sensitivity higher order components. This is not surprising for this particular image because each bead has similar spatial structure but different spectral characteristics. The first two PCA components characterize red and green luminance with low spatial resolution, the third and fourth characterize blue with modest spatial structure, higher order components alternate between spectral measurements and spectrally insensitive spatial projections. While this structure is specific to this example, one often finds variation in the effective sampling rate for spatial and spectral features attractive. As discussed in the next section, a similar feature structure is also common in temporal imaging.

Returning to how one could improve AVIRIS sampling, the decoupling between luma and chroma channels in in FIG. 15 suggests that hyperspectral cameras combining low spatial resolution spectral cameras with high spatial resolution luminance cameras may be more effective. This multiscale approach may be combined across a variety spatial, temporal and spectral data cubes. In contrast with the strategies noted earlier, multiscale sampling does not segment the optical data cube into a uniform voxel distribution. Multiscale spectral sampling is depicted in [34]. The RGB planes are coarsely sampled using low bandpass sensors, luminance is sampled at a higher rate.

As illustrated in [34], one may combine high resolution crossspectral voxels with low spatial resolution spectral voxels. This approach may be implemented, for example, using a multiscale camera array. Hu et al. compared data cube estimation for spectral and temporal imaging using multiscale sampling and CASSI.

A comparison of CASSI sampling and multiscale sampling for a 9 spectral channel 256 pixel imaging is found in [155]. This paper includes a comparison of CASSI reconstruction using the transformer networks

described in with two different transformer networks for multiscale sampling, which is achieved by using nine 4× spatially down sampled spectral slices and one full resolution monochromatic luminance channel. Despite a compression ratio of 128 relative to full data cube sampling, SNR in excess of 37 dB is achieved using a PAT (Position-Aware Transformer) transformer network.

Reference assumes low resolution spatial images/high resolution spectral images and high resolution spectral images/low resolution spatial images are captured using array cameras. In the case of airborne systems like AVIRIS, the features in FIG. 15 and the results shown in suggest that augmenting the hyperspectral

camera with a higher spatial resolution monochrome camera may improve spatial resolution more efficiently than improving the ifov (instantaneous field of view of a single detection element) of the hyperspectral system. One may consider more complex strategies using a variety of snapshot or scanned spectral imaging systems with more higher spatial resolution monochrome or lower spectral resolution cameras. The variety of instrument combinations one could apply is endless; an important point is that neural architectures built around vision transformers, neural representations, etc. enable fusion of array data, and that this capacity significantly increases the design space.

One can also employ adaptive sampling strategies. Adaptive coding to shape measured features has been demonstrated, for example, using spatial light modulators as coded apertures [86]. Alternatively, one can adaptively sample spectral planes using liquid crystal tunable filters, which can shift wavelengths in just a few

milliseconds [236]. Xu et al. have demonstrated an adaptive spectral imager that combines both an adaptive coded aperture and a tunable filter. We do not consider adaptive sampling strategies here, but the focal control strategies using reinforcement learning discussed below could be applied with equal effect in sampling the spectral data cube. Whether adaptive or not, one is likely to find multiscale/multiaperture sampling attractive. For example, one can combine a coarse multispectral camera measuring broad spectral features and high resolution spatial features with a narrow band tunable filter. Adaptive control of such a system can achieve high spatial resolution and high spectral resolution imaging at the frame rate of the coarse camera.

As suggested above, feature analysis and neural estimators suggest that the traditional Bayer color filter array is not ideal for color photography. The Bayer filter already spatially over-samples luminance relative to chrominance by using two green filters in its unit cell. However, the 2×2 unit cell may still over sample spectral

diversity. As suggested by Yasuma et al. one could address this challenge using a larger CFA sampling cell, for example creating a 3 array with more diverse spectral filters. In considering such arrays, however, one should also note that ideal focus and exposure levels may vary between channels. One could account for this by varying filter density, but may again wish to consider multiple sensors, which would allow independent control of focus and exposure for each color.

### Optical Coding for Temporal Imaging

The last section began with the assertion that spectral imaging is the most common form of tomographic optical imaging. One can assume that this is the case because both still photography and video tend to capture in color, but temporal imaging is also extremely common. From a mathematical perspective, coding strategies to capture the spectral and temporal data cubes are nearly identical. One is most often interested in capturing the 4D spatio-spectral-temporal data cube. Historically, temporal imaging relies on the concept of a frame, corresponding to an xy-plane image captured at a specific time. The frame is roughly analogous to a single xy slice of the spectral data cube. Frames are a necessary concept for film photography, where the physical recording media shifts from one exposure to the next. It is unfortunate that this concept has persisted into the digital age, however.

Movies emerged with the pioneering work of Muybridge to use differentially triggered array cameras to capture animals in motion [244]. Muybridge used glass plates for recording, which left no simple mechanism for display. The first motion picture using a single camera with a frame by frame advance was recorded by le Prince [153], followed quickly by diverse other inventors, including most famously Thomas Edison and the aptly named Lumi ere brothers. Electronic motion pictures were developed several decades after celluloid film movies. Early television cameras were single pixel imagers using a rotating mechanical disk to sweep a single object pixel across the screen [2]. Even after electronic scanning replaced mechanical, television was an analog system in which the actual signal value recorded in raster scan by the camera was replicated by raster scan on the display. In contrast with film, television and video did not actually display frame by frame, rather images were replicated pixel by pixel in raster sequence. Typically, rows were interlaced to improve spatial resolution without increasing frame rate. The United States National Television System Committee (NTSC) standard used 525 interlaced rows of pixels at 60 Hertz, with even and odd rows displayed as sequential fields. With emergence of digital video standards in the 1990s and the development of faster scan displays, displays began to shift to progressive scan through the digital HD 720p, Full HD 1080p and 4K standards. 720p, for example, is a 1280 by 720 pixel image with progressive scan. Given that the video is in a compressed digital format, the meaning of “scan” is archaic.

One of the central premises of computational imaging is that the process of image capture is distinct from display. To match human vision and display interfaces it may be useful to maintain the concept of frames, although studies suggest that even on the display side, random point projection may be more effective [197]. This disclosure concerning computational imaging, display science does not concern us except to note that in optimizing capture we do not concern ourselves with display issues. We are focused instead on how to measure the temporal data cube. The reader is likely familiar with the simplest approach, which is to electrically sample the pixel time series. The reader may be less familiar with optical modulation strategies using coded apertures and structured illumination. Optical strategies that enable measurement at frame rates well beyond the capacity of electronic focal planes are the focus of this section; we consider electronic sampling strategies later.

One may assume that the best strategy to measuring the space-time data cube f(x, y, t) is to measure slices of the xy plane as a function of time, which is the temporal analog of swept filter spectral imaging. The forward model for this case takes the form:

$${g}_{n} ( x , y ) = \int f ( x , y , t ) h ( t - n Δ ) dt$$

where the width of h(t) is the exposure time. This model corresponds to synchronous frame imaging and roughly corresponds to measuring the full data cube. There are several situations for which this approach may not be ideal, however. It may be expensive or impossible to obtain sensors with sufficiently short frame rate, or the power or data load needed to obtain a sufficiently fast frame rate may be excessive. In such situations, one may choose to modulate the spatio-spectral data cube to allow a low frame rate sensor to capture higher frame rate information. Despite the disdain for frame-based imaging already expressed in this section, this problem is most easily described by considering measurement of super-imposed frames.

Consider a sequence of image planes f₁, f₂, f₃ . . . fn. The images may consist of xy slices of the spatio-spectral data cube or of the spatiotemporal data cube. Such slices have also been studied in the context of multiplexed imaging systems, in which case the slices correspond to subimages drawn from different areas of the field of view [149, 220, 351]. For some practical reason, it is not possible to independently measure the slices. The measurement system can naturally measure the superposition

g=Σᵢfᵢ.

The goal of the computational imaging engineer is to recover fᵢ from such a measurement. Happily, the engineer may be able to modulate the images to assist in such disambiguation. With modulation, the measurements take the form

g=>Σᵢtᵢfᵢ,

where tᵢ is a known coding pattern. In our discussions of spectral imaging, tᵢ has taken the form of a Bayer color filter array or a coded aperture shifted from one spectral plane to the next, but in principle tᵢ could be an independent code for each multiplexed plane.

Measurement of multiple signals broadcasting on a common channel with independent modulation is a form of code division multiple access (CDMA). While CDMA is today a standard for wireless communications, its origins begin with Golay codes derived for infrared spectroscopy [118]. Such codes also lead to the uniformly redundant arrays used in 2D coded aperture imaging.

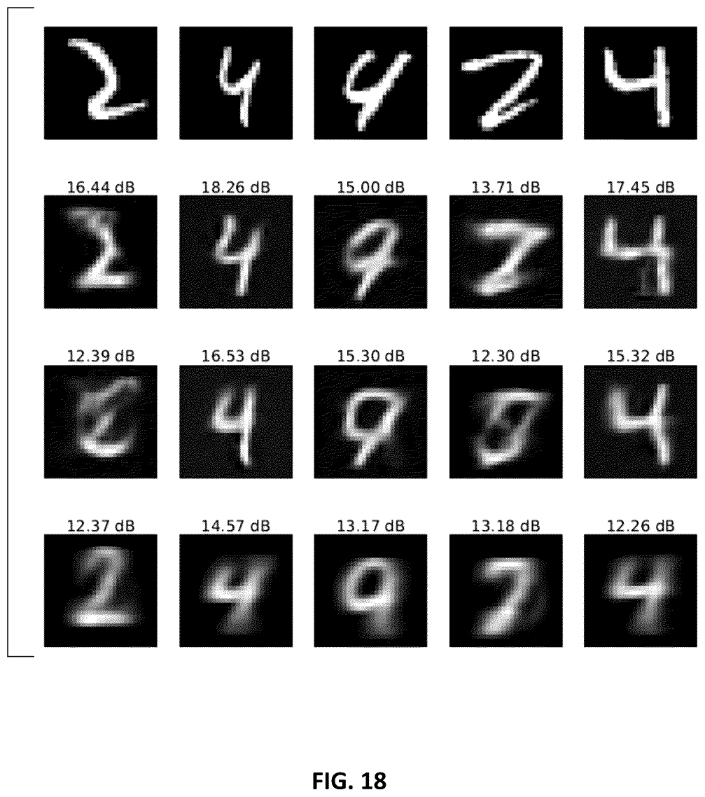

An example of how this approach may be used to separate multiplexed images is shown in FIG. 16. Here f₁ is the iconic cameraman image and f₂ is the horizontal mirror of the image. Each image is multiplied by a unitary binary code and then the images are added in the measurement

g=tᵢf₁+t₂f₂,

as shown in FIG. 16(b). The orthogonality of the codes would be improved with bipolar modulation, but as we have now discussed in some detail bipolar modulation is not possible with irradiance measurements. To decouple the images we multiply g by a bipolar code and low pass filter. For example,

$$( {t}_{1} - . 5 ) g = ( {t}_{1} - . 5 ) {t}_{1} {f}_{1} + ( {t}_{1} - . 5 ) {t}_{2} {f}_{2}$$

But (t₁−.5)t₁=0.5t₁ is everywhere nonnegative and (t₁−.5) t₂ is a random bipolar signal. The expected value of a low pass filter operating on the random signal is zero, so this operation roughly isolates f₁, as illustrated in FIG. 16(c). The complementary action with code t₂ produces FIG. 16(d). The point is to provide an example of the function of spatial coding for compressive tomography; better results may be achieved with more sophisticated coding and image estimation strategies.

Coding frames for high speed imaging dates to the Edgerton's work on stroboscopic imaging [88]. Coded stroboscopic techniques were introduced to modern computational imaging through flutter shutter and coded strobe [354]. Recalling that spatio-spectral and spatiotemporal data cube capture are mathematically identical problems, the feature analysis discussed above applies here. Purely temporal modulation decouples spatial and temporal features, jointly coded features require modulation at the pixel level, which can be achieved either by strobing with structured light or by using pixel-level shutters. For example, coded aperture compressive temporal imaging (CACTI) uses lateral translation of a coded aperture to create the temporal analog of CASSI spectral imaging. CACTI originally used total variation based LASSO algorithms to invert the spatio-spectral data cube. Extended versions capture the spatial/spectral/polarization data cube [343], the spatial/temporal data cube and the 3D spatial focal volume [394].

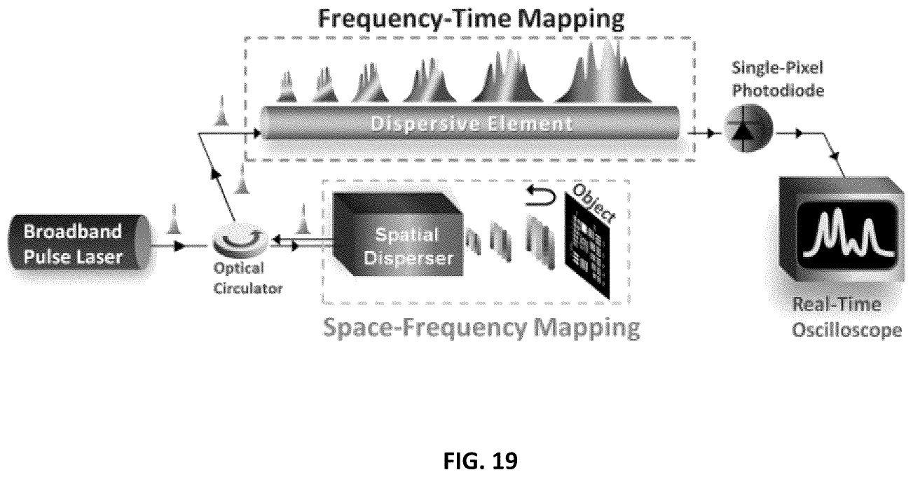

A simple model for coding strategies for compressive temporal imaging is illustrated by the sampling matrices illustrated in FIG. 17. We consider imaging along a single spatial dimension and time. Each panel represents the x-t plane. For snapshot imaging, the measurement system integrates along the temporal axis. The measurement returns:

$$g ( x ) = \int f ( x , t ) h ( x , t ) dt$$

For stroboscopic imaging, h(t) is a sequence of pulses. This case is illustrated in the left image of FIG. 17. Measurements are obtained by pointwise multiplication of this function on the object distribution and then integrating along the horizontal (time) axis. For a moving coded aperture h(x) may be a spatial code translated laterally during the measurement such that:

$$g ( x ) = \int f ( x , t ) h ( x - vt ) dt$$

This case modulates the object distribution by the center sampling distribution in the figure, again the measurements are obtained by integrating along the horizontal axis. As with a color filter array, this approach interleaves different temporal sampling functions in space, with a goal to increasing measurement entropy. Finally, h(x, t) may be randomly coded in space-time by controlled illumination or the use of spatial light modulator. This case is illustrated at the right of FIG. 17.

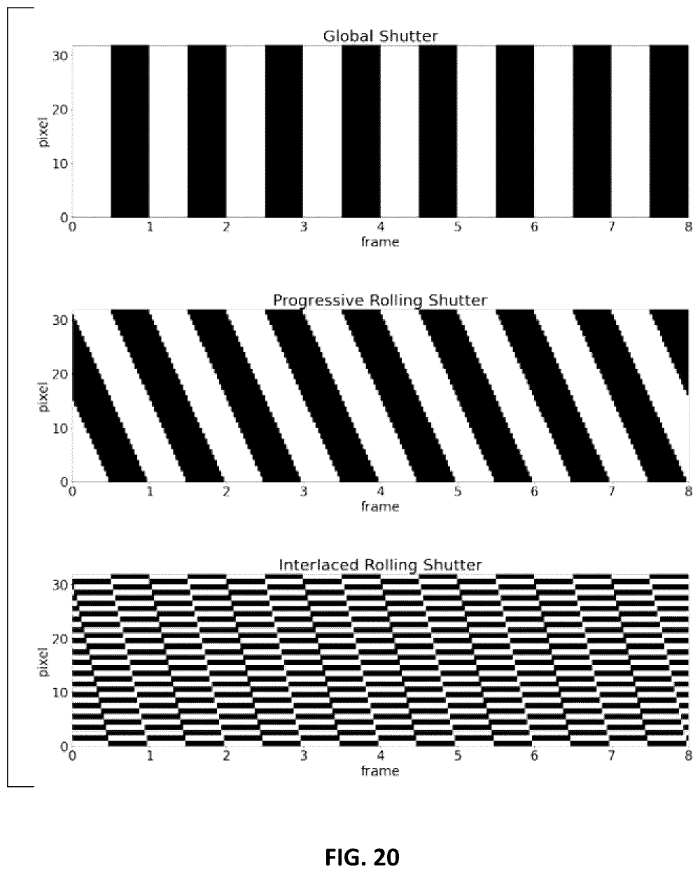

The object space in this example is 28 spatial pixels by 28 temporal pixels, which is useful for reconstruction of the MNIST hand drawn character data set. Compressive tomography of images in this data set can be applied using coded aperture projections, e.g., by drawing 128 measurements along a line. Here we consider the use of just 28 measurements drawn by integrating along the horizontal axis. We use the a convolutional neural architecture, but rather than apply the CNN to the pseudoinverse we use a single densely connected layer to transform the 28 element measurement vector into an initial 28×28 feature map for CNN decoding. FIG. 18 shows example reconstructions with the coding matrices of FIG. 17 using this network structure. The top row shows ground truth images, the second row shows reconstructions using the random encoding structure from the right of FIG. 17, the third row for the moving coded aperture and the fourth row for the flutter shutter. We use PSNR as a metric to compare the images, despite the fact that these are noise-free simulations. PSNR is still a useful measure of mean square error, which in this case arises from decompression. The mean square reconstruction error over the validation data set is 2.2% for the random space-time code, 2.9% for the coded aperture and 4.3% for the flutter shutter. This result validates the idea that less correlated sampling structures improve system performance. Each sampling structure will have null spaces that impact results as illustrated in FIG. 18.

CACTI and CACTI-CASSI hybrid systems have been demonstrated in numerous studies. For example, a comparison of CACTI reconstructions using a low resolution binary mask, high resolution binary mask and high resolution gray scale mask is found in [366]. The paper also shows experimental measurements and reconstructed frames using a hybrid convolution-transformer network.

With mechanical shutters or spatial light modulators, one can imagine using electronic sampling or electronic modulation to replace coded apertures. As frame rates increase to the terahertz or petahertz range, however, mechanical and electronic modulation becomes impossible. By combining coded apertures with streak cameras, however, it is possible to sweep the code at rates consistent with nearly terahertz frame rates [278]. Beyond the streak camera, frame rates approaching petahertz can be obtained by using coded space-time illumination.

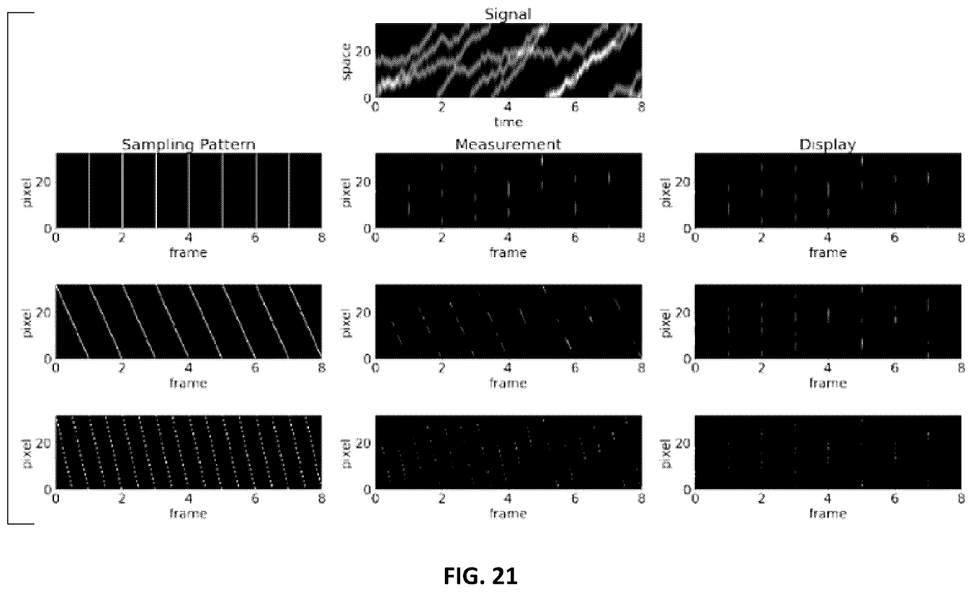

A core concept of CACTI and CASSI is to encode temporal or spectral data in spatial patterns. This is possible because the spatial image is often piece-wise smooth and thus the spatial channel is under-utilized for information transfer. The same may often be said of the spectral or temporal channel. Serial time-encoded amplified microscopy, as illustrated in FIG. 19, uses spectral dispersion to separate a broadband pulsed laser into a 2D spectral image such that each pixel is a different wavelength. When this signal is reflected by a spectrally insensitive dynamic object, the reflected signal at the corresponding wavelength is proportional to the object state at the time of illumination. This system records frames at the pulse repetition frequency of the laser, which may be in the range of megahertz to gigahertz. The reflected signal goes back through the encoding disperser and can be injected into a single mode fiber. Spectral analysis of the return signal decodes the image. While the raw system is not compressive and does not require advanced computation, one can extend the system to combine spatio-temporal-spectral encoding for computational imaging.

All of this analysis leads back to the concepts discussed in the above section entitled Spectral Imaging. Optimized sampling strategies depend on the feature space of the object as well as on the sensitivities of the receiver, and one may find that multiscale and heterogeneous sampling strategies are ideal. When designing temporal sampling systems, scanning the range from kilohertz to petahertz diverse solutions will arise. Consider the most common scenario: electronic sampling for video signal capture. Ideally, video capture can uniformly sample the space time data cube at a rate consistent with the Nyquist sampling period for the temporal channel. While we have discussed spatial bandpass and sampling rate, we have not to this point discussed temporal sampling or the temporal resolution.

### Electronic Sampling for Temporal Imaging

The temporal resolution of optical imaging systems is limited by the temporal response of electronic detectors. Considering the detector as a capacitor that accumulates photogenerated charge, one may expect that the temporal response is limited by the RC time constant of the detector circuit. At speeds beyond 1 GHZ, the manufacture of suitably fast circuits is challenging and the ultrafast capture strategies discussed above come into play. Below 1 GHz, however, it is not difficult to make suitably fast circuits. However, an image sensor is ultimately a device that converts parallel signals into a serial electronic signal. A 30 megapixel sensor read at 30 frames per second reads 900 Megapixels per second, meaning that the read electronics are working with gigahertz frequencies even if the pixel speed is only 30 frames per second. To understand the current design and future opportunities of this process we need to consider details of focal plane operation in more detail.

The mechanical scanning disk of the first electronic imaging systems was never successful commercially. The first generally available electronic imagers used electron beams to scan a photocathode. This technology formed the basis of both visible and infrared imaging systems until the 1970s, when solid state sensors began to emerge. In contrast with photocathodes, which are naturally raster scanned, solid state sensors consist of discrete 2D detector arrays. There is no natural necessity to read-out such arrays in any particular order. Concurrent with the development of these arrays, the term “pixel” emerged to describe images consisting of discrete measurements

The earliest pixel arrays were based on charge coupled devices (CCD). A charge-coupled device (CCD) is an array of capacitors. By shifting bias voltages across the array, photogenerated charges may be passed across the array and read-out in sequence. Alternative devices used to obtain infrared sensitivity may be coupled to CCD backplanes for read-out. While Boyle and Smith were awarded the 2009 Nobel Prize in physics for the development of the CCD, the CCD has largely been displaced by complimentary metal oxide (CMOS) sensors in modern focal planes [103].

CMOS sensors use active pixels to sequence photodetection and signal read-out. This approach is more flexible that the CCD and reduces operating power substantially because each pixel is accessed only once on read out. The simplest version of an active pixel consists of a photodetector, a reset transistor, a source follower transistor, and a row select transistor. The photodetector converts incident light into a charge, which is then transferred to the charge-to-voltage region by the transfer gate of the reset transistor. The voltage of the charge-to-voltage region is then reset by the reset transistor. The source follower transistor amplifies the voltage from the charge-to-voltage region, and the row select transistor selects row of pixels for readout from the source follower transistor.

Image detection on an active pixel sensor consists of three processes: optical signal integration (exposure), read-out and reset. Although exposure is typically the longest process, each of these steps requires some time, particularly because the basic function of the sensor is to convert the parallel optical image into a serial electronic signal. While, as discussed more fully below, this transformation could take many forms, most currently available sensors choose to read the sensor in progressive rows. As discussed above, even at 100 megahertz to gigahertz frequencies may require a substantial fraction of the frame period.

If one intends to capture a still image, then the read-time may not be an issue. But here we mention a secret of modern computational imaging: there is no such thing a still photograph camera. In the emerging age of computational imaging, a camera should continuously capture the data cube. One creates a still image by estimating the scene at a particular point in time, not by literally capturing the pixels at that point in time. Why not simply capture the still image? Because capturing diverse pixel values in the time frame before and after the time enables a better estimate of the physical scene. Tomographic systems, including video, cannot efficiently capture slices, but they can efficiently estimate slices from the data cube. So we take it as given that all modern cameras are streaming data at relatively high clock rates.

Unfortunately, the idea that all cameras are computational cameras is not generally acknowledged. In fact, designers often go to some length to minimize the need for computation by making the raw pixel values correspond closely to display values. In the case of an active pixel sensor, one can add transistors to the simple design to buffer signal values between capture and read-out. In global shutter sensors, all sensors in the array are reset simultaneously and have identical integration periods. The captured signal values are shifted to pixel-level buffers and these buffers are read sequentially. Since no pixel values are read during the exposure period, this approach may substantially increase the dead period during which sensors are inactive, thus decreasing effective quantum efficiency. This approach also increases read-noise because the period available for read is reduced.

Alternatively, rolling shutter sensors reset rows immediately after they are read. This approach means that the reset times of the rows are different, meaning that the exposure windows differ from row to row. FIG. 20 compares sampling patterns for global shutter, progressive rolling shutter and interlaced rolling shutter. The patterns show one dimension in space and one dimension in time, in a 2D system the spatial position corresponds to the image row read at the corresponding time. We have assumed in this illustration that the exposure time is 50% of the frame period, white corresponds to the exposure window and black corresponds to the time over which the corresponding row is not collecting photons. For a sensor with N rows, progressive scan means that rows are read in the sequence 1, 2, 3 . . . . N.

An interlaced scan reads the rows in order 1, N/2, 3, N/2+2, . . . . N/2-1, N. As mentioned above, interlaced scan was used in the NTSC television standard.

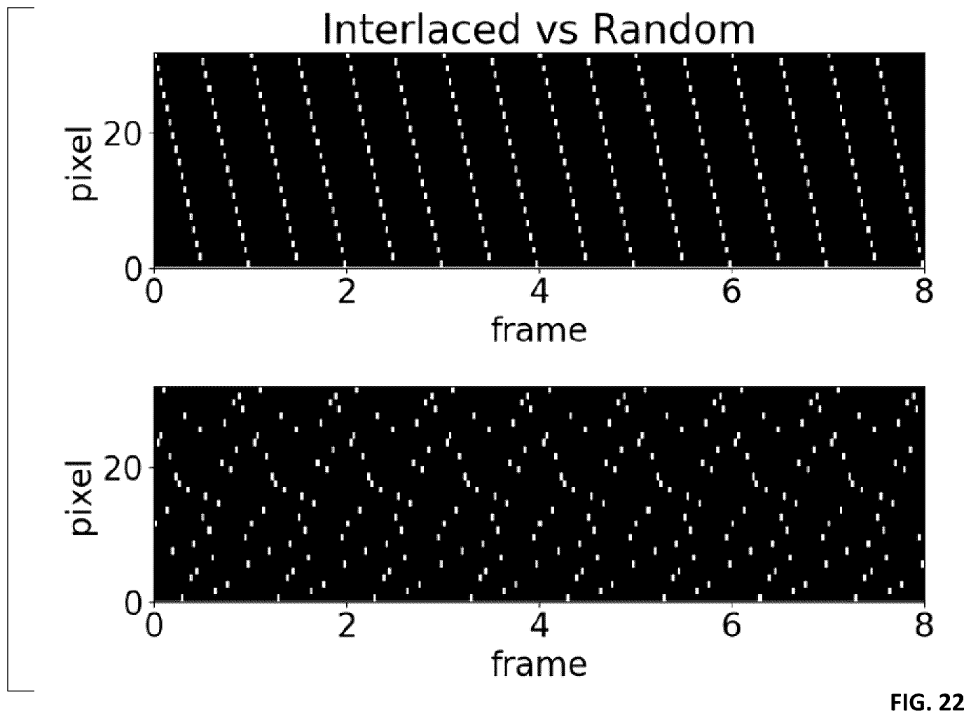

Interlaced scan was used both because it increases the effective visual frame rate for human perception and because it is easier to implement with cathode ray tubes than progressive scan. Since modern solid-state sensors and flat panel displays have no electronic difficulty in implementing progressive scanning, progressive scan is, unfortunately, the current standard. If an event occurs in the black regions of the scan patterns of FIG. 20 then that event is not captured. This simply to state that each measurement strategy has a null space. Note, however, that the continuous regions of the null space for the global shutter and the progressive rolling shutter are much larger than for the interlaced rolling shutter. Referring to the information theoretic measurement arguments raised in the discussion Spectral Imaging, one may expect the interlaced rolling shutter approach to more effectively characterize the signal, because measurements are spread more uniformly over the measurement data cube. Measurements using these three shutter strategies are illustrated in FIG. 21.

The object in this case is a simple 1D random pattern varying as a function of time, as illustrated at the top of the figure. We assume that the exposure time is equal to the row read time, which is 1/32 of the frame period in this example. The left columns in the figure show the exposure windows for each pixel for the three shutter types. The center columns show the captured measurement values at their actual measurement times. The right column illustrates a sad fact regarding the processing of image data in typical current image signal processing pipelines. Despite the fact that rows are captured at different times for rolling shutter, the ISP assumes that all rows were captured at the same time and the rows are processed into a single frame at a single time. The right column displays the signals that would be displayed from the measured data under this assumption. The global shutter data is undistorted and represents the actual ground truth of the signal value at the corresponding frame times. The progressive scan and interlaced rolling shutter data is distorted relative to the ground truth, despite the fact that, as illustrated in the center column, the interlaced rolling shutter data is a much closer representation of the true signal than the global shutter data. As illustrated in this figure, the central issue between rolling and global shutter comes down to misuse of the sample data on display.

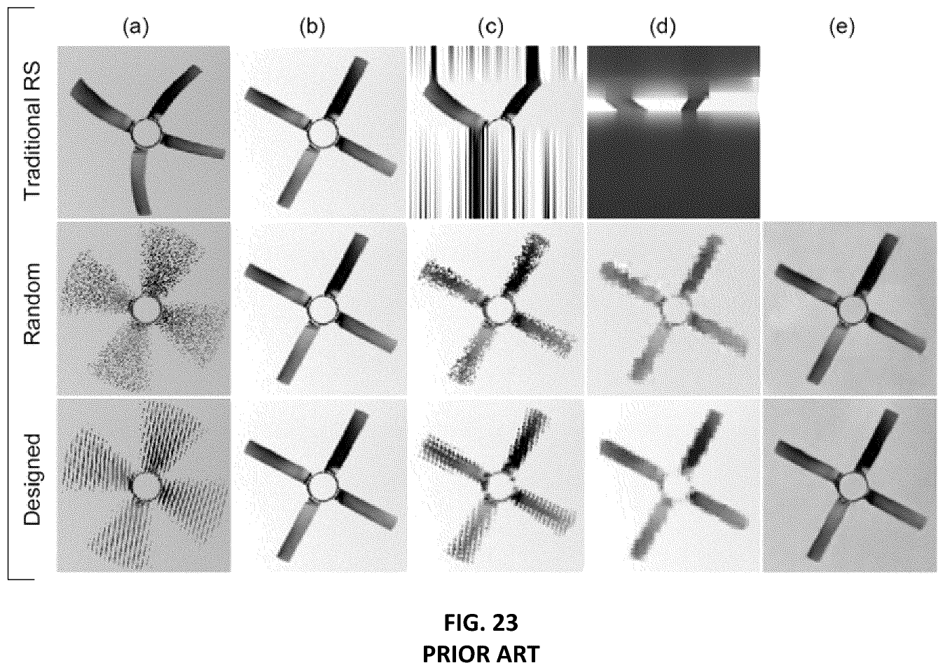

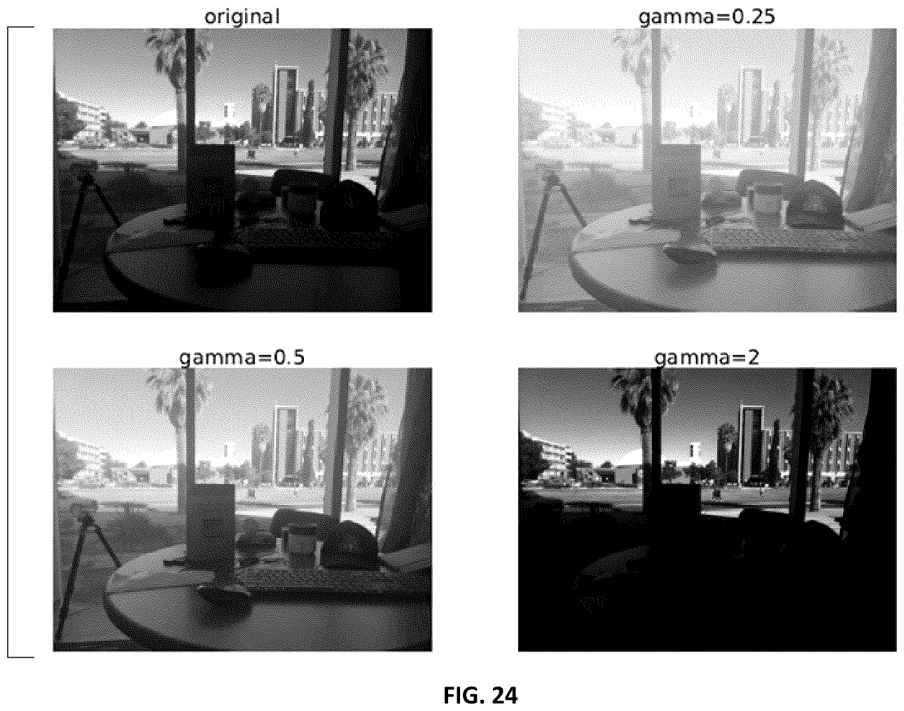

While interlaced rolling shutter samples the data cube densely for a 50% exposure cycle when the exposure time is much less than the frame time interlaced sampling may leave smooth regions of the spatiotemporal data cube unsampled. FIG. 22 compares the spatio-spectral sampling pattern for interlaced sampling from FIG. 21 with the sampling pattern achieved if the image rows are read in random order, as illustrated at the bottom of the figure. By maximizing the mean separation between sampling points, e.g. spreading them uniformly over the data cube, one hopes to maximize the rate of information capture. Several studies have considered optimizing capture and scene estimation from rolling shutter sensors [124, 355]. As an example, FIG. 23 compares scene estimation for progressive (traditional) rolling shutter capture with random row sequences and optimized row sequence. The optimization process maximizes the distance between sampling points in the data cube [355]. The left column (a) in the figure shows the measured data from a single frame window projected into a single 2D image, analogous to the right column of FIG. 21. Note the iconic rolling shutter distortion of the fan in the upper left image. Column (b) shows the true image of the fan at a particular time. Column (c) uses nearest neighbor linear interpolation to estimate a single time slice. Columns (d) and (e) use total variation constrained linear regression and a neural estimator to recover a slice from the video sequence of fan motion. Note that the actual reconstruction consists of the full 3D space-time slice from the single captured image, meaning that the estimated frame rate is more than an order of magnitude faster than capture frame rate.

Given that these results seem to indicate that nonsequential rolling shutter is better than progressive scan, the reader may wonder why design switched from the original interlaced systems to progressive scan. The reason lies in the compression algorithms utilized. NTSC and PAL consisted of interlaced raster scan analog image streams. Digital video, in contrast, consists of encoded data. Encoding is implemented on a mostly per frame basis based local pixel values. The JPEG strategy operates on 8×8 pixel blocks. With a progressive scan system, operating on such blocks requires buffering 8 lines of video. In a streaming system, one may operate on a block of 8 lines during the time that the next block is read into the buffer. If, in contrast, one uses nonsequential rolling shutter read-out, it may be necessary to buffer an entire frame of video to implement standard compression algorithms. An answer to this conundrum is to implement nonstandard compression without such buffering, but this answer is unlikely to occur to standards committees.

When buffering is used, it is possible to correct for standard rolling shutter by processing images over multiple frames [205]. This is because interpolation strategies for raw spatial pixel values 3 apply with equal force to temporal signals. Just as upsampling can improve estimated image quality, neural temporal upsampling can

improve estimated temporal sequences. See, for example, for an early study in the large video interpolation literature. One can view interpolation on correctly structured rolling shutter data as an interpolation problem. While these methods require frame buffering, video standards already buffer reference frames to calculate motion vectors and residual images. However, buffering both the reference frame and the current frame to read interlaced lines is not generally supported. It is uncommon for ISP ASICS to support interlaced read-out and emerging standards, such as the AV1 compression standard, do not support interlaced formats at all. One reason for this is that compression standards are often more concerned with the decoder/display side of the process than the image capture side. Systems seek simple capture-independent decoding. Modern flat panel displays operate almost exclusively in progressive scan.

Rolling shutter artifacts are less pronounced if the exposure time consumes a substantial fraction of the frame period. If the exposure time is approximately equal to the frame period then the temporal resolution of the imaging system is less than the error in row time (which is half a frame period if the rolling shutter estimation time is synced to the center row). This brings us to a conundrum of video sampling: why is the exposure time often substantially less than the frame period? This seems like a crime, setting the exposure time to less than the frame period reduces net quantum efficiency by the ratio of the exposure time to the frame period; signal is literally going to waste. This situation also means that temporal data is typically undersampled relative to the Nyquist rate of the photodetector response, which creates aliasing artifacts that cannot be resolved by simple interpolation. The motivation behind this conundrum is that the frame period is determined by factors wholly unrelated to the temporal response time of the photodetector.

Conventionally, the frame period is also set to a standard value demanded by the display. The NTSC frame rate at 29.97 was set to match limits of human perception, typical frame rates have remained factors of 30 fps since, despite the fact that there is no reason for capture frame rates to be the same as display frame rates. In fact, as mentioned at the start of this section, the frame concept has outlived its usefulness on for image capture. Why then are exposure levels set to less than the frame period? First, to avoid motion blur. Second, and more fundamentally, exposure times are set to match detector dynamic range. Third, and finally, reducing the frame period strains read-out electronics.

The first issue is straight-forward, one would like to set the exposure time short enough to capture the actual dynamics of the scene. The photon flux for typical scenes ranges from 104 photons per pixel per second for an indoor or night scene to 109 photons per pixel per second for a brightly lit scene. Since there is reasonable hope of reconstructing an image even with just 100 photons per pixel, exposure times on the range of 0.1 microseconds, corresponding to 107 frames per second may be reasonable for natural cameras. In practice, cameras operating at several megapixels per second are commercially available. Despite the technical feasibility of high frame rates, such systems are uncommon due to issue number 3. Before discussing this issue, let's consider how the exposure time is determined if it is independent of the frame period.

The basic photodetector is essentially a capacitor collecting photogenerated charge. The operating voltage, materials characteristics and pixel area determine the well capacity of the photodetector. The well capacity is the maximum number of photogenerated charges that the detector can process in a single exposure cycle. While the designer must go to some length to obtain an acceptable value, the parameters that determine well capacity are largely beyond the ability of the designer to control. The pixel cross section should ideally be near the Nyquist period, e.g. on the order of λf/#. The operating voltage is largely determined by characteristics of electrical components of the circuit. Materials characteristics, most often of silicon, are determined by convention and available manufacturing processes. Based on these constraints, well capacity is on the range of 10³−10⁴ electrons for pixel pitches of 1−2 μm. Well capacity increases approximately linearly in pixel area and may exceed 10⁶ electrons for 10 μm pixels. Such large pixels, however, imply f/#in excess of 10, which in turn implies large optics.

If photogenerated charge exceeds the well capacity then charge may bleed into adjacent pixels or be lost in the control circuit. To avoid this, the exposure time is generally set to limit saturation. Thus one finds the two primary time constants of video capture, the frame period and the exposure time, to often be substantially different. Why not simply increase decrease the frame period to match the exposure time? Here we find a classic compressive tomography issue. The purpose of the focal plane array is ultimately to transform the 2D array of pixel values on the focal plane into a serial stream of data values. The speed at which the photodetectors can respond is not the limiting factor, rather the bandwidth of the read-out electronics limits the frame rate.

Numerous strategies to address the disparity between the ideal exposure time and the frame rate have been considered. One approach is to expand the internal circuitry of the pixel. For example, rather than simply reporting the integrated charge, one can build a detector with logarithmic response to enable long integration times. Alternatively, event cameras are designed to report changes at the pixel level rather than integrated charge. A central problem with these approaches is that increases in pixel complexity also increase pixel area and, most critically, electrical power. Ultimately, a focal plane is a massively parallel analog to digital converter (ADC), the solution to power efficient data capture requires conceptual innovation in ADC [137]. In particular, as with other forms of compressive tomography, one must find an efficient and information-rich encoding for measuring multiplexed values rather than individual pixels.

Focal planes with feature-based read-out are termed neuromorphic sensors, based on the idea that biological retina and visual cortex systems use such strategies. A simple approach to electronic neuromorphic sensing assumes that one reads the first layer of a convolutional network from the focal plane rather than pixel values

This approach can reduce read bandwidth and power by at least an order of magnitude relative to raster scan. Beyond this simple strategy, the reader may wonder: what should one be reading out of a focal plane, what would the ideal focal plane readout measure? Strategies like logarithmic response or event measurement are pixel-centric. Surely in an imaging system one should be reading spatial features rather than temporal features. Ideally, one may use PCA or similar feature analysis as discussed in the section entitled Feature-Specific Measurement to create optimal spatio-temporal features and design focal planes to react to such features. To minimize electrical complexity, one ought to make feature abstraction circuits operate over groups of pixels rather than single sites. Such strategies have yet to be implemented in actual systems, however. While one can expect rapid innovation in focal plane design, in the meantime the computational imaging system designer must optimize based on available hardware. This can include the use of multiple focal planes or the use of multiple exposure times on a single focal plane, which is the topic for our next section.

### Dynamic Range

We have emphasized the fact that measurements are represented by discrete numbers gₙₘ. In actual systems, the values that gₙₘ can assume are also discrete. As analog irradiance values are read-out of a sensor plane, they are converted into digital values. Poisson noise limits the signal to noise ratio of each digitized pixel value to ≈√N, where N is the well capacity in photoelectrons. The SNR is thus approximately 100 for a 10,000 photoelectron well or 300 for a 100,000 photoelectron well. With such modest SNR, quantizing detector signals as 8 bit integers with 255 levels is often considered sufficient.

To this point, a goal has been to design imaging systems that reconstruct the object distribution as accurately as possible. The phrase “as accurately as possible” is open to interpretation. The mean square error/f-fₑₛₜ/² or the mean regression error/g-Hfₑₛₜ/² are common measures of accuracy, but such measures may overemphasize

accuracy in estimating bright pixels. Alternative measures, such as structural similarity [370], have been developed to address this problem. The structural similarity index is designed around a model for the human visual system with weighted evaluation of luminance, contrast and structure. While one may choose to optimize a computational imaging system relative to this or other metrics, detailed discussion of this particular metric is not central to our narrative. Our challenge here is simply to understand how to appropriately use the limited dynamic range of an image sensor.

As a practical matter, this challenge splits into two challenges:
Tone mapping. For a given measured image pixel value, what image pixel value should one display and
Exposure control and object estimation. Given sensor characteristics, what measurements should one make and how should one estimate the object distribution.

The second challenge is a computational imaging problem but the first is an image data exploitation problem somewhat outside the focus of this disclosure. We nevertheless briefly review tone mapping here to establish the context of the exposure control problem.

Tone mapping addresses the challenge of communicating images to human observers. Unlike solid state

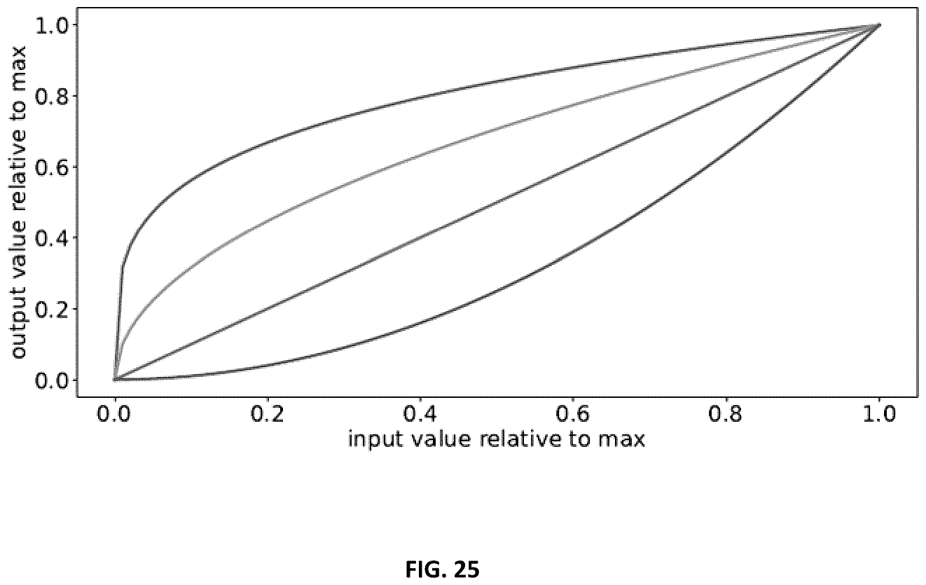

sensors, human vision is not frame-based and the human visual response is logarithmic in image irradiance [327]. While one can certainly imagine a high dynamic range display to allow human processing, such displays are unnecessary; tone mapping can enables low dynamic range displays to present images that seem natural to human observers. The basic problem is shown in the image at the upper left of FIG. 24, which displays a linear tone map. The tone map refers here to a function between measured and displayed pixel values y=T(x), where x is the captured image data and y is the displayed value. In the case of a linear mapping, y=x.

Historically, photographic film had a nonlinear response curve such that the developed transmittance of the film could be modeled as y=xy. Fast film has a large y, slow film has a small y. The value of y is determined by silver halide crystal grain size, during the development process exposed grains are converted to metallic silver, larger grains act as amplifiers that increase gain and y. This model of film speed is incorporated in an International Organization for Standardization (ISO) standard. Film speeds, varying from ISO 10 to 5000, indicate the exposure time needed to expose to 80% of saturation. Using the film ISO and the known relationship between scene illumination and sensor irradiance, one can find the exposure time needed to use the dynamic range of the film according to:

$$\frac{ρ {I}_{O}}{{( f / \# )}^{2}} \frac{t}{ISO} = C$$

where C is a constant derived from the standard and t is the exposure time. Exposure time, f/#and ISO form the exposure triangle used in composing photographs, each of the three may in principle be adjusted to set proper exposure but changing each has consequences. Increasing t may produce motion blur, decreasing f/#reduces depth of field. As discussed below, ISO is not really adjustable for solid state focal plane arrays, which generally return a signal linear in the illumination.

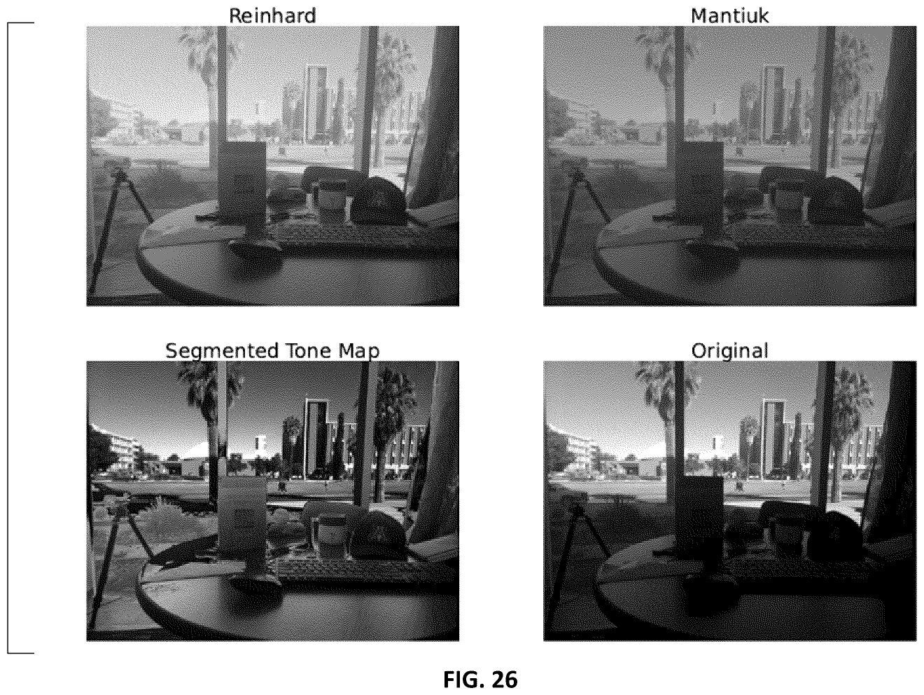

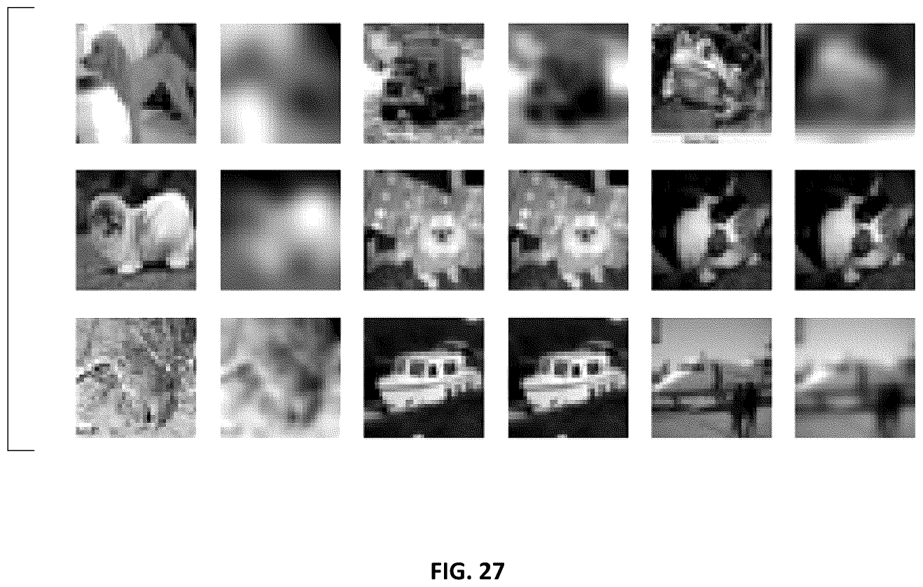

The concept of y lives on as a computational nonlinearity used in tone mapping. The display pixel value relative to the maximum signal value as a function of image pixel value for various values of y is shown in FIG. 25. Display images with these gamma corrections are shown in FIG. 24. These are examples of global tone mappings, the same corrections are applied across the entire image regardless of context. As shown in the figure, raising the exposure values of darker parts of the scene comes at the expense of reduced contrast in brighter areas. Humans are able to process images with wide luminance values using local tone mapping such that the function y=T(x) depends on position within the image. Many local tone mapping algorithms have been developed. At the simplest level, one may simply segment foreground and background regions of the image and implement distinct tone mapping functions on each region. In the lower left image of FIG. 26, this is achieved by creating a mask with thresholded image values. Values below the threshold tend to be in the foreground, values above threshold tend to be in the background. This extremely simple method produces reasonable visual images of the foreground and background, but distorts the mid-range. More sophisticated methods work by building a contrast map of the original image and then recreating a tone map from the local contrast values. Two such methods implemented in OpenCV. The Mantiuk tone map uses a multiscale Gaussian pyramid to analyze local gradients of the image and then applies a model of the human visual response to rescale the images. The Reinhard tone map [285], in contrast, implements a global tone map based on another model of the human visual response. Substantially improved tone mapping may be achieved using neural processing [282]. Neural tone mapping can work on many levels, recognizing relationships between objects and building a model of the captured world. Given the complexity and power of this approach, however, we reserve discussion until a later section and turn here to the second component of dynamic range management.

The second challenge of limited dynamic range sensors is how to control exposure to best characterize the object distribution, f. To resolve this issue, one may start with a model for optoelectronic signal conversion. The optical power in the image field is converted into a digital value by creating photoelectrons at each pixel and then converting the analog charge value into a digital signal value. While there are ISO standards for digital camera response, solid state sensors are typically characterized by responsivity. Responsivity is related to the quantum efficiency (photoelectrons per photon), but where quantum efficiency is specified as a function of wavelength, responsivity may be averaged over a spectral range and specified in luminance values. For example, one lux-second corresponds to approximately 10⁴ photons/μm² [260], so a sensor with 75/% quantum efficiency and 2 μm pixel pitch may be expected to yield 30,000 photoelectrons per lux-second of exposure. If the well capacity is 10,000, then for an object with luminance 100 lux captured with an f/3 imaging system, the exposure time to saturation is approximately 30 milliseconds.

Given the image flux and the well capacity, a natural mechanism for fully sampling the image field is to increase the frame rate to avoid saturation. Unfortunately, the frame rate of typical image sensors is independent of the exposure time and cannot be adjusted to match the flux. The operating power and bandwidth of the sensor generally determine the rate at which measurements can be made. Under this constraint, one may choose to sample so as to make the signal to noise ratio independent of intensity level. This is achieved if the number of photons measured to characterize intensity I is independent of I.

Multiple exposure imaging is a solution to this challenge. In a single exposure, the dynamic range is set at the natural value of a radiometric sensor. Consider a sensor reliably reporting integral signal values between 0 and M. Suppose that one wishes to measure an image with maximum flux Nₘₐₓ and minimum measurable flux Nₘᵢₙ. These fluxes are in units of signal value per unit time. The target dynamic range is Nₘₐₓ/Nₘᵢₙ. Letting tₘₐₓ be the maximum exposure time in the sequence, the minimum registered signal value is tₘₐₓNₘᵢₙ=1.

An exposure sequence satisfying this objective is constructed as follows:
A first exposure is recorded with exposure t₁ such that t₁Nₘₐₓ=M, meaning t₁=M/Nₘₐₓ. This exposure produces measured data for signal values between Nₘₐₓ/M and Nₘₐₓ.
The second exposure is set to avoid saturation for signal values below Nₘₐₓ/M, which means t₂=M²/Nₘₐₓ. With the second exposure, signal values between Nₘₐₓ/M² and Nₘₐₓ are characterized.
The third exposure is set to avoid saturation for signal values below Nₘₐₓ/M², which means t₃=M³/Nₘₐₓ. With the third exposure, signal values between Nₘₐₓ/M³ and Nₘₐₓ are characterized.
Similarly, for i >3, tᵢ=Mⁱ/Nₘₐₓ and that after the integrated signal allows acceptable SNR from Nₘₐₓ/Mⁱ to Nₘₐₓ.
Stop when tᵢ ≥1/Nₘᵢₙ

This approach may leave poor signal to noise ratio for signal values measured as 1. To improve the result one can choose multiple exposures at each exposure level. Since image values are captured with even dynamic range for each exposure, one may choose to index data according to exposure number and value, which is equivalent to storing the logarithm of the signal value. The Logluv TIFF image format adopts this approach [285].

Multiple exposure integration for high dynamic range image estimation are in-use. Standard strategies consist of the following steps:
Use common features in the exposure stack to calibrate the camera response as a function of exposure time and signal value,
Warp, rotate and shift the images to align pixels,
Weight the signal values and merge them into a single HDR image.

Following these steps, one can tone map the HDR image for display using tone mapping strategies described above. For the computational imaging system designer, one assumes that the first step is unnecessary because the designer selects the sensor and is aware of its calibrated signal response. The second two steps are, however, essential components of the process. Modern sensors often include HDR modes in which signal exposure times are interlaced, essentially constructing exposure mosaic images analogous to color mosaics. In this case, interpolation algorithms like those used for color interpolation can be used to create a high dynamic range image.

### Focus

For almost the last time, we here mention again that tomography is the fundamental problem in computational imaging. This discussion consists primarily of a tour of the three most common forms of tomographic imaging: spectral imaging, temporal imaging, and in this section, space. From a mathematical perspective, the challenge of imaging a 3D object from 2D measurements is akin for these three tomographies and the same measurement and estimation strategies can be applied. One can measure slice by slice, as in pushbroom tomography, frame-based video and focal imaging. One can make heterogeneous multiscale measurements using multispectral, multitemporal or multifocal arrays.

One can make spatially interlaced measurements using color filter arrays, event cameras or integral cameras

. Rather than explore the litany of possibilities in each case, we have discussed particularly illuminating examples in previous sections. We continue this strategy by discussing adaptive measurement in the present section. Adaptive measurement is an extension of any non-snapshot measurement strategy. When measurements are made in sequence, whether consisting of scanning spectral projections, different exposure times, or different focal states, one has the option to choose the next measurement based on previous measurements. This form of dynamic control is most common for focus, where it is called autofocus, but can also be applied for spectral or temporal sampling.

Conventionally, autofocus means setting the focus state of an imager such that the scene is in focus. This is impossible for images of 3D objects, so autofocus usually chooses to focus on some particular object or keypoint in a scene. The computational imaging system designer is unsatisfied with this approach and seeks instead to capture the entire focal data cube. We approach this challenge in three steps: first we describe what it means to capture the entire data cube (the focal stack), second we briefly review conventional autofocus strategies and third we describe a neural control strategy for efficient capture of the focal data cube of dynamic scenes. In contrast with neural systems using supervised learning, neural control systems rely on a reinforcement learning. Focal imaging is described by a shift invariant transformation in projective coordinates. he transformation between the spectral density in object space and the spectral density in image space is:

$${S}_{i} ( {θ}_{{x}^{′}} , {θ}_{{y}^{′}} , {θ}_{{z}^{′}} , v ) = \int \int \int {S}_{o} ( {θ}_{x} , {θ}_{y} , {θ}_{z} , v ) \times h ( {θ}_{x} + {θ}_{{x}^{′}} , {θ}_{y} + {θ}_{{y}^{′}} , {θ}_{z} , {θ}_{{z}^{′}} , v ) d {θ}_{x} d {θ}_{y} d {θ}_{z}$$

A camera typically samples the image space distribution over Cartesian pixels in the transverse domain, where the ideal sampling period is proportional to the natural limit λf/#. One may also choose to sample for discrete values of θₜ′. The hyperfocal distance [symbol] zₕ, leads to a natural sampling structure. The field from zₕ,/2 to ∞ is measured by focusing at zₒ=zₕ. The depth of field when focused at zₒ=zₕ/a spans:

$$\frac{{z}_{h}}{α + 1} < {z}_{o} < \frac{{z}_{h}}{α - 1}$$

For example, if we set the second focus at zₒ=zₕ/3, then the in-focus field runs from the near point zₕ/4 to the far point zₕ/2. to the far point zₕ. The full focal range from a near point of Zₙₑₐᵣ=zₕ/(a +1) to infinity is covered by N=(a+1)/2=zₕ/2Zₙₑₐᵣ focal positions for any odd value of a. More generally, the number of focal states needed to fully sample from near point Zₙₑₐᵣ to far point Z_{far} is N=(zₕ/2)(1/Zₙₑₐᵣ−1/Z_{far}). In practical systems, one is unlikely to sample a scene at all possible focal positions. Most scenes are sparsely populated with smooth transitions from one range to the next. Autofocus is the process of selecting which focal states to measure. Before discussing autofocus, one should note that the number focal states one needs to maintain focus over a particular depth of field is arbitrary system specification. The in-focus image for a fixed focal length lens varies in magnification over the depth of field, with the ground sample distance increasing linearly in range. If instead of just maintaining focus over the depth of field one also wishes to have constant transverse resolution then the focal length also changes with range. This can be achieved with varifocal or zoom lenses or with a lens array. Suppose that one wishes to achieve object resolution Δ over the range from Zₙₑₐᵣ to Z_{far}. Supposing that the longest longest focal length lens focuses at Z_{far}, one may set F₁=Z_{far} (λf/#)/A. The corresponding hyperfocal distance is:

$${z}_{1} = \frac{{F}_{1}^{2}}{{C}_{max} f / \#} = \frac{{λ}^{2} f / \#}{{C}_{max} {Δ}^{2}} {z}_{far}^{2}$$

The depth of field is:

$$DoF \approx \frac{2 {z}_{fax}^{2}}{{z}_{1}} = \frac{2 {C}_{max} {Δ}^{2}}{{λ}^{2} f / \#}$$

The DoF for a given object resolution is independent of the range to the object. This is because we have assumed that the imaging aperture is sufficient to achieve the given object resolution and the rate of diffraction of an object feature of size A is determined only by Δ and λ, not by the remote collection optics.

As an example, suppose that one seeks to image human faces with 100 vertical pixels on each face. Assuming that the extent of the face is 150 mm, this requires object resolution 1.5 mm. Assuming a wavelength of 600 μm,

$$\frac{{Delta}^{2}}{{λ}^{2}} \approx 6 \times {10}^{6} .$$

If Cₘₐₓ=2λf/#and the system operates at f/2 then the depth of field is approximately 12 meters. Improving the object resolution to 0.5 mm would reduce the depth of field by an order of magnitude. The number of focal lengths and focal states needed to achieve constant object resolution over a range is:

$$N = \frac{{z}_{far} - {z}_{near}}{DoF}$$

which is linear in the range and inversely quadratic in the desired resolution. Many different adaptive lenses and lens arrays may be considered to sample a scene. Let's turn now to how one can adapt a single lens to a scene.

A core assumption of conventional autofocus is that there exists a plane of best focus. This plane then found via one of the three strategies: (1) active ranging [13, 326, 333], (2) phase detection [13, 131, 163, 323] and (3) contrast maximization [110, 111, 127, 136, 174, 385, 391]. Active ranging uses structured illumination, time of flight or ultrasonic sensing to range objects of interest and adjust the focus accordingly. Phase detection uses light field sensors to measure the disparity between the current focus setting and the in-focus setting. Contrast maximization uses image quality measures to evaluate focal quality and search for optimal focus. Each strategy has advantages and disadvantages. Active illumination and phase detection can determine the correct focus in a single time step, and thus can be fast enough for dynamic scenes or moving objects, but require special hardware that adds cost and can degrade image quality. Beyond the need for specialized hardware, these methods miss the main point of autofocus in the age of artificial intelligence, which is that focus control should analyze scene content and motion to optimize the captured image. The classic assumption that a global “best” focus position exists is no longer viable. Even when specialized hardware is available, autofocus should be scene-based.

Conventional image-based autofocus combines a metric of focal quality with a multiframe search strategy to maximize the metric [110, 111, 127, 136, 174, 385, 391]. Learned metrics may be used to improve on ad hoc measures [60, 129, 133, 241, 263]. Neural methods may also be used to directly estimate the focus position from a single image, eliminating the need for a search strategy [164, 272, 273, 286, 371]. As an example, Wang et al. uses a simple CNN to evaluate the quality of current focus and the focal shift needed to reach best focus [359].

One point of these demonstrations is that autofocus, as conventionally defined, is not a dynamic process. If one seeks to characterize a scene from a single snapshot, there exists a single optimal focal state. A neural evaluator can immediately sense this state and move to it.

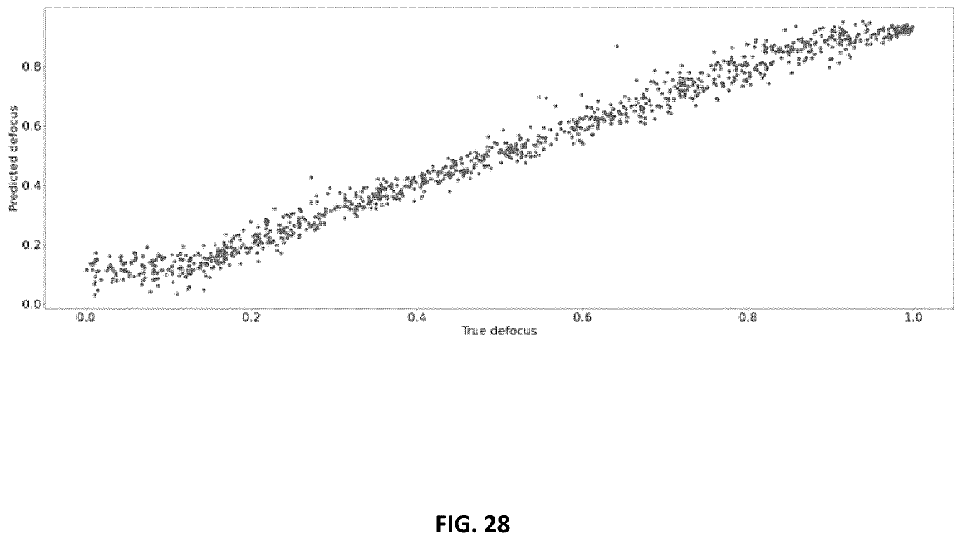

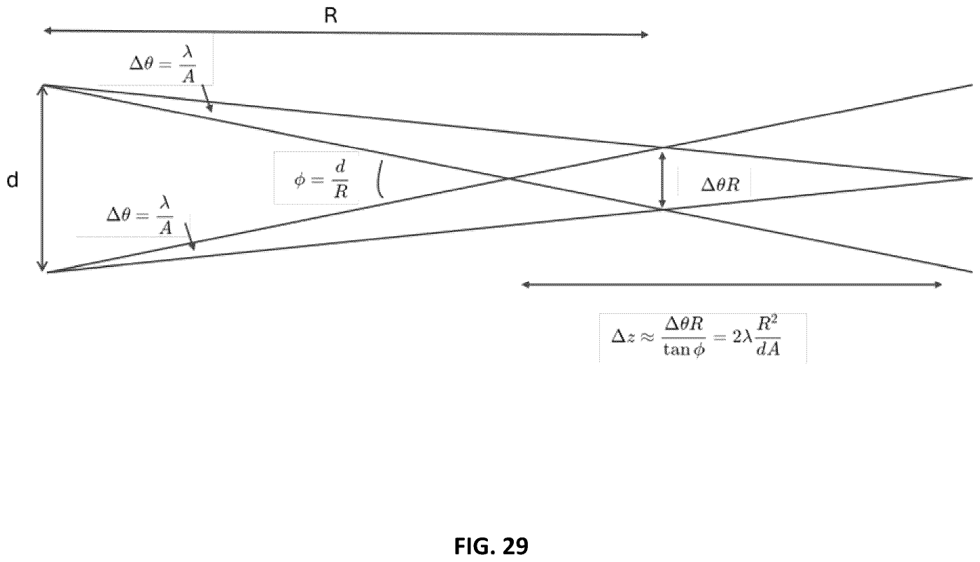

To illustrate an example of such an evaluator, consider the images drawn from the CIFAR10 shown in FIG. 27. The left version each image pair is the infocus image, the right is blurred by defocus. Where a conventional autofocus system can focus these images by searching for the focus parameter, a person, e.g. you the reader, has a good idea of the level of defocus simply by looking at the blurred scene. What a person can see, one may assume a neural operator can see as well. Here we model the system PSF with a Gaussian function and choose a random variance to blur each image. A three layer convolutional network is used for feature extraction and then a dense layer is used to estimate the defocus parameter. The accuracy of the defocus estimate is illustrated in the scatter plot of FIG. 28. While the system is not extremely accurate, focus itself is in accurate without fine features to analyze.

One may use the estimated defocus from the neural operator to move directly to the in-focus state, modulo the ambiguity that one cannot know the direction of the defocus. Thus, it may take two adjustments rather than one to find the focus. This ambiguity is likely to be obviated in practice by the fact that focus is a dynamic process. Just as we argue that a camera should consider data taken before and after the photographic moment when composing an image, focus should be continuously adjusting when the camera is on. We have shown in this example that focus quality can be evaluated from a small (32×32) image patch. An ideal focus control system evaluates focus quality over the entire scene and dynamically adjusts the state to optimized captured data.

More generally, one can view a camera as a data sampling system with diverse sampling parameters. These parameters may include the focus setting, the exposure time, spectral response and illumination. One can even dynamically control optical image stabilization for multiplex measurement [211]. Once one has specified the sampling parameters of the camera, one requires a control system to set these parameters. For example, a conventional camera may evaluate one or more test images to set the exposure and focus states. For computational imaging, however, one can develop substantially more sophisticated control strategies.

Reinforcement learning (RL) is the branch of machine learning that focuses on robotic control. Game playing systems, such as AlphaGo [318], are the most well known examples of reinforcement learning. Reinforcement learning consists of an agent that takes actions on an environment to optimize some reward. The agent acts according to a learned policy. In the case of a game, the agent takes moves, the environment is the score of the the game and the reward is an improvement in score. For a complex game it may be difficult to assign a score to the current state. For a robotic system, such as an autonomous vehicle, the agent controls acceleration, turning, and braking and the environment is the vehicle position. Rewards may focus on the distance of the vehicle from its goal as well as safety and resource measures. In comparison with these complex systems, camera control may seem relatively simple. One can use control and reinforcement learning on diverse scale in a camera. For example, Chan et al. uses RL to dynamically control focus with a phase detection focus measure. However, the most exciting use of RL in robotic imaging builds an end-to-end model wherein agent sets all camera parameters according to the policy and the environment is the current estimate of the object data cube. The reward is the quality of the estimated data cube according to focus or error measures.

Many design choices arise in scene estimation from adaptive measurement. The designer must determine both measurement strategy and the use of measured data. For example, one may use a set of defocus images to estimate the 3D object [54, 270] or one may estimate the in-focus image. Wang et al. compare a rule-based control strategy with a learned strategy that attempts to maintain an all-in-focus estimate of the scene [359]. The rule-based strategy uses an neural estimator similar to the one from FIG. 28 to build a defocus map over the current measured image. The system moves to the most popular estimated focal position. The neural system uses a multiframe memory to estimate where defocus will occur in subsequent frames. In both cases, the system combines the current estimate of the all-in-focus image and the current measurement to update the all-in-focus image.

A neural control strategy is detailed and illustrated [359]. A focus quality evaluator acts on both the current measurement and the current estimate to inform the agent, which determines the next focal position by estimating which scene window will be out of focus in the next estimated frame. A control strategy for all-in-focus imaging with reinforcement learning is particularly detailed, together with measurements and estimates from an experimental system.

As discussed at the start of the Spectral Imaging discussion, interlaced, manifold and temporal strategies may be used to recover tomographic spectral, temporal and spatial information. These strategies are not independent and may be applied in diverse ways to sample the full optical data cube. The next section considers another coding mechanism in the form of structured illumination and the final two sections finally discuss practical aspects of camera system design.

### 3D Imaging

While we have discussed numerous tomographies in this disclosure, estimation of object density over the spatial xyz volume remains the canonical example. As indicated by the variety of approaches, spatial tomography may be captured by a variety of mechanisms. The current section focuses on the strategies most relevant to photographic imaging.

Ironically, photographic 3D is generally not tomographic in the sense that one is not usually interested in reconstructing a 3D density function f(x, y, z). Rather photography generally deals with opaque objects. For such objects a goal may be to characterize the range to the object in each pixel and the emittance of the object at that pixel. (Emittance is the irradiance at the surface of the object.) The object distribution may be function:

$$f ( {θ}_{x} , {θ}_{y} ) = [ \begin{matrix}I ( {θ}_{x} , {θ}_{y} ) \\ R ( {θ}_{x} , {θ}_{y} )\end{matrix} ]$$

where I is the emittance and R is the range from the camera center of projection. More generally, one may seek to image the radiance on the surface, which would increase the dimensionality of the object distribution. Here, however, we assume that we only wish to characterize the range and irradiance from a single view point.

The Fourier uncertainty for ranging an object from defocus or coherence analysis depends on the transverse texture of the object. If the object is a smooth featureless wall, then its image does not blur on defocus and no range information is obtained. Maximal range information is obtained from object spatial frequencies near

$$u = \frac{1}{2 λ f / \#}$$

where the both the transverse passband and the defocus blur are nonzero. Assuming that the object has features at these frequencies, we found that the Fourier range uncertainty is

$$λ z \approx 8 λ \frac{{R}^{2}}{{A}^{2}} ,$$

where R is the range and A is the aperture. Based on the fact that the true range has only one value, one may expect to beat this limit using a nonlinear estimator by a constant factor of 10×-100×. One may also use more sophisticated priors, such as the known transverse size of the object or object relationships to estimate range. Single image depth perception based on such strategies has been highly successful [62], but here, as elsewhere in this disclosure, our focus is on improving data quality for computational imaging without reference to high level image semantics.

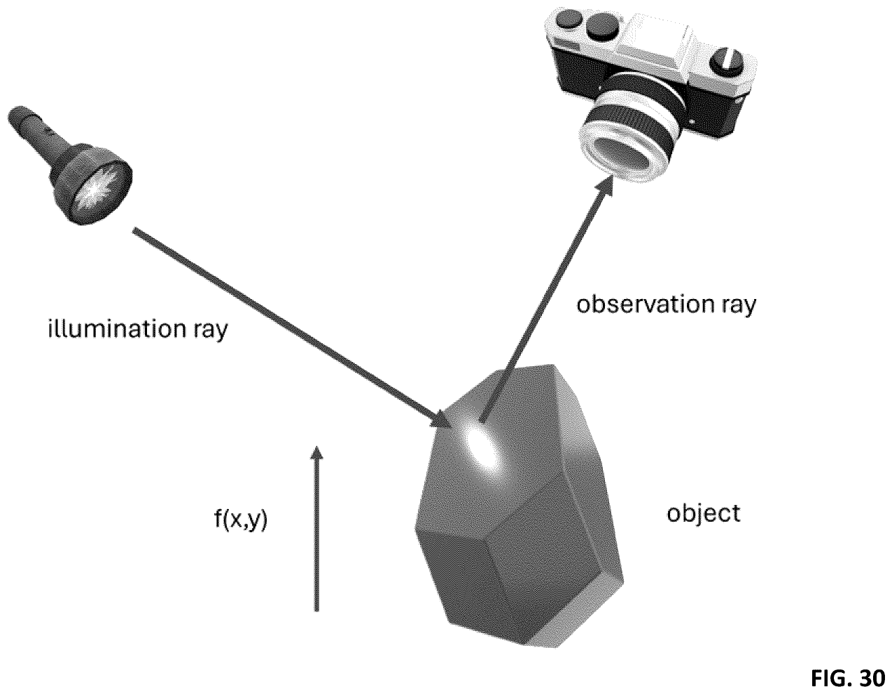

Multiple viewpoint triangulation is one method to decrease range uncertainty. Images captured from a complete vertex path can be inverted via the projection slice theorem to reconstruct the 3D object. Images sampled from an incomplete vertex path suffer from a missing cone, which reduces the range of the sampled object Fourier space and leads to undercertainty. For objects, as considered here, with only a single range value per pixel, triangulation is often implemented on stereo camera pairs. This process is illustrated for a single object point in FIG. 29. Observations from centers of projection separated on a baseline of length d observe the same object point. The cones emanating from the observation point correspond to the angular uncertainty Δθ=λ/A.

While angles between the near and far edges of these cones differ in FIG. 29, for narrow cones at long ranges with actual cameras these angles are approximately equal. Additionally, the cross section of the intersection is approximately equal to the ground sample distance, ΔθR. As illustrated in the figure, the angle of intersection of the cones is φ=d/R. Assuming that the actual observed object point could be anywhere within the intersection of the two uncertainty cones, the range uncertainty is:

$$Δ z = 2 λ \frac{{R}^{2}}{dA}$$

Stereo ranging thus improves the range resolution the factor 4 (d/A) relative to single aperture systems. As an example, if R=10 m, d=10 cm, λ=1 cm and 1=.5 μm, depth from defocus yields Fourier range uncertainty of 4 m, while stereo has uncertainty 0.4 m. In both cases, nonlinear estimators are likely to improve resolution by an order of magnitude, moving to .4 meters for depth from defocus and 4 cm for stereo.

While it is possible to capture range using defocus or stereo, spectral diversity beats angular diversity for ranging in a reflection geometry. For this reason, time of flight cameras are commonly used to resolve range. A way to resolve range by time of flight is to illuminate with a source pulsed source. If p(t) is the pulse envelope, the return signal in a given pixel would be p(t−2R/c). Assuming that one has sufficient temporal resolution to measure the pulse, the approximate range resolution is Δz=c/2t, which means that a femtosecond pulse may resolve range to .3 μm while a one nanosecond pulse may resolve range to 30 cm. Note that, in contrast with projection methods, the range resolution is nominally independent of range. (Nominally in the sense that we assume the ability to resolve the target in cross range.). Interferometric methods may be more effective than direct sampling in measuring temporal signals. Rather than directly measuring the time of flight of a pulse, one may use swept frequency source or multiple wavelengths to measure range. One means of achieving this in time of flight cameras is to transmit an amplitude-modulated optical signal, I(t)=I_{φ} (1+cos (ωₜ)). The return signal is then I(t)=Iₒ(1+cos (ω(t−2R/c))). The accuracy with which one can estimate R now depends on the accuracy with which one can estimate the phase φ=ω2R/c. Practical time of flight sensors measure I(t) with lock-in measurements [102], which may measure the signal by phase quadrature using the four bucket method [64]. Details related to such methods are likely to introduce their own error sources, but for present purposes it is interesting to focus on fundamental uncertainties in estimating R. Assuming a Poisson process, for h(t, φ)=Iₒ(1 +cos (ωₜ+φ) the Fisher information is [symbol] xₒ)=IₒT=N, where T is the total observation time for the signal and N is the expected number of photons measured over time T. The Cramer-Rao lower bound on the variance in estimating φ is then 1/N. The standard deviation in estimating range may be:

$$Δ R = \frac{c}{2 ω \sqrt{N}}$$

If, for example, the modulation frequency is 20 MHz, then the standard deviation under the CRLB is

$$Δ R = \frac{2.4}{\sqrt{N}} m .$$

### Assuming N=10,000 the CRLB is 2.4 cm.

This method also leads to ambiguity, however, because φ is only known modulo 2π. The ambiguity-free distance range is

$$L = \frac{π c}{ω} .$$

Again at 20 MHz, L=7.5 m. If more than one range is possible, auxiliary measurements must be used to disambiguate. For example, coarse range stereo may be combined with fine range ToF or one may measure the range with multiple modulation frequencies [267]. Multiple frequency measurements are closely related to synthetic wavelength holography methods; with two wavelengths the ambiguity free range becomes the synthetic wavelength rather than the individual modulation wavelengths. Due to the need for multiple phase samples per pixel, pixel circuits for ToF cameras are large and complex, which in turn means that the pixel count tends to be low. Typical ToF cameras may resolve just 10−100 kilopixels. This limitation can be addressed by fusing ToF imagery with higher resolution conventional images, several commercial ToF cameras integrate ToF and staring focal planes for this purpose [148]. We can combine temporal ToF modulation with spectral or spatial illumination codes, or with the temporal sampling strategies discussed above. The resulting arrangements can be implemented in single aperture range imaging cameras and in heterogeneous arrays of range and cross range cameras.

### Active Illumination

Active illumination for image capture dates to the origins of flash photography, but with the development of lasers, light emitting diodes and spatial light modulators, a vast variety of illumination schemes can be utilized. Time-of-flight cameras are a tool for 3D scanning and Fourier ptychography can be implemented as a form of super-resolution via coded illumination. Coded illumination lies in the family of strategies one may use to capture the multidimensional optical data cube. Projection tomography and diffraction tomography [331], are canonical examples of the use of illumination sequences to characterize 3D objects. Various compressive sampling and estimation strategies can extend these applications. This section further extends this analysis by making the nominally simplifying assumption that we wish to measure the 3D surface of remote objects rather than a true volume distribution. The impact of this simplifying constraint is to make the forward model nonlinear. The problem becomes one of parameter estimation rather than a transformation on complementary distributions. As discussed here, this substantially impacts the spatial resolution one may achieve in 3D imaging. As with previous sections, the analytical and estimation methods discussed in this section can also be applied to other multidimensional imaging systems.

As we have seen, computational imaging requires an accurate forward model describing the relationship between object parameters and measurement. When illumination is included, the forward model includes a relationship between the illumination, the object and the measured field. Illumination is commonly used in microscopy, where depending on the application one may measure the bright field, consisting of the illumination signal as attenuated by the object or the dark field, consisting of the illumination scattered by the object. Alternative strategies measuring the fluorescence or phase contrast are also popular. A particularly simple form of tomographic slice selection is achieved by light sheet microscopy [255], which illuminates a 3D sample obliquely with a collimated line of light. Light sheet microscopy uses illumination to select which region of the object is observed. More advanced approaches localize the field of regard using nonlinear optical effects such as stimulated-emission depletion and single molecule localization [268].

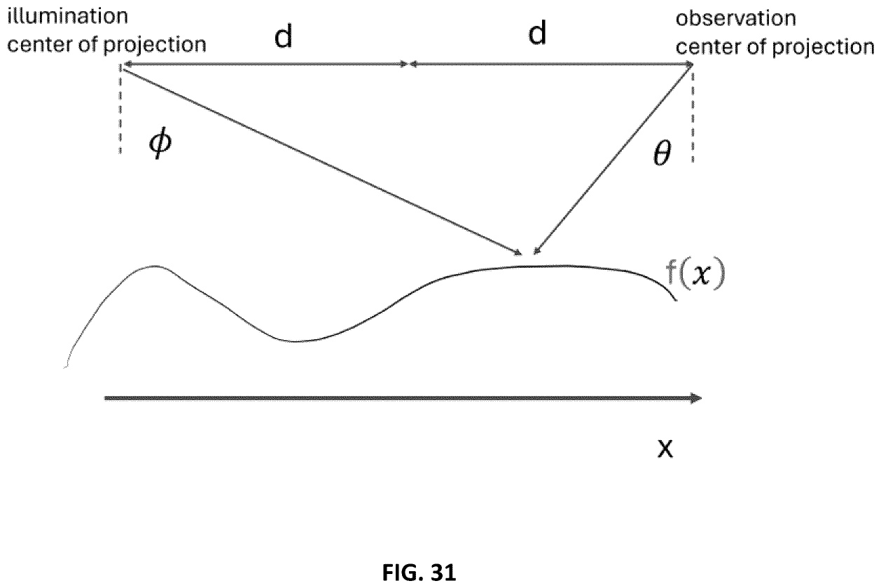

Here we focus on the simpler form of structured illumination imaging illustrated in FIG. 30. An object is illuminated by a source through the source center of projection v₁. The object is observed by a camera with camera center of projection v₂. A forward model for the camera image in this system can be derived using a scatter or absorption model for projection tomography, but in most cases one is imaging surface reflections for which a volume tomographic model is not appropriate. Let's suppose for simplicity that the object can be parameterized by the xy plane and that at each xy point the height of the object is z=f(x, y). The illumination ray

φ=[x,y,f(x,y)]−v₁

illuminates the object at xy. This ray is observed by the camera along the ray

θ=[x,y,f(x,y)]−v₂.

Thus, if one illuminates with ray φ and observes a signal along ray θ then one knows that the object surface reflects at point [x, y, z=f(x, y)]. This analysis is the basis of 3D scanning by laser triangulation [10⁴]. Simple approaches scan diverse illumination directions with a laser spot, more sophisticated systems may scan with a line. The problem, as always with multidimensional imaging, is that scanning takes time.

Before considering more sophisticated strategies, let's briefly consider the spatial resolution of laser scanning. In measuring the signal at unit vector 0 with illumination unit vector φ we know that there exist a and B such that:

$$( αϕ + {v}_{1} ) = ( βθ + {v}_{2} ) = [ \begin{matrix}x \\ y \\ f ( x , y )\end{matrix} ]$$

With φ, v₁, θ and v₂ known from the measurement system, one can solve the first set of equations,

α(φ+v₁)=β(θ+v₂)

for unique values of α and β. Such a solution exists only for choices of φ, v₁, θ and v₂ that lie in an epipolar plane; within such a plane we find coordinates α and B such that the illumination and observation rays meet.

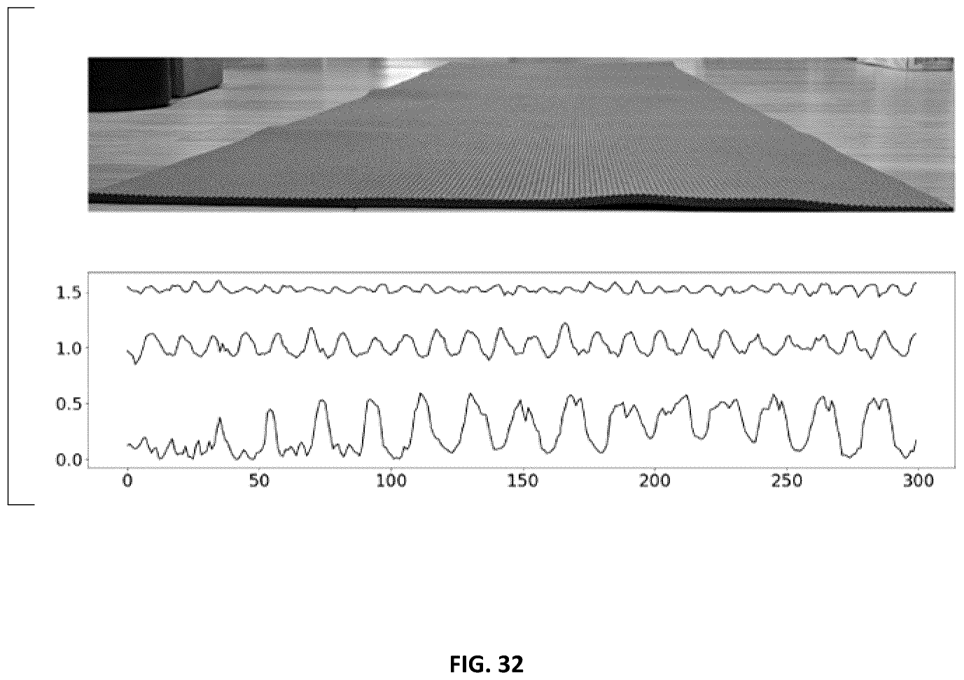

Letting the xz plane correspond to the epipolar plane, one can parameterize laser point scanning as shown in FIG. 31. The center of projection of the illumination system is at d=−x, z=0 and the center of projection of the observing camera is at d=x, z=0. We assume illumination by a focused laser spot. The laser spot incident along the ray making angle φ with the z-axis intersects the surface of the object at point x, z=f(x). This spot is observed by the camera along a ray at angle θ from the camera center of projection. Analysis of the triangles made by these coordinates yields:

$$\begin{matrix}tan ϕ = \frac{d + x}{f ( x )} \\ tan θ = \frac{d - x}{f ( x )}\end{matrix}$$

from which we find that when the object illuminated at angle φ is observed to reflect to the observation angle θ then the observed surface point is:

$$\begin{matrix}x = d ( \frac{tan ϕ - tan θ}{tan ϕ + tan θ} ) \\ f ( x ) = \frac{2 d}{tan ϕ + tan θ}\end{matrix}$$

In practical systems, the illumination and observation angles are imprecisely known because the illumination and observation apertures are finite. We have seen that diffraction limits the angular resolution to approximately 80=1. One can estimate the impact of this uncertainty measurement of x and z=f(x) as:

$$Δ x \approx \frac{\partial x}{\partial θ} Δθ and Δz \approx \frac{\partial z}{\partial θ} Δθ$$

Ignoring for a moment the uncertainty in φθ and assuming that the illumination and observation plane is sufficiently far from the object for one to assume that tan φ ≈φθ and tan θ≈θ, to lowest order in θ this yields:

$$\begin{matrix}Δ x \approx \frac{z}{2} Δθ \approx \frac{λ}{2 A} z \\ Δ z \approx \frac{{z}^{2}}{2 d} Δθ \approx \frac{{λz}^{2}}{2 Ad}\end{matrix}$$

One may compare with the resolution

$$Δ z = \frac{8 λ {z}^{2}}{{A}^{2}}$$

for a single aperture imager. Observation of an object spot from two centers of projection, whether by illumination scanning or by stereo projection improves the resolution of range resolution by the factor A/2d, where 2d is the separation of the centers of projection. Assuming, for example, a 1 cm aperture at a range of 10 m with λ=0.5 μm a single aperture has range ambiguity of more than a meter, but two apertures separated by 10 cm would may resolve range to less than 10 cm.

Typically, one may assume that the illumination angular certainty Ap and observation uncertainty Δθ are of similar magnitude, which will increase uncertainty in x and z. However, the observation system typically observes over a field of view over which geometric aberration becomes important. From an optical design point of view, it is easier to project a single well focused spot than to maintain diffraction limited quality over a wide field of view. If the illumination is a coherent laser beam then adaptive beam forming may be used to focus on the object even in the presence of turbulence or obscuration in the illumination path. In this case, Ap may be substantially less than Δθ. Careful scanning of the illumination may then enable super-resolution beyond the limits indicated by the above pair of equations.

To analyze this possibility, consider a simple 2D imaging model with illumination t (x, y) such that:

$$g ( {x}^{′} , {y}^{′} ) = \int \int f ( x , y ) t ( x , y ) h ( {x}^{′} - x , {y}^{′} - y ) dxdy$$

It is possible, in principle, to use this model to achieve arbitrarily high resolution in imaging f(x, y). If t (x, y)=δ(x−xₒ, y−yₒ) then g (x′, y′)=f(xₒ, yₒ) h(x′−xₒ, y′−yₒ). More generally, the effect of object modulation is to shift the passband of the imaging system. For Fourier ptychography, one selects (x, y) =e^{2π}. For incoherent imaging, in contrast, t (x, y) must be real and nonnegative, but it is still possible to use a diversity of illumination patterns to increase the passband. Super resolution by structured illumination is most popular in microscopy, where it can be applied in bright field, dark field, fluorescence [140, 303]θ and ptychographic versions [181, 402, 404].

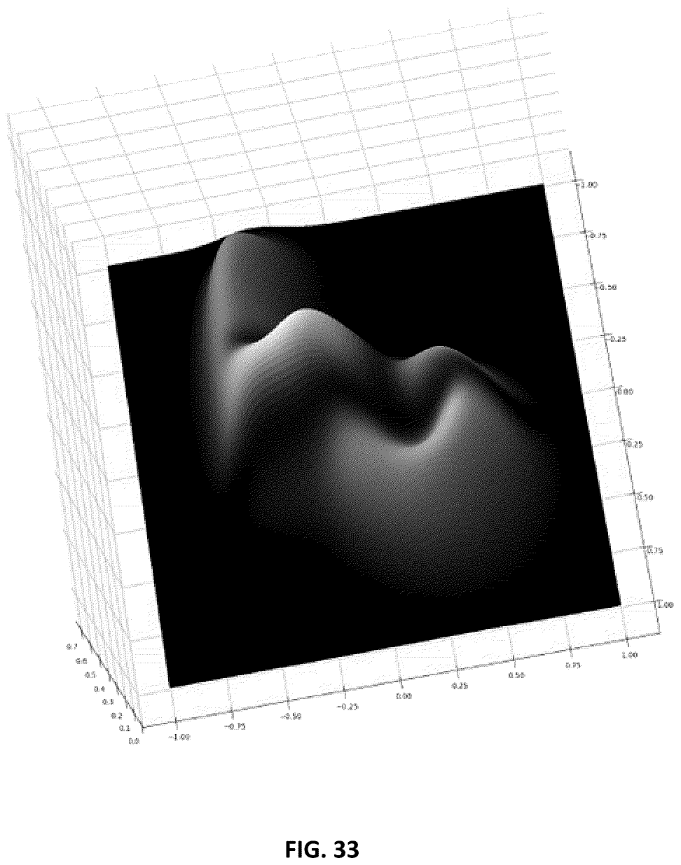

As mentioned earlier, this section considers a different perspective on structured illumination. We are interested in using illumination to determine the range or surface profile of objects. Paradoxically, we consider this question using the image of a yoga mat shown in FIG. 32. The mat consists of periodic ridges, plots of horizontal lines across the mat are shown at the bottom of the figure. The actual period of the modulation is independent of range along the mat but as shown in the plots the apparent frequency of the modulation increases with range. We model the object reflectance as f(x, z)=1+cos (2πux), e.g. as periodic in x and independent of z then the observed image. The image may be measured in projective space as:

$$\begin{matrix}g ( {θ}_{x} , z ) = f ( x = {θ}_{x} z , z ) \\ = 1 + cos ( 2 π u {θ}_{x} z )\end{matrix} ,$$

meaning, as seen in FIG. 32, we observe an image with apparent frequency proportional to range. In this image, different ranges appear at different points in y due to the height of the camera above the yoga mat. The x direction corresponds to the horizontal axis. The frequency along the θₓ axis is uz, so if we know u we can estimate z. It helps in the present case to know that the range to the front of the yoga mat was approximately 2 meters. If the frequency at the back of the mat is twice the frequency at the front, then we know that z has increased by a factor of 2 and the range is 4 meters.

A question here is “how accurately can one measure z for a given slice of the yoga mat?” The Cramer-Rao lower bound on the variance for estimation of uz is proportional to 1/θ²N, where Θ is the angular extent of the object at range z and N is the number of photons collected. In the present case, N141 1 and u=4 mm, indicating that careful analysis can yield sub mm ranging from several meters away.

We do not generally seek to image periodic objects (and more careful analysis would consider how the apparent image chirps for a periodic object at range z). But we can project periodic or other coded patterns onto objects. The forward model for this case takes the basic form of the equation given above for g (x′, y′), but care must be taken to scale the illumination code from the illumination center of projection and the image magnification from the camera center of projection. For laser scan imaging, we consider this scaling as a point by point operation. When illuminating with a coded pattern, disambiguation of variations in the surface reflectance and the illumination code becomes a pattern.

This ambiguity is at the heart of every compressive tomography system we have considered. With coded aperture spectral imaging, one uses local spatial modulation to encode spectral data under the assumption that the underlying spatial pattern is sufficiently sparse or slowly varying. The same approach is taken with coded aperture temporal imaging and compressive x-ray tomography. Mixing of spatial frequency and spatial information lies at the heart of spectrogram analysis for phase retrieval and ptychography.

We have considered various algorithms for inversion of coded patterns, including constrained optimization, error reduction and neural methods. Ultimately, these algorithms may be implemented in hybrid layers, but the ability of perceptrons to find and transform patterns has emerged as a critical component of computational image estimation. In the present case, we found in the paired equations for x and f(x) given above that the solution for a surface point is a nonlinear transformation of the measurement parameters. Historically, fringe projection profilometry has applied similar nonlinear transformations on registered points in the measured data [368, 381]. This approach, however, requires precise calibration and does not account for the ambiguity of reflectance and surface data in estimating the object.

Using neural processing, one can eliminate the need for analytic inversion of the surface profilometry problem. While we have emphasized algebraic forward models throughout this disclosure, in most cases imaging is substantially more complicated than inverting g=Hf. While it may be possible in the present case to develop an analytical forward model, implicit modeling is much simpler. As an example, we develop a forward model for a particular set of objects and use a UNet neural estimator to estimate the height and reflectance of the objects.

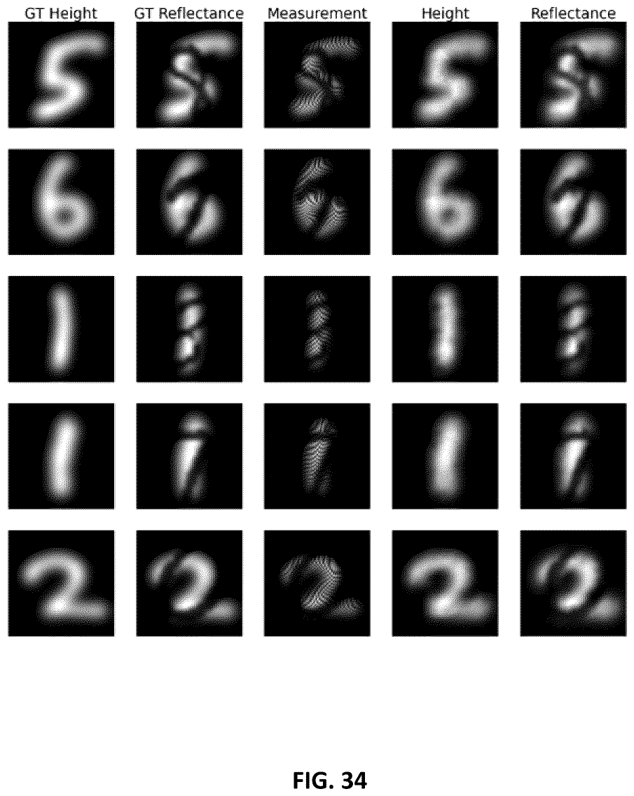

The example objects used are again the MNIST data set of hand drawn digits. The objects are initially 28×28 images, in this example the images are up sampled to 128×128 using cubic spline interpolation and are then convolved with a Gaussian filter. We treat the MNIST image as a map of height of the image, with the maximum height normalized to 1. To create a model reflection for each image, we imagine that the product of a randomly selected second MNIST image and the current height map is the reflectance. This model affords a library of training and test images. An example training object is illustrated in FIG. 33.

We imagine that the object is illuminated by the pattern t (θₓ, θ_{y})=1+sin (2πxθₓ) sin (2πufy), where θₓ and θ_{z} are projective coordinates measured from the illumination center of projection. The illuminated object is observed from the camera center of projection. The object is distributed across the xy plane and is described by the height h (x, y) and reflectance r (x, y) functions. For each value of xy one calculates the illumination angle and the observation angle. The observed signal value is the product of the illumination at the illumination angle and the reflectance. We ignore the possibility that some points on the object are shadowed from the illumination.

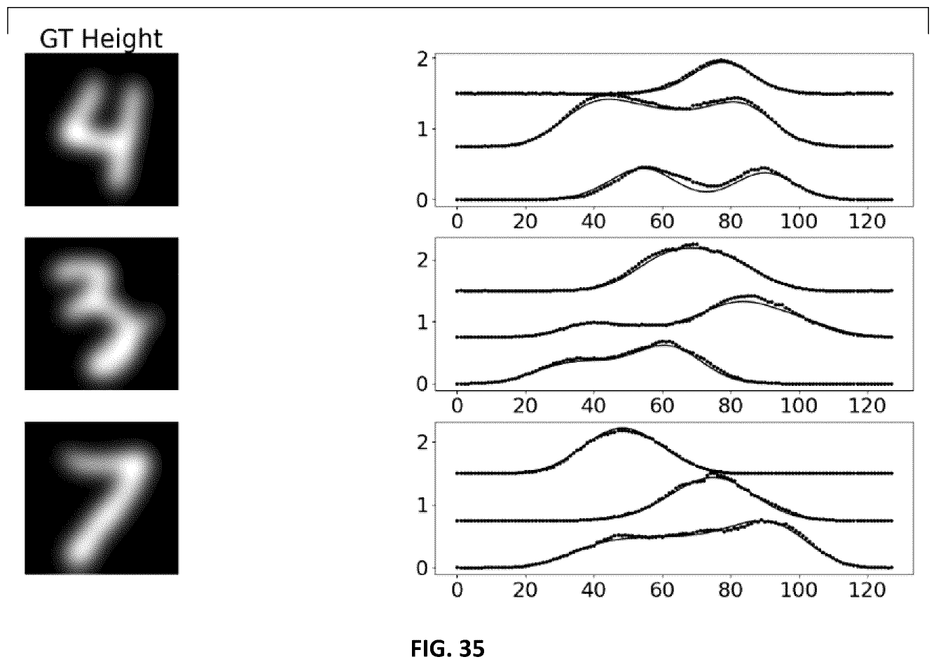

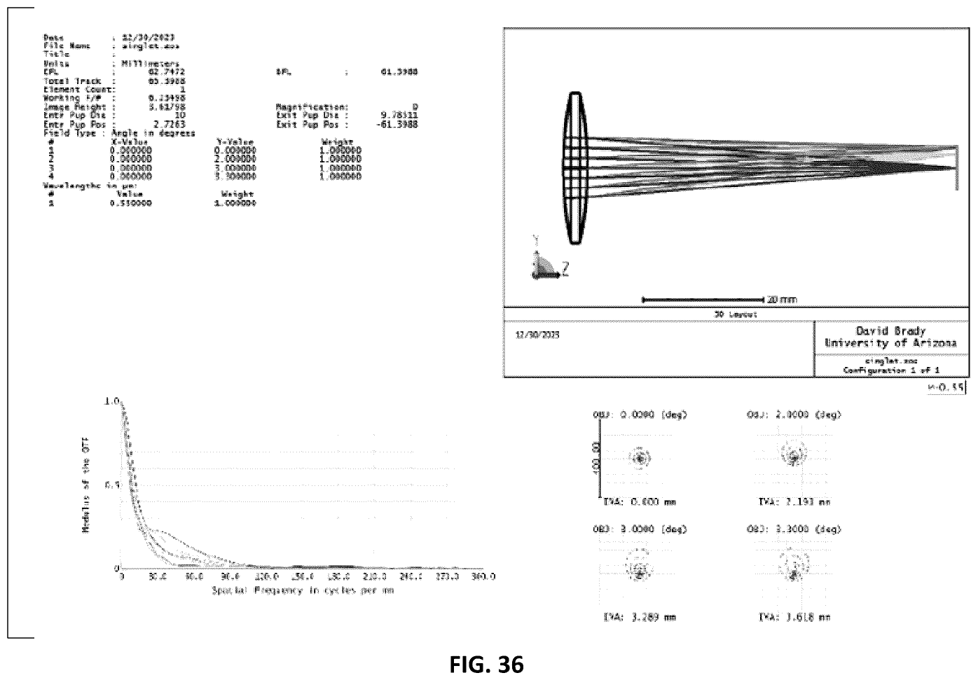

As a simple example, a UNet used for holographic estimation was trained with input observed images to reconstruct height-reflectance pairs. Example reconstructions are illustrated in FIG. 34. The center column shows the simulated measurements. The left columns represent ground truth and the right are estimated from the UNet. FIG. 35 shows cross sections through the height map as estimated by the neural system.

In this particular example, the transverse dimension is 28×28 units and the maximum height is 1. The illumination is 10 units from the object and the illumination frequency is 150 inverse units, corresponding to an angular resolution of approximately 0.095. The observed image is scaled by magnification 125. If the range corresponds to 1 meter and the object is 2.8×2.8 meters, this magnification may be achieved with a 8 mm focal length observing lens. The model separation between the observing point and the illumination point is approximately 0.5 meters in this example. The paired equations, above, for Δx and Δz indicate that with 0.8 μm illumination this system may achieve 100 μ longitudinal resolution in a laser scan. The achieved resolution illustrated in FIG. 34 is consistent with this limit. Neither the illumination code nor the estimation network has been optimized, however, so one may expect better results with more development. The full reconstruction operates in a snapshot; dynamic systems may use scanned or adaptive illumination. The point is to show that an implicit forward model can be inverted with pattern substitution in neural processing to obtain a deeper understanding of compressive multidimensional system design. Beyond the spatial patterns we have considered here, coded illumination may also include diverse spectral and temporal patterns

### Lens Design

Lens systems perform the service of mapping the modes focused on a point in object space onto modes focused on a conjugate point in image space. In view of the very low photon density per mode in natural light, lens processing is absolutely essential to optical imaging. It is somewhat ironic, then, that lens design is not a central focus of this specification. To a certain extent, this is expedient; our model for a lens as a physical system for creating a focusing wave in image space bandwidth limited by the exit pupil is an accurate description of the lens function independent of the complexity of the actual lens. To a larger extent, however, we do not focus on lens design here because the challenge is so vast that it justifiably requires its own text. Many wonderful texts cover the history and practice of lens design, Kingslake's history and Lens Design Fundamentals by Kingslake and Johnson are favorites. Jos′e Sasia′n's texts present a modern review [300, 301].

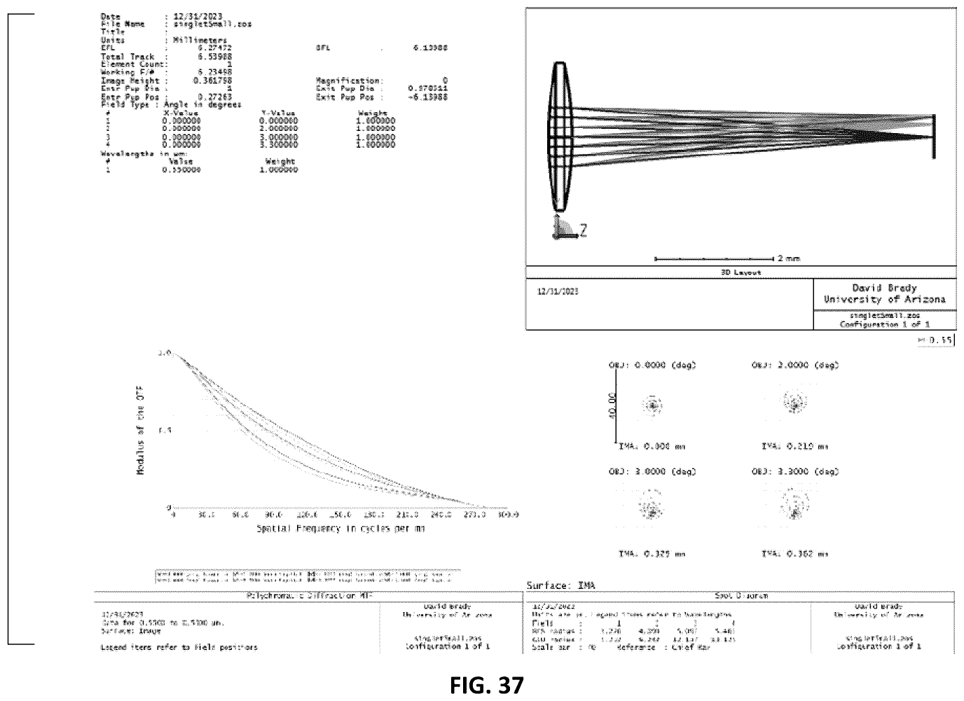

While imaging system design is much too vast a topic for a single individual to be expert in lenses, sensors and algorithms, the system designer does require a basic understanding of the utility and limitations of these components. Most of this disclosure focuses on the forward model and inverse algorithms, but we considered electronic sampling issues in the Electronic Sampling discussion above, and we briefly consider lens design here. Let's begin by considering an actual single lens. FIG. 36 is a ray tracing analysis for a lens consisting of a solid piece of BK7 glass evaluated at a single wavelength (1=550 nm) using the Zemax design environment. The spot diagram at lower right shows the intersection in the image plane of ray bundles nominally focused on the center of the image field and 2 and 3 mm above the center. For an ideal lens, these rays would all cross in single point. The full scale of the spot diagrams is 400 μm, each grid square is 40 μm. This lens works at f 6.2, meaning that the diffraction limited bandpass should be

$$u = \frac{1}{λf / \#} = 293 line pairs / mm ( lp / mm ) .$$

The achieved MTF is calculated from discrete Fourier analysis of the actual focal wave front at various field points. As illustrated in the figure, geometric aberration leads to an achieved MTF much worse than diffraction limited models would indicate. In deriving our lens model, we often assume that the spherical lens surface could be approximated by a parabola and that the lens itself could be modelled as a simple transmittance function. As illustrated by the performance of our actual lens, these assumptions are not generally valid. However, the end result of lens processing is still a wave focusing on a focal spot in image space. We use the complex wavefront at the exit pupil at each image point as the pupil function for each image point. The poor modulation transfer results illustrated in FIG. 36 arise from the fact that this wavefront is aberrated. The goal of lens design is to use a sequence of surfaces to reduce wavefront aberrations.

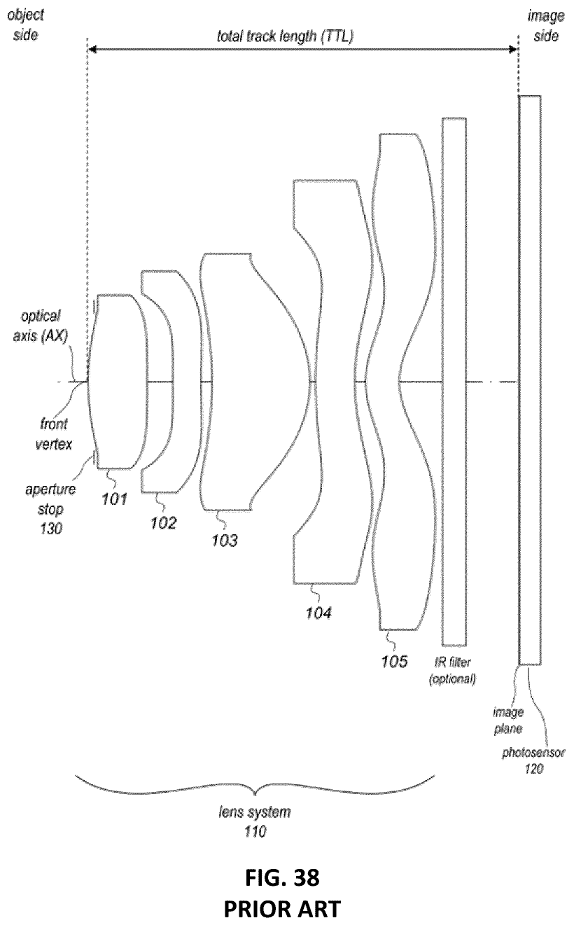

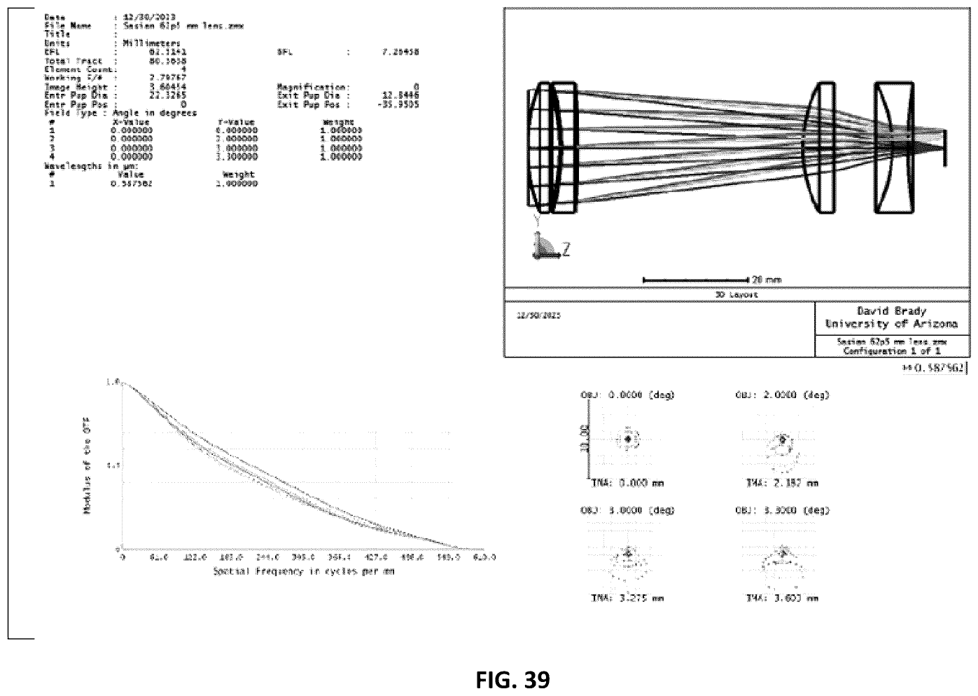

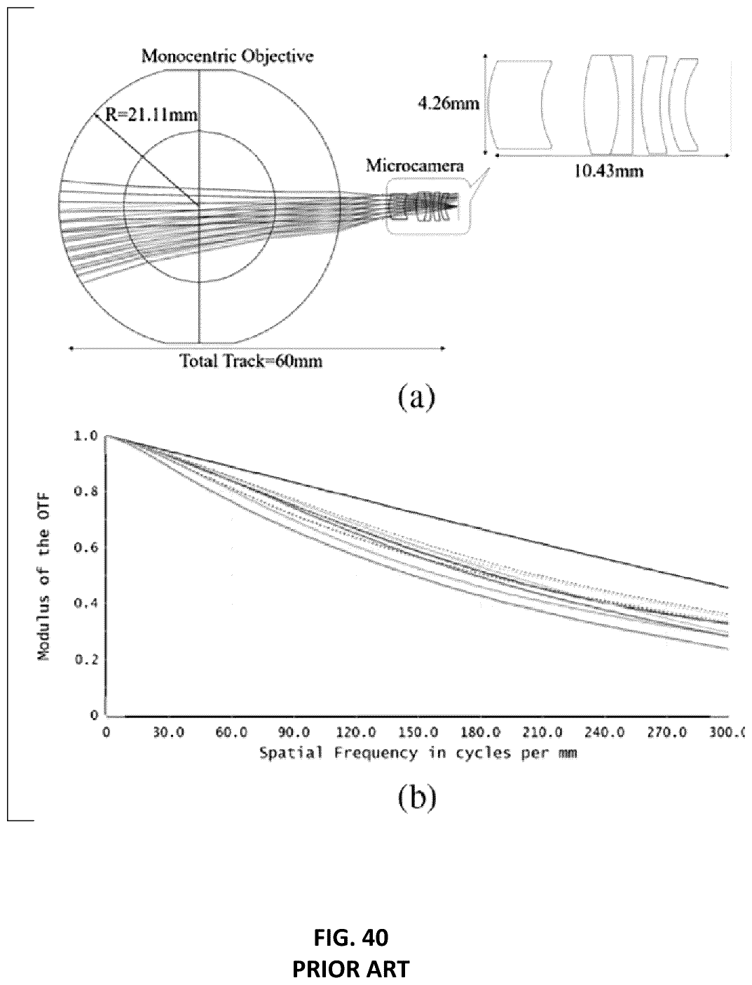

One way to reduce wavefront aberration consists of simply reducing the scale of the system aperture. FIG. 37 repeats the analysis of FIG. 36 when the system scale is reduced by 10×, moving from a 62.7 mm focal length to 6.27 mm. The spot diagram remains the same, but the scale is reduced from 400 μm to 40 μm. Because the scale of the ray aberration relative to the wavelength is reduced by 10× the phase of the wavefront error reduced and system performance becomes close to diffraction limited. However, one does not generally have the option of reducing aperture size to improve lens performance. Angular resolution of an imaging system is proportional to Typically, the angular resolution is the defining characteristic at the start of design and the target aperture size is thus predetermined. To achieve diffraction limited resolution for a given aperture size, one must increase lens complexity by adding surfaces or components to reduce wavefront error. Even for the small system of FIG. 37 the field of view and f/#are still limited and the MTF is imperfect. Lens designers overcome these limitations by increasing lens complexity. For example, FIG. 38 shows a compact lens design from a 2021 US patent consisting of 5 aspherical components in close contact with the image sensor. As second example, FIG. 39 presents a design analysis for Petzval-style lens designed to match the focal length and size of the singlet of FIG. 36. This lens was designed by Professor Sasia′n to work as a narrow field objective in array cameras. The primary design goals were a compact track and f/2.7 imaging over a sensor-limited field.

Petzval introduced his eponymous design in 1840. Coming just a decade after the invention of photography, this lens was the first lens system designed using mathematical analysis and improved effective f/#by more than an order of magnitude. Over the subsequent history of photographic systems, just a few additional lens families were developed, such as the Cooke triplet and the double Gauss [178]. Most photographic lenses developed from 1840 through 2000 can be assigned to one of these families. Since 2000, however, lens design has entered a new phase. What changed in 2000? Solid state sensors finally began to replace photochemical film. Solid state focal planes were famously demonstrated at Kodak in 1975 and commercial cameras using solid state arrays were introduced by Kodak, Sony, Apple, Nikon and Canon in the 1990s. Solid state sensors entered the mainstream in 2000, however, after Nikon introduced the D1 digital back, compact digital still cameras came to market and, most critically, the camera phone was introduced [143].

Digital sensors change camera design in fundamental ways. At first, however, digital cameras were simply film cameras with digital backs, like the Nikon D1. It is important to understand, however, that the fundamental purpose of a digital camera is different from the fundamental purpose of a film camera. A film camera produces a physical photograph. A digital camera produces data. Cameras changed from something that produces images to something that transduces optical signals into digital data. While this transformation has many fundamental implications, one of the more mundane implications is also deeply impactful on lens design. A film camera requires a mechanism for separating the recording medium from the lens. With a solid state back, the lens and the sensor may be permanently conjoined on manufacture. This simple difference enables digital cameras to adopt much more complex and critically aligned optical designs, such as the design illustrated in FIG. 38.

Lens design includes many challenges beyond just finding a set of surfaces that optimize MTF over a field of view. One must also consider mechanical and thermal tolerances, focus and chromatic aberration. Since film cameras had to allow for separation of the lens and the sensor, for 100 years they relied on standard backs with interchangeable lenses. Such lens systems cannot be manufactured with tolerances consistent with f/2 operation. For this reason, mobile phone cameras operating near f/2 have largely displaced interchangeable lens systems operating at f/10 because mobile systems achieve competitive image quality in a system with >100× smaller volume. More broadly, solid state image sensors enable computational imaging. The primary impact of computational imaging on lens design is that it creates demand for a radical increase in system information capacity. There is relatively little need for a physical image consisting of gigapixels or terapixels, but there is no reason for a digital imaging system not to capture all possible information in the optical data cube. In fact, maximizing information capture is our goal. To achieve this goal, we need novel lenses.

Paradoxically, a lens design that achieves diffraction-limited imaging over an arbitrarily wide field of view at any lens scale was already discovered by Maxwell in 1854. The Luneberg lens and the Maxwell fish-eye are graded index designs that focus parallel ray bundles on the surface of a sphere [216]. These designs are seldom used, however, because they are challenging to fabricate, unwieldy and because spherical focal planes are not widely available. There are continuing efforts to develop curved solid state focal planes and once such focal planes become available one imagines that they will be a useful component in camera systems. Here we pause to give a name the new age of lens design that began in 2000. The 20th century was the interchangeable lens cameras age, 2000 began the microcamera age. A microcamera, as used herein, is an integrated system with a lens and electronic sensor manufactured as a single piece, forever coupled together. (The lens need not be bonded immediately to the sensor. They both, for example, can be forever bonded to an intermediate member, such as a structural member.) Microcamera integration enables fast optics and tight tolerances consistent with the lens designs shown in FIGS. 38 and 39. Similarly, microcamera integration enables innovative sensor development, as in curved focal planes. Designing the lens and the sensor to match and manufacturing them together enables wide field f/2-scale image. A microcamera is a species of an imager, or camera module, which includes a lens and a sensor, but not necessarily forever bonded together.

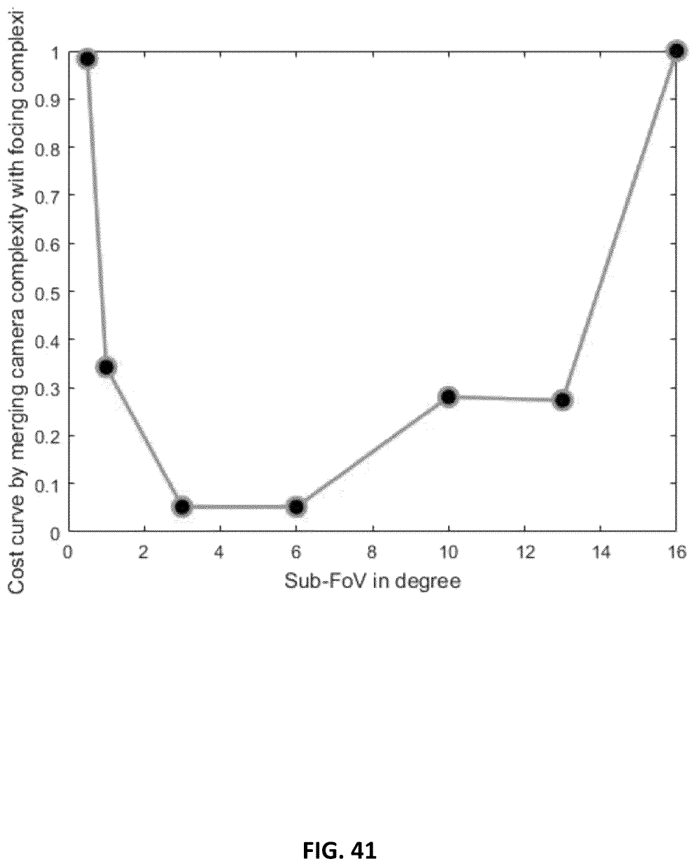

Gigapixel-scale imaging using Luneberg lenses is not easy. One challenge is that even when curved focal planes become available, they are unlikely to appear as full hemispherical components. More fundamentally, however, one encounters the problem of focusing a spherical optic. For objects at finite range, the curvature of the focal surface must change. Resolving this challenge brings us to our first example of a microcamera array. Monocentric multiscale imaging systems combine the advantages of spherical optics and curved focal planes with the focal control of compact microcameras. FIG. 40 illustrates an example design from such a system. Rather than a curved focal plane, multiscale systems place secondary microcameras near the focus of a spherical lens. Rather than a graded index, the sphere consists of two layers of crown and flint glasses designed to minimize chromatic aberration. Microcamera optics enable the imaging path to be more compact and enable each segment of the field to focus locally. FIG. 40 shows just a single microcamera, but in deployed systems microcameras may be densely packed around the sphere. The effective focal length for this design is 20 mm and the system operates near the diffraction limit for f/2.5. The microcamera field of view is 11.4°, but as discussed in microcamera arrays may be arranged to capture 360° fields.

Having surveyed the challenges and context of modern lens design, let's step back to consider the design process. Lens design basically consists of bridging the divide between application requirements and available sensors. Application requirements include spectral, polarization and temporal sensitivities, but the most basic requirements are ifov and FoV. The designer starts with a sensor pixel pitch, Δ and, given the ifov requirement, sets the system focal length to F=Δ/ifov. Designing lens with arbitrarily long focal length and diffraction limited ifov is not particularly difficult. The problem is that as F goes beyond the mm scale this challenge can resolved by reducing field of view [212]. For this reason, designs from the mm scale up to astronomical telescopes have historically been limited to ˜ 10 megapixels resolution.

One of the challenges in lens design is that changes to optical prescription effect the entire image field. As illustrated by the design in FIG. 38, modern freeform optics may find advantages in nonmonotopic optics that control aberration locally in the image field. Multiscale design segments the image field into disconnected regions with independent optics. This divide and conquer strategy enables scalable wide field of view imaging systems but so far no multiscale optical systems are commercially available. In fact, very few cameras resolving beyond the 10 megapixel barrier are available. Applicant believes that this is because we are still early in the microcamera/computational imaging revolution.

The section entitled Electronic Sampling discussed various deficiencies in available electronic focal planes. With respect to microcamera lenses, as illustrated by the design shown in 38, modern mobile devices are based on integrated systems of incredible sophistication. Beyond the 5-10 mm focal lengths of mobile device systems, however, integrated microcameras are not currently available.

While the design illustrated in FIG. 40 suggests that one can build gigapixel-scale cameras in the form factor of a golf ball, the reality is that current cameras are limited by the volume of electronic components rather than optics. For the gigapixel cameras constructed in the AWARE program, for example, optics volume was just 3% of total system volume [233]. Modern cameras rely on application specific integrated circuits (ASIC) for image signal processing (ISP). Beyond innovations in sensor and lens hardware, major revisions in ISP architecture are needed to reduce camera volume. In particular, neuromorophic circuits are needed to reduce camera head power and system volume [383]. Because optics volume is not the main barrier to improved camera capacity, near term designs are likely to focus on discrete microcameras rather than multiscale systems.

Here we assume, based on earlier discussions, that one can fuse image data collected over disjoint manifolds in the optical data cube. With this freedom, the lens designer can separately optimize ifov and FoV. The designer builds cameras from arrays of microcameras, with each microcamera sampling a distinct slice of the data cube. The ifov specification drives determines microcamera aperture size. As illustrated by the design shown in FIG. 39, it is possible to design compact high performance microcameras resolving 10 urad ifov. Beyond this limit one is likely to transition to multiscale telescope designs. Modern telescopes already locally process the field through adaptive optical wavefront corrections [349], pointing out that beyond the 10 urad limit resolution is likely limited by the atmosphere rather than the camera.

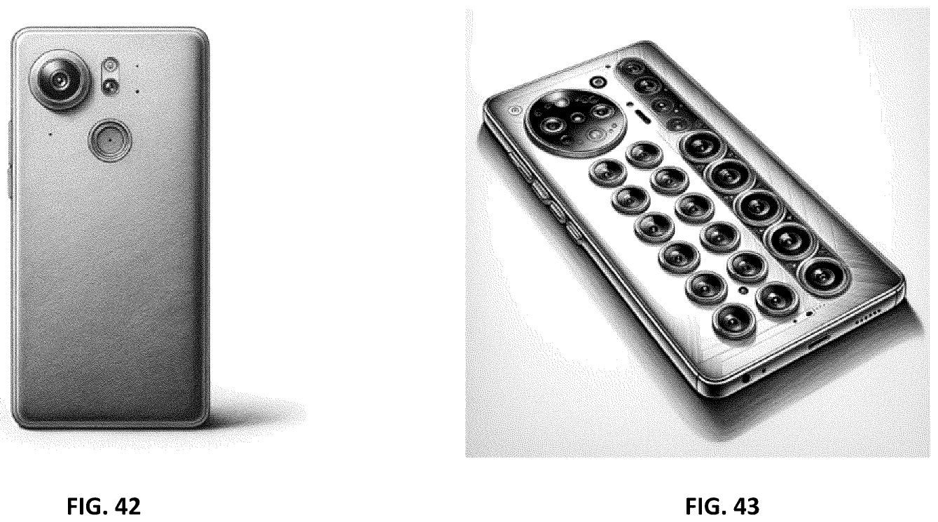

Granularity is a key design issue, specifically how large should the FoV of each microcamera be? This issue can be resolved by modeling cost per resolved pixel. The designer begins with a focal length matched to the ifov specification. Making a lens to resolve a single pixel is obviously expensive, the designer increases field of view to increase the value, in pixels captured, of the lens design up to the FoV at which lens complexity becomes unacceptably costly. At this point the designer will find it advantages to add additional microcameras rather than increasing lens complexity. FIG. 41 illustrates the results of a design study for an F/3.5 35 mm focal length lens system of pixel cost as a function of field of view [39]. The broad minimum around 3−6° suggests that microcamera field of view in this range, corresponding to 5−15 megapixels may be ideal. Larger FoV and higher pixel count is then achieved through arrays of such microcameras.

### Heterogenous Array Cameras

We next present examples to illustrate the concepts discussed herein. To clarify semantics, in this section a “camera” is a device consisting of optics and electronics. A camera can comprise one or more “microcameras.” A microcamera is an integrated sensor and lens, typically with a single optical axis. In addition to microcameras, a camera may include active illumination sources such as LEDs or lasers. This terminology derives from terms used in computation. Essentially all modern computers are “parallel computers,” so the term parallel computer is no longer in use. A computer includes an array of multicore microprocessors, graphical processors and tensor processors. A modern camera is a computer that also happens to include VPUs (visual processing units). Each microcamera is a VPU.

Earlier discussion explained why one may choose to segment the field of view onto microcameras when capturing wide field of view imagery. Recall, however, that our goal is not just to capture pixels over a 2D field of view. Our goal is to capture the light field, which includes color, time, dynamic range, focus, 3D and polarization. Conventionally, cameras have captured the light field by temporal scanning, but throughout this disclosure our preference has been to capture as much as possible in a snapshot. Snapshot photographic imaging is enabled by the use of heterogeneous array cameras [392]. In such systems, diverse camera modules (i.e., microcameras) sample manifolds in the optical data cube. Such manifolds may include different fields of view or different spectral, temporal or focal slices. The selection of how many parallel camera modules one uses and which regions of the data cube each module samples is a design issue.

A modern camera is an analog-to-digital converter, accepting a parallel analog data stream of optical signals and outputting a serial digital data stream. The spatial bandpass of a camera is limited by aperture size. In practice, however, electrical power dissipation and computational complexity are the primary barriers to camera information capacity. While digital memory capacity, communications bandwidth and computational power have grown exponentially over the digital age, camera information capacity has remained trapped at megapixel scales by the power and processing requirements of image signal processing.

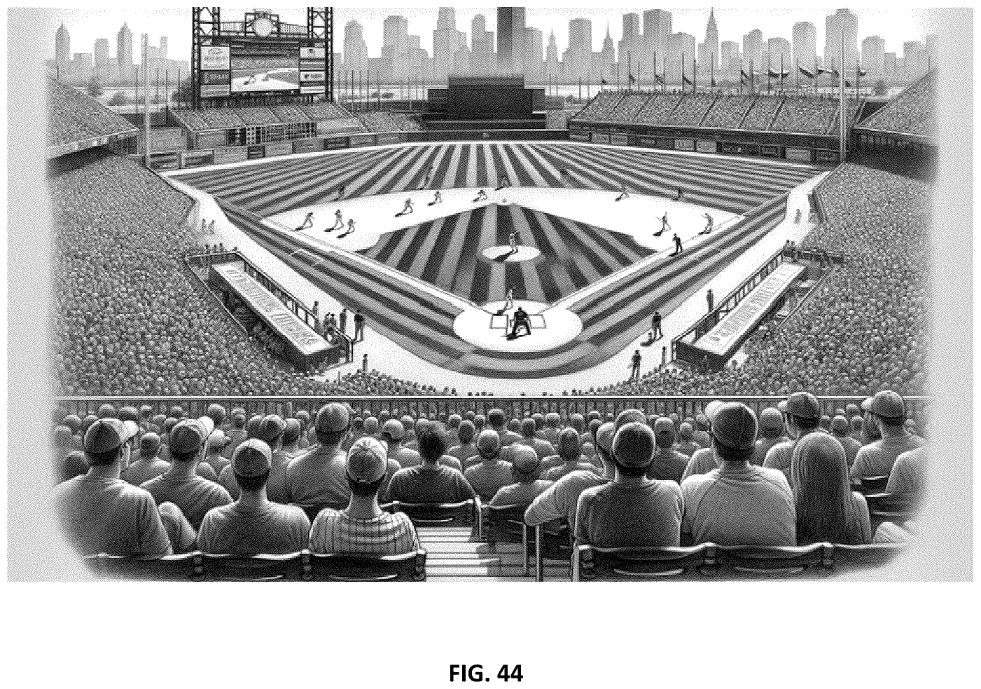

As discussed earlier, the third age of lens design began with the emergence of mobile phone cameras. FIG. 42 illustrates a typical layout for an early smart phone with a single image sensor. The primary constraints on this design were that the lens had to be less than 5 mm thick. More fundamentally, however, the cross section of the camera reflects the scale of the electronic processing area needed to capture, process and share image data from the sensor. A key point is the that the scale of the image data processing and transmission system is much larger than the sensor itself. FIG. 43 is a design for a future mobile device with a heterogeneous sensor array. Adding more sensors adds to the information capacity and quality of captured media, a key challenge is reducing the power and computation requirements on the device to level such that one can reasonably build the array illustrated.

Strategies for reducing the electrical power rely on the sampling strategies discussed earlier. A conventional ISP encodes the image data stream as in a camera-independent format, such as JPEG or HVEC. This approach relies on relatively heavy on-camera data processing and relatively light display-decoding. This approach is not appropriate for light field cameras capturing the entire data cube. In the light field case, efficient processing requires minimizing camera side power dissipation, even at the cost of increasing render side processing. Rendering is typically a server or cloud service that then delivers a standard format data stream to the display.

Assuming that we have resolved the challenge of managing electrical power, what is the design for the optimal array camera? As we have seen, homogeneous sampling in the data cube is not ideal. It makes sense for luminance sampling rates to exceed chrominance, for low resolution high frame rate sampling to complement low frame rate high resolution. It also makes sense to combine active illumination for holographic, structured illumination and range measurement with passive cross range imaging. In choosing which sensors to use the designer may consider computational complexity and feature specificity. Computational complexity refers to the fact that it is sometimes better to add sensors even if the information they sense is technically already available.

For example, while it may be possible to construct large field of view and 3D models from narrow field of view cameras, the addition of wide field of view or time of flight sensors that directly measure these quantities can substantially reduce the computational load. Feature specificity means simply that one can use methods discussed above to ensure that a sensor array can actually distinguish necessary object features.

With these concepts in mind let's consider a few designs. First, we note that the uniform integrated array of FIG. 43 is probably not such a good idea. It is important to point out two concepts:
1. Mobile device camera modules have demonstrated that integrated design and manufacturing of optoelectronic components improves sensor performance per unit size, weight power and cost, and
2. The integrated module concept can be applied to more sophisticated sensors than the telephoto, wide and ultrawide sensors common in mobile devices.

Rather than a single device incorporating all possible camera modules, one may expect consumers to purchase multiple devices with diverse focal cameras, time-of-flight cameras, coherent cameras, etc. Imagine 3D family portraits and gigapixel little league games. Leaving design of such systems to market specialists, let's consider some specific camera applications from a purely technical perspective.

### Event Capture

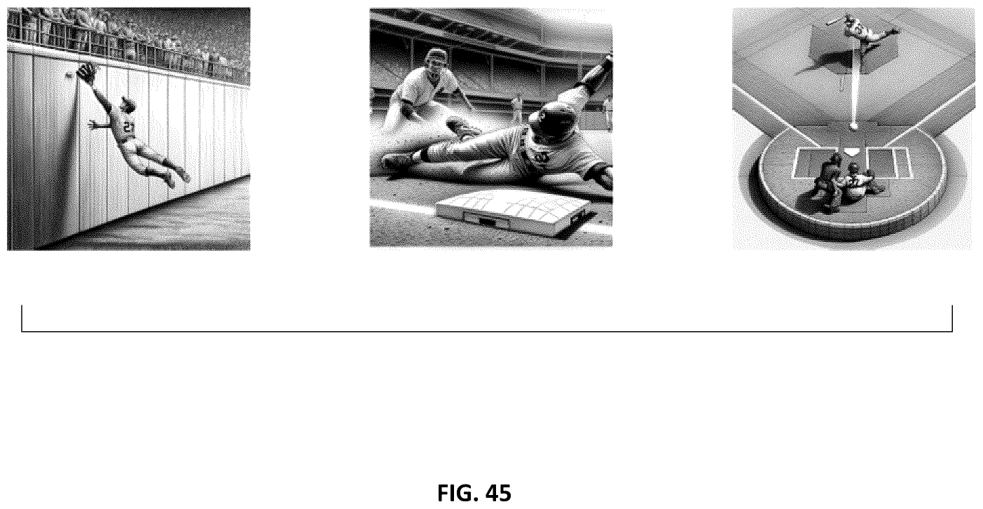

Suppose that one wishes to record action over a wide field of view with high depth of field and reasonable temporal resolution. This application space includes sporting events, theater and church productions and dramatic natural scenes. It may also include wide area persistent surveillance, although in the surveillance case one may simply seek to detect and store rare events. The field of regard for an example event is illustrated in FIG. 44.

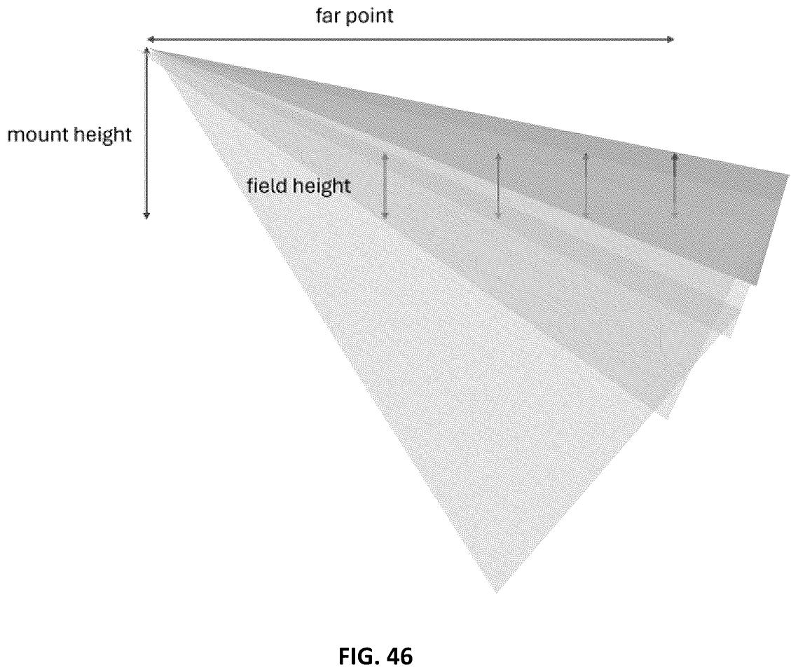

Camera design begins in object space. One specifies the object characteristics one wishes to capture, such as ground sample distance (gsd), temporal resolution, spectral resolution, luminance range and polarization, and designs a camera to capture these features. In the case of a ball game, one seeks multiscale visualizations ranging from the wide field context of a play to individual player actions. Detail views one may seek in a ball game are show in FIG. 45, which also shows some flaws in DALL-E's understanding of the game. A typical tight shot has a player filling half the vertical field of view. Assuming a player height of 2 meters and 4K resolution, this corresponds to gsd=2 mm. One may design to reduce the gsd to 0.5-1 mm at the bases and pitcher's mound. Neglecting for now regions of particular interest, a baseball camera may have the following specifications:
mount height 10 meters
near point 20 meters
far point 100 meters
field height 4 meters
field of view 90° ground sample distance 2 mm microcamera focal plane 4000×3000 pixels
pixel size 2 μm
f/#2
circle of confusion 4 μm

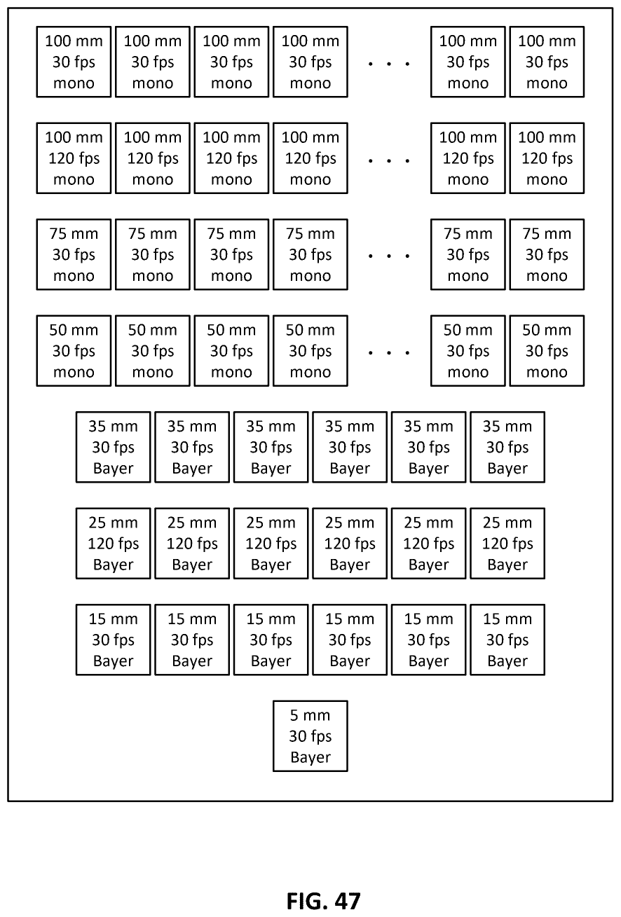

The far point is the distance from the camera to the outfield fence and the field height is the height of the image above the ground at the fence. We assume here that required image height is the same across the entire field of play. These parameters lead to field of view assignments as shown in FIG. 46. The longest focal length camera module observes the top of the field at the longest range. The focal length of this camera module is F=R Δ, where R is the range and Δ is the pixel pitch. The field of view is equal to the product of the ifov and pixel count. Bringing the field down from the high point, one finds where this camera module's view intersects the ground. This point is the far point for the next camera module. Repeating this process, one reduces the focal length as the far points reduce in succession to cover the full field.

The following Table I calculates a sequence of focal lengths to cover the vertical field of view by this method. Notice that the depth of field is the same at all ranges. The depth of field is calculated to be

$$D o F = 2 \frac{{R}^{2}}{{z}_{h}} .$$

Since R² and zₕ are both proportional to F, this is invariant. This confirms the result indicated by the foregoing equation for DoF. DoF is determined by the gsd. Here 0 parameterizes the vertical view angle and φ is the horizontal field of view of each microcamera. N is the number of microcameras needed to fill the 90° horizontal field of view.

TABLE I

| | | | | | | | | near |
|---|---|---|---|---|---|---|---|---|
| F | zₕ | R | DoF | θₘₐₓ | θₘᵢₙ | ϕ | | point |
| mm | m | m | m | degrees | degrees | degrees | N | m |
| 100 | 1250 | 100 | 16 | −3 | −7 | 5 | 20 | 83 |
| 83 | 860 | 83 | 16 | −4 | −8 | 6 | 16 | 69 |
| 69 | 589 | 69 | 16 | −5 | −10 | 7 | 13 | 57 |
| 57 | 401 | 57 | 16 | −6 | −12 | 8 | 11 | 46 |
| 46 | 270 | 46 | 16 | −7 | −15 | 10 | 9 | 38 |
| 38 | 179 | 38 | 16 | −9 | −18 | 12 | 7 | 30 |
| 30 | 116 | 30 | 16 | −11 | −23 | 15 | 6 | 24 |
| 24 | 72 | 24 | 16 | −14 | −29 | 19 | 5 | 18 |

While the foregoing information gives an understanding of capture parameters needed for this camera, in practice one is likely to use high performance mass manufactured camera modules rather than very specific wavelengths. Based on the results shown in Table I, one may use 20 100 mm focal length microcameras to capture the far field. One may choose a larger number of 75 mm focal length modules, say 30, because these modules must cover two different ranges. 50 mm modules may also cover a greater range but since their field of view is twice that of a 100 mm module, only 20 would be needed. One could then use a half dozen each of 35 mm, 25 mm and 15 mm modules. A 5 mm module would be used to capture the wide field image and a few 100 mm modules can be included to capture details on the bases, mound and foul lines. A proposed roster of camera modules is presented in the following Table II:

TABLE II

| F | | frame rate | |
|---|---|---|---|
| mm | N | hertz | Color |
| 100 | 20 | 30 | mono |
| 100 | 10 | 120 | mono |
| 75 | 30 | 30 | mono |
| 50 | 20 | 30 | mono |
| 35 | 6 | 30 | CFA |
| 25 | 6 | 120 | CFA |
| 15 | 6 | 30 | CFA |
| 5 | 1 | 30 | CFA |

Such a camera is shown in FIG. 47.

The 5 mm and 15 mm camera modules cover the entire field of view with color filter array (CFA) sampling. While it is possible to create stitched panoramic imagery to cover the wide field without directly sampling it, the cost of computation would greatly exceed the cost of measurement. Overall the design must balance the cost of sampling, computing and adaptation. The focal plane size of the sensors is selected at 12 megapixels because experience shows that it is reasonable to manufacture optics resolving at this limit. Lens cost increases dramatically beyond 12M. Someday this system will be manufactured using multiscale optics, which will radically decrease lens size, weight, volume and cost per pixel.

Some of the microcameras can be monochrome and some color because we know that it is not necessary to capture chrominance at the same resolution as luminance. Making some camera modules monochrome increases their light sensitivity, which allows shorter exposures and faster frame rates. In considering exposure time, one must consider typical velocities in pixels per frame. A player body part or bat moving at 50 km/hour moves .5 meters/frame at 30 fps. To ensure that the player moves less than one pixel per exposure, the exposure time must be less than 1.5 milliseconds.

With current technology the microcamera for this system can be manufactured at a cost of ≈$100 per module, meaning that the optics cost of this 99 microcamera system would be less than $10,000. The read-out electronics and data management system is somewhat more expensive. The detailed camera generates 64 gigapixels/sec. This is a challenging, but not unmanageable data rate. One may consider this design as an example of a “light field camera,”

We term the configuration data for each camera module the module's “capture configuration.” Thus, in the above-detailed baseball camera system, there are 99 camera modules of 8 different capture configurations. This camera system may be said to have N camera modules (e.g., 99), of M different capture configurations. M can be more than 8 (e.g., 10 or 20), or less than 8 (e.g., down to 2 or 3). N is typically greater than M by a factor of at least 2, 3, 5 or 10. For example, in the above Table II, N is greater than M by a factor of 99/8 or 12.375. Many such camera arrays have two camera modules with focal lengths in a ratio k, where 1<k<1.4 (e.g. the 100 mm and 75 mm modules, above). Many such camera arrays additionally or alternatively have two camera modules with focal lengths in a ratio k, where k >10 (e.g. the 100 mm and 5 mm modules, above). Most or all of the camera modules are typically microcameras, but this is not essential.

### Object Detection

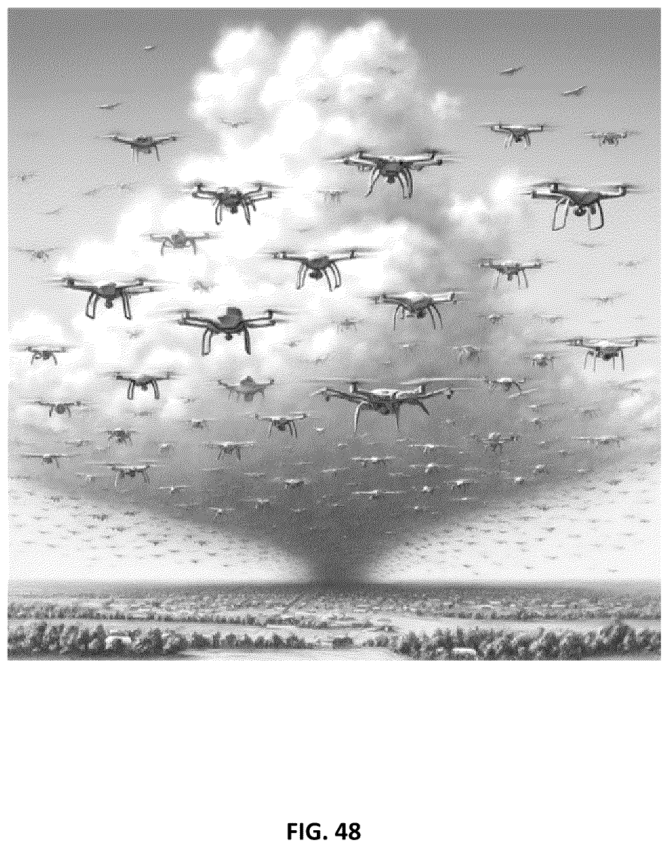

A next example consists of detection of unresolved rare events in a large field of view. Examples include drone detection and space debris tracking. The challenge is illustrated in FIG. 48, but DALL-E has been generous with the number of drones. In practice, we wish to detect a drone well before it becomes a resolved object. This means that the drone may occupy just one pixel on the camera at the time of detection. Actual unresolved objects are likely to blur onto several pixels due to turbulence effects. With this in mind, one does well to choose an aperture size matched to the seeing limit for drone detection. Aperture size is useful here in filtering the target radiance from the sky background sky and in increasing the signal energy collected, but the second objective is obtained as effectively by using arrays of small apertures rather than a single large aperture.

Many issues can be considered in design of an actual drone detection and tracking system. The nature of the signal detected may be the foremost consideration. A remote target may be self-luminous or it may reflect ambient or active illumination. Since one is likely to want to detect objects at all hours, active radar illumination is the most common mechanism for detecting and tracking airborne objects. For present purposes, however, it is useful to consider sparse object detection under ambient or solar illumination.

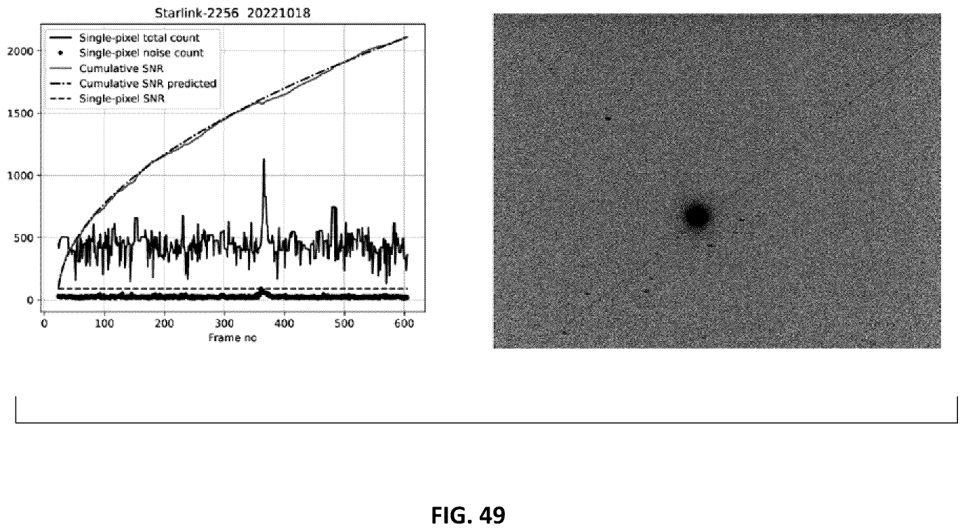

A feature of this application is that the object feature of interest is a temporal track rather than a spatial pattern. As an example, FIG. 49 shows the average of sequence of frames tracking the transit of a satellite. The satellite is unresolved and cannot be distinguished from background in a single frame, but as discussed in [12], the SNR for object detection increases as the root of the number of frames collected if the frame rate is sufficient to track the motion.

In addition to temporal diversity, unresolved objects may be distinguished from background using angular diversity. A true object will register from multiple perspectives, while Poisson fluctuations will not. On the other hand, observation from multiple perspectives enables object identification and increased signal to noise due to the potential directional nature of the object radiance. Since expected objects must follow continuous curves, the probability of detection is especially increased if array design increases the number and length of the tracks one may observe.

Object detection as defined in this problem comes down to analysis of how many tracks one can observe. The full sky, consisting of x steradians with a the seeing limit of ≈10⁻¹⁰ steradians may contain 10−100 gigapixels. To resolve tracks one may wish to analyze this field at 100 fps or more. To improve path radiance contrast or for night vision, one may build this system to operate at infrared wavelengths, which would reduce pixel count in inverse proportion to wavelength, but which could radically increase sensor cost. One can reduce cost by reducing field of view and then scanning the sky with a reduced field of view instrument.

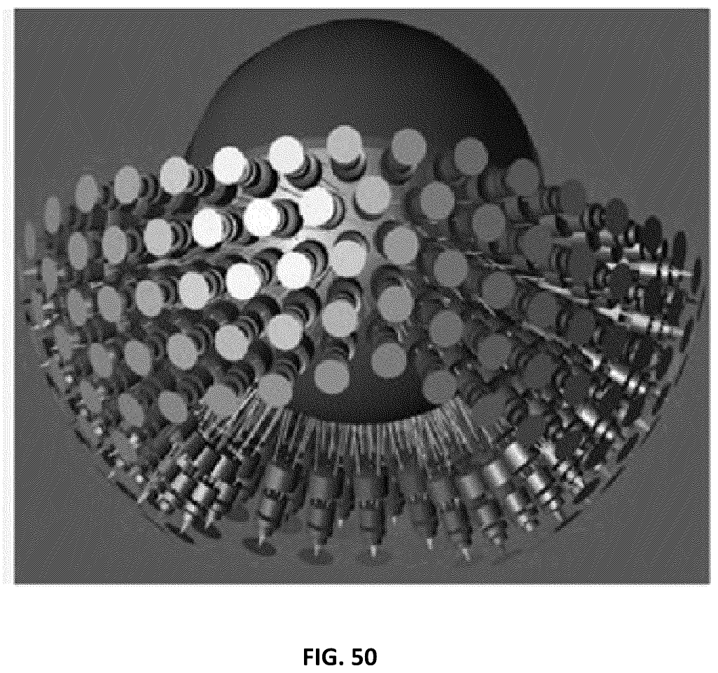

While this system seems challenging, it is possible to build imaging systems meeting this requirement. For example, the AWARE 40 camera described in was capable of imaging up to 40 gigapixels. Imaging systems on this scale benefit from multiscale design. As illustrated by the sensor layout in FIG. 50, a multiscale system may cover r steradians in an integrated system with volume roughly equal to the cube of the operating focal length [261]. The challenge is to manage the data stream and power draw for such a system, but efficient compression hardware is emerging to address this issue [367, 383]. Cost is also an issue; typical conventional cameras range in cost from $10 to $100 per resolved megapixel. Cost is a difficult issue to quantify for the system designer because it scales with production volume. In sufficient volume, cost for a multiscale system will be proportional to the number of microcameras used. Since the microcamera is a compact module, one may reasonably expect cost to reach $1 per resolved megapixel.

### Object Identification

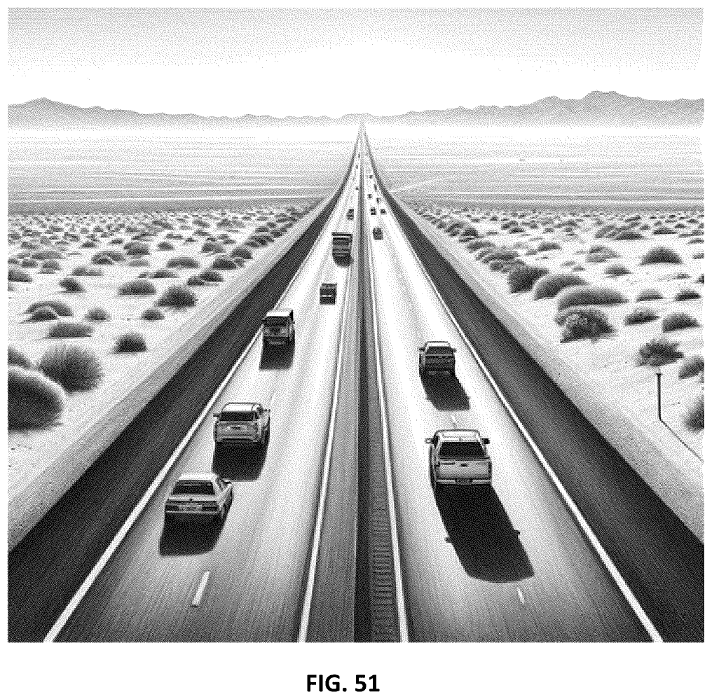

A next example considers object moving along a fixed path, such as the cars along the highway in FIG. 51. Since some of the vehicles are headed against traffic, DALL-E clearly expects something worth photographing to happen here. Visible and infrared imaging systems are an essential component of emerging smart highway systems [41]. The cost installing and maintaining such systems is dominated by the cost of mount points.

Assuming that one seeks to monitor the entire length of a roadway, the net cost of the video analysis system is proportional to the rate at which one installs such mount points. Installing cameras every 100 meters enables simple low resolution sensors, but at a high cost. In contrast, installing cameras every 1 km reduces installation cost but increases sensor requirements.

A challenge here is that one seeks to capture details, such as license plate numbers and facial identity while also maintaining visibility over the length of the path. As we saw above, depth of field is a function only of gsd. If one wishes to maintain constant gsd along a path, the number of sensors required is thus linear in the depth of field. For the 2 mm gsd discussed earlier, approximately 50 sensors would be needed to observe 1 km. A solution to this requirement is to use sensors with adaptive focus. Adaptive focus is particularly attractive because the frame rate needed to observe the path is also variable; objects at longer ranges have a slower pixel velocity and thus can be observed at lower frame rates. Lower frame rates allow time for focal sweeps.

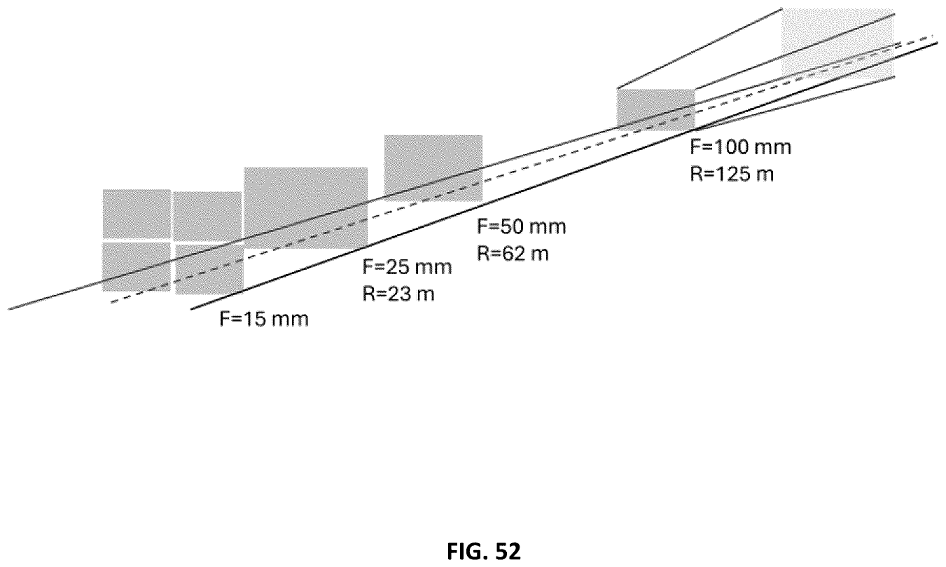

The sensing geometry of a microcamera array for a highway camera is illustrated in FIG. 52. One needs more than one camera for this application because the pixel velocity may be high in the foreground and because the ground sample distance varies with range. This variation is shown by the cone for camera 4 in the figure. We choose to set the field of view at the near point for the longest range microcamera to match the size of the highway. Supposing that this field is 10 meters wide and 5 meters high, at 4K resolution the gsd is 2.5 mm. The 100 mm focal length microcamera from the Event Capture discussion covers this field at a range of 125 meters. If this camera is then used to image the range to 1 km, focus measurements at zₕ/2=625 m, zₕ/4=313 m, and zₕ/8=156 m are needed to cover the depth of field. At 1 km, the gsd is 2 cm, which places 50 pixels across a 1 m high vehicle. Vehicles are detected at long range and tracked through the near field for identification. A vehicle moving at 50 m/s requires 18 seconds to transit from the far point to the near point of the long focal length microcamera, which leaves plenty of time to track its motion at all three focal positions. A 50 mm lens similarly covers the roadway at 62.5 mm. This range is reasonably covered by a fixed focus at range at zₕ/4=78 m. A 25 mm focal length covers the range beginning at 31 m focused at zₕ/2. 14 m to 31 m can then be covered by a 15 mm lens. One can then perform parallel sampling of the lanes in the near field to reduce the gsd to 1 mm with an effective 8K frame using 10−15 mm lenses. For example, a 15 mm lens would provide 1 mm gsd at a range of zₕ/4 =7m, with a field range from 5.6 to 9 m. Since the vehicle covers this range in .1 seconds, the rate of motion could be as high as 10,000 pixels per second, suggesting that exposure times of less than 10 microseconds may be needed. Active illumination and strobing may be used achieve this exposure time. Design parameters for a microcamera array for this application are presented in the following Table III. Color filter arrays are indicated on the mid-range microcameras, the near field camera modules are mono or infrared to allow short exposure times matched to the object velocity.

TABLE III

| | near | far | | exposure | |
|---|---|---|---|---|---|
| F | point | point | focus | time | |
| mm | m | m | states | ms | Color |
| 100 | 125 | 1000 | 3 | 3 | mono |
| 50 | 61 | 125 | 1 | 1 | CFA |
| 25 | 31 | 61 | 1 | 1 | CFA |
| 15 | 14 | 31 | 1 | 0.1 | mono |
| 4 × 15 | 5 | 10 | 1 | 0.01 | infrared flash |

### Video Analytics

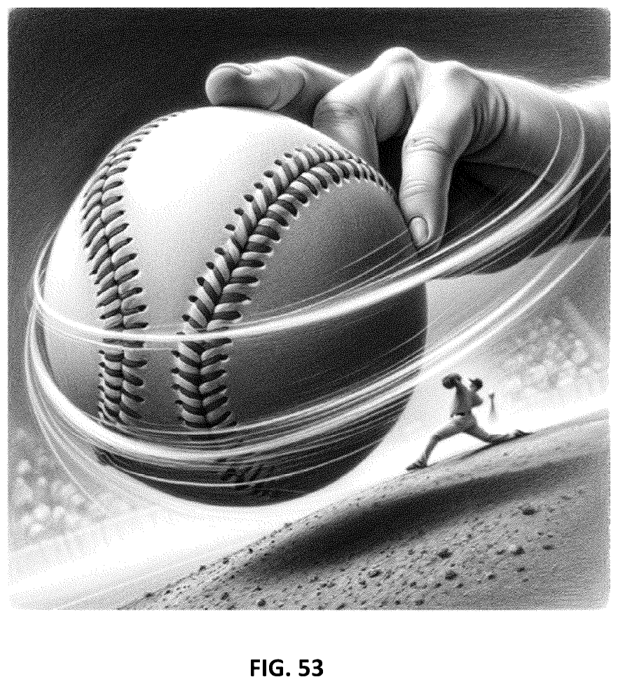

Many applications in robotics, process control and data collection use cameras to abstract information from a scene without the necessity of a visual image. A prototypical example is illustrated in FIG. 53. Here one wishes to get analytic data regarding a pitched baseball, including the spin rate and axis as well as the trajectory of the ball. In designing such systems, one must first consider the design constraints. If cost is a high priority, one may seek to minimize sensor or computational resources. Since, computational capacity is typically more expensive than sensor capacity, one may use simple time-of-flight radar or optical sensors to get the velocity of the ball. These sensors are augmented by optical sensors to get the 3D trajectory and spin.

A baseball spins rates up to 50 revolutions per second. A standard baseball is 74 mm in diameter, the seams are approximately 1 mm. At 50 revolution per second the seam velocity is thus around 100 m/second. If the on ball resolution is 1 mm then the seam moves 10000 pixels per second, suggesting that an exposure time of less than 100 us is needed to capture the seam. Capturing 5 frames of a seam as the ball spins requires a frame rate of 200 fps. 500 fps would more comfortably capture 10 frames. The ball must be captured outside the playing field, one may assume a capture range of 25 meters. A 1 mm gsd at 25 meters with 2 μm pixels requires F=50 mm. A 4K image with 1 mm gsd covers a sample area of 4×2m. This range corresponds to zₕ/6, with a depth of field of 4.5 m. If the velocity of the ball along the track is provided by radar, a single 50 mm microcamera may be sufficient to capture the spin. If the frame rate of this camera module is less than 500 fps or if one seeks to model the trajectory along the path in detail, an array comparable to the highway camera can be considered.

### Machine Vision

As a further example, we consider the question “what and how should machines see?” Historically we have struggled to make vision systems as powerful as human vision, but this disclosure presents numerous strategies by which machines can collect vastly more information than human vision. Machines may use this information for industrial process control, such as sorting materials for mining, controlling chemical dynamics or even robotically assembling products or for access control in security systems. The scenarios in which robotic vision can be used is endless, as an example here we focus on automated transportation systems.

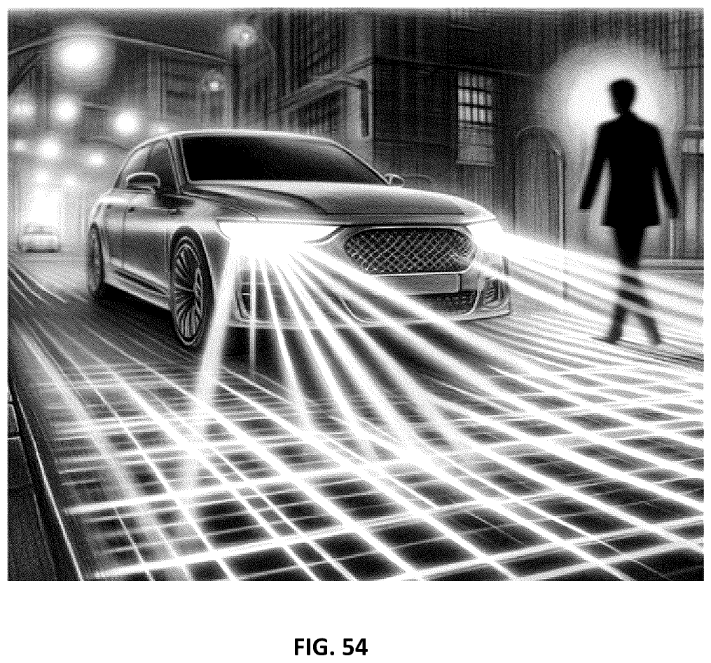

FIG. 54 illustrates automotive vision as a quintessential application. Given that humans operate vehicles using only color vision, one may wonder what sensors a car should include. Just in considering this question one is immediately struck by the power of augmented sensors in autonomous systems. Automobiles may use radar and ultrasound time-of-flight sensors to capture 3D information with greater accuracy and in more diverse environments than humans. Autos also may rely on lidar scanning and other optical illumination systems. Autos have always provided headlights to allow human night vision.

Analysis of the current and historic state of the art is a good first step in design. Over the first century of automotive production a wide variety of sensors for engine control and monitoring and vehicle speed were developed [101]. Only in the past decade have sensors been added to give the vehicle and driver situational awareness. These sensors include visible and infrared cameras [200], radar and lidar [199]. Radar and lidar are time-of-flight sensors as discussed earlier and are used to measure range, cameras cross range texture with higher resolution. Infrared cameras are potentially attractive due to reduced sensitivity to haze or fog [83, 166].

With modern AI one can also sense range from camera data. Here one encounters a fundamental trade-off of automotive sensor design. As indicated by the ability of humans to understand depth, visible sensors are sufficient to drive a car. However, the processing time and computational power needed to this with current machine vision systems may be too large. Direct measurement of range using time-of-flight sensors increases sensor cost but can decrease computational cost. The fundamental trade-off of automotive sensor design is how much to budget for illumination complexity, sensor complexity and computational complexity.

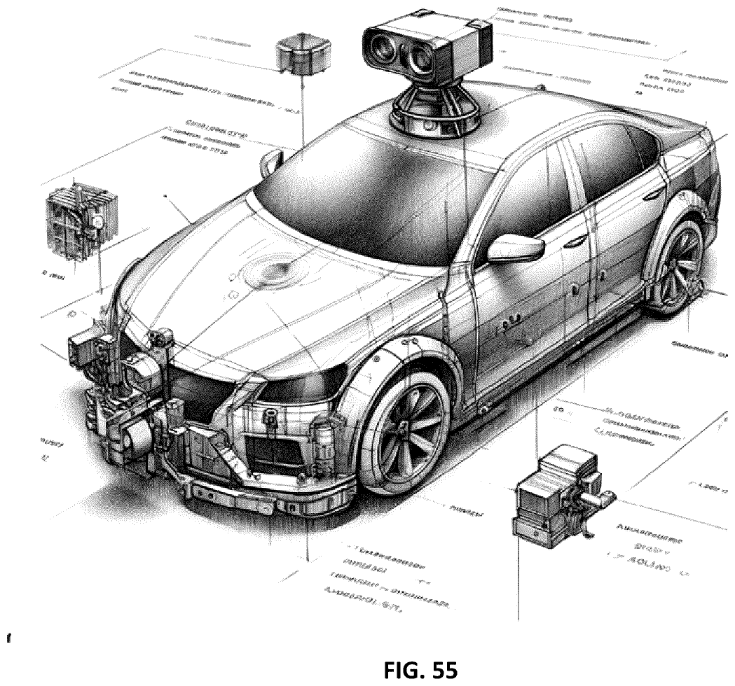

As illustrated by the complexity of the transmit and receive optics on top of the car in FIG. 55, lidar chooses complex illumination in exchange for simple receiver and processing components. Typical lidar systems are line of sight versions of the time-of-flight systems discussed in the section on 3D imaging (although since lidar came first and is a much larger application, one may say that NLOS uses lidar). These systems achieve range resolution on the scale of 1−10 cm, which is comparable to wideband radar systems [24]. However, lidar systems achieve substantially better cross-range resolution. The longer wavelength of radar systems limits cross range to =5 milliradians, whereas lidar may achieve submilliradian resolution. If we assume a forward-looking field of view of encompassing 0.05-0.1 steradians, a lidar can resolve 10,000−100,000 range points and a radar may resolve an order of magnitude less. Unfortunately, common lidar systems are point scanners, which means that they require several seconds to acquire this data.

Related to complexity, one may also consider cost. Cost is extremely difficult to quantify because, as illustrated most spectacularly by the automobile itself, the cost of something manufactured in quantities of 10 to 100 units can be very different from the cost of a product manufactured in quantities of 1 million or more. Analysis of this issue is well beyond the scope of this disclosure, however, so we must content ourselves with noting that an automotive lidar is a >$1000 component, automotive cameras cost $10−$100 per microcamera and automotive radar costs $10−$100 per system. The data processing system to manage and act on the sensor stream costs $100−$2000. These costs are likely to remain fixed, although one may expect that continuing advances in tensor processing hardware and software will improve the processing capacity by at least 2× per year for the next 5−10 years (sort of a neural Moore's Law).

One aspect of this cost analysis is to note that while cameras and radar are definitely essential parts of any robotic imaging system, lidar is a less certain component. The problems with lidar are (1) it requires a high performance laser and, perhaps more significantly, (2) it relies on an extremely sophisticated mechanical scanning system. Optical coherence tomography is essentially a confocal scanned time of flight imager. In the case of OCT, confocal filtering is needed to enable cross-range resolution in the reflection geometry. For lidar, in contrast, there is no fundamental physical reason for scanning, one would be better served to measure many pixels in parallel with a focal imaging system. The problem is that lidar requires fast sensors, such as SPADs [389, 395]. These devices cannot be cost effectively fabricated in large arrays and therefore must be scanned. On the other hand, SPAD devices are sensitive and thus enable lidar to sense targets at ranges approaching 200m.

In summary the current state of the art for automotive sensors uses multiple sensors to remain robust against component failure and variable weather conditions. Systems may use cameras and radar for side and rear situational awareness, but the forward looking sensor may be a lidar with 10 cm range resolution and 1 milliradian cross range resolution at ranges from 2 to 200 meters. Applicant expects that the reader will look at this sensor suite in the context of technologies discussed in this disclosure and find it strikingly unimaginative. Despite nearly a century of computational imaging, we are still at the dawn of the age of intelligent machines.

The high cost of making new hardware is one reason for the slow pace of development. A typical computational imaging system built from off the shelf components costs $1000−$10,000; making a custom glass lens costs $10,000−$100,000 and making new plastic lenses costs $100,000−$300,000 for molds and a >$1M commitment to amortize the molds. For an automotive sensor with a multimillion unit run these costs are justified, but the upfront costs inhibit innovation in new sensors. For our present purpose, it may now be helpful to switch from off-the-shelf sensors for automotive vision to a deeper analysis how machine vision can be better than human vision. Machines can do three things that humans cannot do:
they can process vastly greater data cubes at vastly greater speed,
they can see infrared, ultraviolet, radar, etc., and
they can actively illuminate with space-time patterns.

With respect to point 1, automobiles use visible image systems that exceed human capacity. While human vision is foveated and forward looking, autos use an array of forward, side and rear cameras. To date, these cameras have limited spatial resolution due to the assumption that they must be fixed focus, but as microcamera technology advances, arrays with specifications similar to the highway camera arrangement detailed earlier will be mounted on cars. Such arrays will provide human consumable forensic records and will augment driver vision. For the machine intelligence, however, it is better to focus on point (3). While humans use headlights to assist vision, the sophistication with which machines can use illumination greatly exceeds human search lights. For automotive vision the greatest opportunity is to use near-infrared illumination. Automotive lidar uses 905 nm or 1500 nm light, with the advantage of the 1550 nm band being lower atmospheric attenuation. However, the currently high cost of short wave infrared (SWIR) cameras makes this band unsuitable for imaging applications. Near-infrared (NIR) LED illuminators operating at 850 or 940 nm are attractive options for automotive vision. Since humans are not sensitive to these wavelengths, their luminous intensity may exceed limits that would distract human drivers with visible light. The quantum efficiency of silicon sensors is typically half of its peak value at 850 nm and may be as low as 10% at 940 nm, suggesting that 850 nm may be the better choice. So let's say the car illuminates its surroundings with primarily forward looking 850 nm light. The sources are likely a distributed array emitting coded space-time signals matched to diverse ranges and object features. LED's can be modulated at rates up to 100 MHz, so the primary challenge with temporal coding is in building build detection systems that can decode it. However, even smart rolling shutter systems can capture the 10−20 MHz frequencies needed to obtain the 2 cm specification in our brief.

Optical design for LED headlights is a well-developed science [154, 330] with the primary goal of matching the illuminated field to requirements for high and low beams. This challenge may be simplified for narrow band infrared headlights because diffractive elements or metalenses can be used. With such elements one can implement illumination arrays capable of projecting 1−10 cm illumination patterns at ranges up to 250 m. While dynamic spatial light modulators to control headlight illumination patterns have been proposed [159], it is simpler to use LED arrays to adapt illumination patterns [330]. Range dependent variation in the perceived frequency of these patterns requires a baseline separation. Recall from the earlier discussion that the nominal range resolution for stereo triangulation is:

$$Δ z = 2 λ \frac{{R}^{2}}{d A}$$

For d=1 m, λ=5 cm, and 1=0.5 μm, nominal range resolution is 20 cm at 100 meters and 1.25 meters at 250 meters. However, coded illumination patterns as discussed earlier substantially improves this resolution. A headlight may, for example, project a pattern

$$I ( x , y ) = t ( \frac{x}{R} , \frac{y}{R} ) .$$

Viewed from the illuminating center of projection, the reflected pattern is independent of range, but from a laterally displaced viewpoint one observes

$$g ( x , y ) = t ( \frac{x}{R} - d , \frac{y}{R} ) .$$

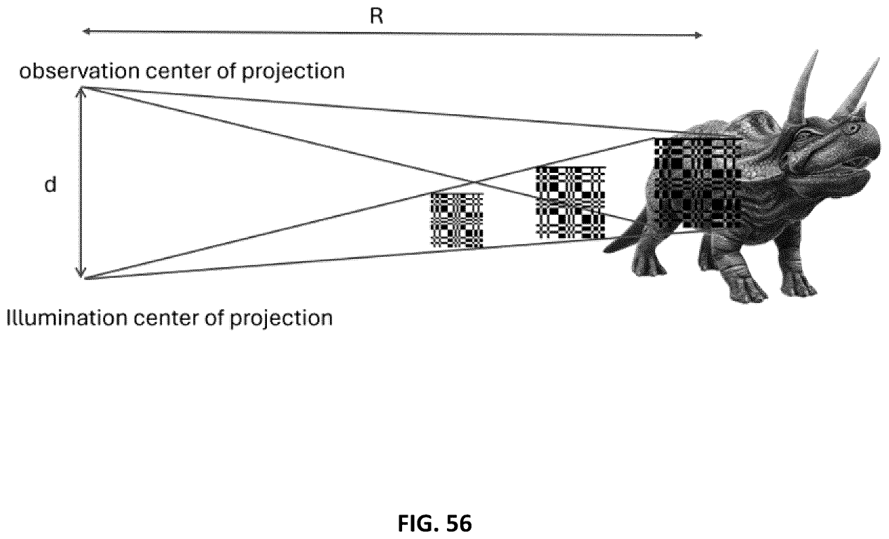

FIG. 29 illustrates the resolution one achieves if the illumination is a collimated beam. Without the displacement, d, the observed reflection g (x, y) is independent of range. Displacement gives perspective to estimate the lateral shift of the reflected illumination with range. Illumination with a periodic pattern, as used above, requires coherent illuminators or near-field geometry. A more accurate mechanism for ranging from a vehicle is to use shift variant illumination as illustrated in h FIG. 56. Here we assume that the object is a relatively smooth surface, enabling one to determine range by integrating the signal over multiple transverse resolution elements. As with periodic illumination, the improvement in range resolution will be linear in the angular extent of the illumination or the number of cross range bins. This means that cm scale resolution is reasonable at 100 meters and 10 cm range resolution may be achieved at 250 meters.

FIG. 56 assumes illumination with a uniformly redundant array, for which case the analysis can be applied to estimate the lateral shift of the code and thus the range. As with CASSI and CACTI systems, however, one here is likely to mix cross-range and range estimation using quasi-random codes. This approach leads to substantial computational requirements for real-time driving, but here one must remember that although we are 200 years into the age of photography, 100 years into the age of electronic imaging, 75 years into the age of transistors, 50 years into the age of solid state focal planes and 25 years into the age of integrated camera modules, we are only a decade into the age of artificial intelligence and deep learning. Hardware capable of this task is coming very soon. One can fuse radar ranging with camera cross-range resolution [252, 405, 407]. In addition, the motion of the vehicle can be used to synthesize imager baseline. With narrow band illumination, partially coherent specular reflection, or coherent wavefront imaging, can be applied. In short, a very large design space capitalizing on the capabilities of machines to see more than humans.

### Further Disclosure

According to the world health organization, traffic accidents cause 1.2 million deaths each year. They are the leading cause of death for people aged 5−29 and they are the most deadly non-disease killer for all ages [257]. And they are almost completely preventable. WHO further estimates that traffic accidents reduce typical gross domestic products by 3%. Beyond this the impact of the constant stress of traffic, road noise and pollution is immense. Imagine a world in which vehicles safely operated by intelligent design so as to avoid all accidents while also efficiently delivering people and things where they need to go. Better sensing and sensor data processing is the key to this world. Beyond safety, sensors improve the efficiency of mining, manufacturing, heating, cooling, entertainment and science. Ubiquitous sensing using the technologies discussed in this disclosure will change our world.

The big picture challenges of computational imaging include:
1. What physical measurements should one take?
2. How should one represent the measurements in discrete data?
3, and how should one transform the data into images?

These three challenges address the interface between the physical and information systems. The first question requires that one interact with physical systems on physical terms. As seen above, there is a mismatch between the mathematical structure of images and the physical samples one can actually draw. This mismatch leads us to separate challenges 1, 2 and 3. One can measure and display pixels, but in information systems one processes features.

This disclosure is focused primarily on challenge 1. The foregoing discussion has detailed diverse ways to capture as much information as possible and to evaluate the relationships between the captured data and the object. Optimization of physical measurements implicitly assumes that solutions to challenges 2 and 3 are available. We have described various solutions. In the applicant's experience, advances in computing hardware and software strategies will come to resolve these challenges. But major and continuing advances are needed.

Image data loads will continue to grow exponentially for the foreseeable future. The solution to power efficient sampling and representation of these data loads likely lies, in part, in blind post detection compression, as described for example by Yan et al. and Wang et al. [367]. A goal is to measure features rather than pixels to reduce sensor power and data loads. The solution to challenge 3 lies in neural processing and neural representations.

One might think that physical sampling strategies, as described in this disclosure, would have reached a level of stability. In comparing this disclosure with the 2009 text Optical Imaging and Spectroscopy [33], one sees that just over the few intervening years there has been incredible growth in the sophistication of physical design. Phase imaging and ptychography, wavefront cameras, radiance tomography and heterogeneous array cameras have all exploded in the past few years. As discussed, other information technologies have grown faster than imaging in recent decades. But computational imaging is just getting started.

A few final points:

Prior art array cameras have been laborious to construct, requiring extensive hand-assembly and calibration. Moreover, the fixed-focus nature of the component imagers limits utility.

Mobile phone cameras are mass-produced, and some employ variable focus mechanisms, such as voice coil modules. However, such cameras are typically of short focal length, e.g., less than 10 mm. Applicant believes it would be desirable to employ longer focal length (greater than 10 mm, and preferably greater than 20 or 40 mm), variable-focus imagers into array cameras, but longer focal lengths require more precision in construction, and compound assembly difficulties.

In a particular arrangement, a sensor and a voice coil module are robotically assembled and aligned together. The sensor can be of any configuration, but in an illustrative embodiment is a 5−, 12- or 25-megapixel panchromatic CMOS sensor. The pixels may be of any size; pixel sizes in the range 1.5−2, 2−3 or 3−4 microns are exemplary. A multi-element long focal length lens assembly (often employing aspheric surfaces) is similarly assembled and aligned in a mount. A vision-equipped robotic manipulator is configured to then bring the lens assembly into rough alignment with the substrate, using alignment marks on the former or latter. A laser-generated calibration target is next projected into the lens assembly. Data from the sensor is then collected while the manipulator varies the relative positioning of the lens assembly to the substrate, e.g., in tip, tilt and centering. When analysis of sensor data indicates the lens assembly has been optimally-positioned, the mount is secured to the substrate, e.g., by glueing in-place three or more pins that extend from the lens mount into enlarged holes in the substrate (large enough to permit the freedom of movement needed for alignment).

In another aspect, data sets from imagers of an array camera (e.g., variable focus, longer focal length imagers of the sort just-described) are first compressed and then transferred to a database. In many embodiments, the imagers collect disparate data sets, e.g., varying in resolution, spectra, capture time, capture exposure interval, field of view and/or f-stop, etc. The array camera delays processing tasks, such as multiframe fusion, tone mapping and color estimation, demosaicing, white balance correction, focal stacking, etc., that might normally be performed before image compression, and applies such processing only when a particular image is queried and rendered from the stored database information. Such arrangement lends itself particularly well to neural network-based data fusion, such as by application of transformer networks.

Array cameras employing the technologies detailed herein find multiple applications. One is in advanced driver-assistance systems (ADAS), in which a vehicle equipped with one or more such array cameras collects multi-spectral data about the vehicle's immediate and remote environment. Rather than rendering imagery from the database into a frame of pixels for display, the ADAS system can directly operate on the collected database information, e.g., to detect obstacles and respond to emergent situations.

As discussed in the foregoing disclosure, many applications in event capture, persistent surveillance and machine vision require diverse sensor resources. Array cameras enable efficient capture of the “optical data cube,” consisting of diverse focus states, exposure, color and polarization data sets. Integrated sensor modules enable capture of slices of the data cube at various levels of resolution. Modern neural inference platforms enable combination of these diverse slices in a common estimator. Rather than considering cameras as systems in which the image is formed by a single lens, array cameras manufactured as described sample multiple focal states, diverse exposure, color and polarization planes in parallel. Cost-effective manufacturing strategies and efficient array camera data processing platforms enable increases in sensor data per unit volume and cost.

### Concluding Remarks

It bears repeating that the present disclosure should be read in the context of applicant's preceding filings and papers-particularly the papers and patent documents found in the Related Application Data paragraphs and in the first paragraph of the Detailed Description. Applicant expressly teaches that the arrangements detailed herein can be practiced using the technologies detailed in those documents (e.g., the novel color filter arrays detailed in patent U.S. Pat. No. 12,047,692, the noise reduction techniques detailed in application Ser. No. 19/013,418, and the data storage arrangements of application 63/761,969, can be employed in embodiments of the present technology). Similarly, the arrangements detailed in the cited patent documents can be practiced using the technologies detailed herein (e.g., the heterogeneous cameras detailed herein can be employed in the spectator-centric imaging arrangements of application 63/788,687).

Having described and illustrated principles of the present technology with reference to various examples, it should be apparent that applicant's inventive work is not so limited.

For example, while many of the detailed embodiments employ camera modules that have the same pixel dimensions, this is not essential. In other embodiments, camera modules can employ sensors of different pixel dimensions.

Similarly, while the disclosure has focused mainly on arrangements employing sensors that have peak sensitivities in the visible light range, in other arrangements some or all of the sensors can have peak sensitivity in the near infrared (e.g., 905 nm), far infrared (e.g., 1500 nm), or ultraviolet.

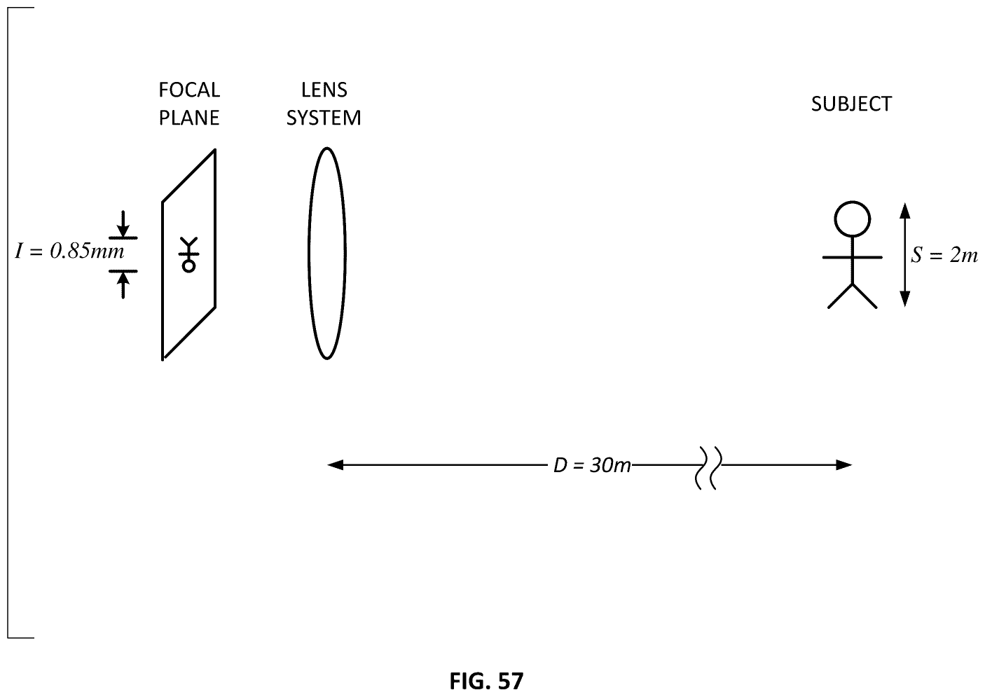

Reference was made to effective focal length (“focal length”). The effective focal length of a lens system is defined with reference to the example of FIG. 57 (not to scale). A subject (depicted by the stickman) is remote from the lens at a distance D shown as 30m. (The lens system is regarded as negligibly-thin as compared to distance D.) The physical size of the subject S is, e.g., 2m.

The lens projects a corresponding, inverted image onto the plane of the image sensor (the focal plane). This projected size of the image I is, e.g., 0.85 mm.

The ratio of the subject's physical size S, to its distance from the lens D, is the same as the ratio of the projected image size I on the sensor, to the effective focal length EFL. That is:

$$\underline{S} / \underline{D} = \underline{I} / \underline{E F L}$$

### SO

$$\underline{E F L} = \underline{D} * \underline{I} / \underline{S}$$

In the example just-given, with the units in meters, EFL=30 *. 00085/2, or .01275m, or 12.75 mm. (Effective focal distance may be better determined with reference to image rays from an infinite distance. However, infinity does not work well in ratios, and a distance of 30m, or 100 ft, is close-enough.)

Preferred camera modules used in the above-detailed camera arrays commonly include multi-element lens assemblies using variable focus actuator mechanisms, such as voice coil modules, to effect focus control. Suitable voice coil modules (VCMs) are available, e.g., from Alps Alpine Co., Ltd.

The elements of each lens assembly are typically positioned with their optical axes aligned with the center of the camera module sensor. A frame structure is permanently coupled to the sensor (e.g., by gluing) and supports a voice coil module that controllably moves one or more of the lens elements relative to the frame structure (and the sensor) in response to a focus control signal. The lens element(s) moved by the VCM (typically the lens elements closest to the sensor) are commonly plastic.

In lens assemblies having longer focal lengths (e.g., longer than a threshold value, such as 10, 12 or 15 mm), additional lens elements are typically not moved by the voice coil module. Instead, they are fixed relative to the sensor, e.g., mounted in a barrel that is bonded to the sensor, or to the VCM frame structure. One or more of the additional lens elements in this barrel may be glass.

Such a preferred lens assembly thus includes some lens elements (typically of relatively larger diameter, volume and weight) that are fixed relative to the sensor, and one or more other (relatively smaller) lens elements that are movable relative to the sensor, to control focus.

In preferred camera modules that have focal lengths of the threshold value or shorter, all of the lens elements can be moved by the VCM; none is fixed relative to the sensor. Thus, in the camera array detailed in Table II, the camera module with the 5 mm focal length would have all of its lens elements movable by a VCM, whereas the other, longer focal length-camera modules would each have both static and VCM-movable lens elements.

(While VCMs are used in the detailed embodiments, other actuator mechanisms can alternatively be used, including piezo-electric positioners, and shape memory alloy arrangements.)

Alignment of the lens elements to the sensor is performed using a machine that performs active optical alignment while the image sensor captures pixel data from a laser test pattern. The frame structure containing the VCM and associated lens element(s) is first positioned on the sensor. The machine adjusts the relative alignment between this frame structure and the image sensor to achieve optimum results (e.g., highest MTF measurements), as indicated by data from the image sensor (i.e., a feedback loop). The frame structure is then glued to the image sensor at the optimum alignment, e.g., using a UV-curing adhesive. In the case of longer focal length lenses, this process is then repeated by positioning the barrel containing the static lens elements on the glued frame structure, and adjusting its relative alignment to achieve optimum results. The barrel is then glued to the frame structure at this optimum alignment. Machines suitable for such alignment are available from TriOptics-USA, Inc., ASM International NV, IsMedia Co. Ltd., and Pioneer FA Corp.

Applicant has found that imaging modules having their lens assemblies aligned and bonded in this fashion (“integrated modules”) yield superior results, compared with non-integrated (removable lens) arrangements. Removable lenses cannot be aligned as precisely as a lens in an integrated module. An integrated module, in which the lens and the image sensor are aligned and permanently coupled together during manufacturing, improves f-number by 5−10 times. This means 5−10× better light sensitivity, 100−1000× smaller volume per captured pixel, and 10−100× lower manufactured cost per pixel.

To illustrate, an integrated imaging module employing a 62 mm/f2.8 lens is modeled to achieve a spatial frequency resolution of 250 lines per mm, as contrasted with 50 lines per mm for such a lens in a conventional “mount” arrangement. To achieve 250 line/mm performance with a conventional (mounted) camera lens requires resort to a lens of 300 mm focal length.

Additional details concerning lens design and sensor construction that can be employed in embodiments of the present technology are found in [409].

Additional details concerning array camera technologies that can be employed in embodiments of the present technology, including particular arrangements for compressing imagery, synthesizing imagery, and rendering imagery, are found in [410, 411, 156, 392]θ and applicant's patent documents U.S. Pat. Nos. 10,462,343, 10,944,923, and US20200059606.

Deep learning technologies can be employed in embodiments of the present technology. Suitable deep learning technologies are detailed in Brady et al paper, Smart cameras, cited above.

The processes and arrangements disclosed in this specification can be implemented as instructions for computing devices, including general purpose processor instructions for a variety of programmable processors, such as microprocessors (e.g., the Intel Core i9 series, the ARM Neoverse and Cortex series, etc.), and graphics processing units (e.g., the Nvidia Xavier and ARM Mali series). These instructions can be implemented as software, firmware, etc. These instructions can also be implemented in various forms of processor circuitry, including programmable logic devices and field programmable gate arrays.

Implementation can additionally, or alternatively, employ dedicated electronic circuitry that has been custom-designed and manufactured to perform some or all of the component acts, such as an application specific integrated circuit (ASIC), or as an array of hardware logic gates integrated on the same semiconductor as the image sensor.

Software instructions for implementing the detailed functionality can be authored by artisans without undue experimentation from the descriptions provided herein, e.g., written in C, C++, Visual Basic, Java, Python, Tcl, Perl, Scheme, Ruby, Matlab, etc., in conjunction with associated data.

Software and hardware configuration data/instructions are commonly stored as instructions in one or more data structures conveyed by tangible media, such as magnetic or optical discs, memory cards, volatile and non-volatile semiconductor memory, etc.

While certain aspects of the technology have been described by reference to illustrative methods, it will be recognized that apparatuses configured to perform the acts of such methods are also contemplated as part of applicant's inventive work. Likewise, tangible computer readable media containing instructions for configuring a processor or other programmable system to perform such methods is also expressly contemplated.

Each of the documents cited herein forms part of the present disclosure and is incorporated by reference, as if set forth fully herein.

### BIBLIOGRAPHY

The following publications referenced above are incorporated herein by reference.
[2] Albert Abramson. The History of Television, 1880 to 1941. McFarland, 1987.
[4] J. Adams, K. Parulski, and K. Spaulding. “Color processing in digital cameras”. In: IEEE Micro 18.6 (1998), pp. 20−30. doi: 10.1109/40. 743681.
[5] E. H. Adelson and J. Y. A. Wang. “Single Lens Stereo with a Plenoptic Camera”. In: IEEE Trans. Pattern Anal. Mach. Intell. 14 (1992), pp. 99−10⁶.
[9] Gonzalo R Arce et al. “Compressive coded aperture spectral imaging: An introduction”. In: IEEE Signal Processing Magazine 31.1 (2013), pp. 105−115.
[12] Hasan Bahcivan, David J Brady, and Gordon C Hageman. “Radiometric sensitivity and resolution of synthetic tracking imaging for orbital debris monitoring”. In: arXiv preprint arXiv: 2211.09789 (2022).
[13] Octavian Baltag. “History of Automatic Focusing Reflected by Patents”. In: Science 3.1 (2015), pp. 1-17.
[17] Marion F. Baumgardner, Larry L. Biehl, and David A. Landgrebe. 220 Band AVIRIS Hyperspectral Image Data Set: Jun. 12, 1992 Indian Pine Test Site 3. 2015. doi: doi:/10. 4231/R7RX991C. url: https://purr.purdue.edu/publications/1947/1.
[23] Vasudev Bhaskaran and Konstantinos Konstantinides. “Image and video compression standards: algorithms and architectures”. In: (1997).
[24] Igal Bilik. “Comparative analysis of radar and lidar technologies for automotive applications”. In: IEEE Intelligent Transportation Systems Magazine 15.1 (2022), pp. 244−269.
[26] David A Boas et al. “Imaging the body with diffuse optical tomography”. In: IEEE signal processing magazine 18.6 (2001), pp. 57−75.
[30] W. S. Boyle and G.E. Smith. “Charge-coupled semiconductor devices”. In: Bell Systems Technical Journal 49 (1970), p.587.
[31] D. J. Brady. “Multiplex sensors and the constant radiance theorem”. In: Optics Letters 27.1 (2002), pp. 16−18.
[33] David J Brady. Optical imaging and spectroscopy. John Wiley & Sons, 2009.
[34] David J Brady, Lu Fang, and Zhan Ma. “Deep learning for camera data acquisition, control, and image estimation”. In: Advances in Optics and Photonics 12.4 (2020), pp. 787−846.
[38] David J Brady et al. “Multiscale gigapixel photography”. In: Nature 486.7403 (2012), pp. 386−389.
[39] David J Brady et al. “Parallel cameras”. In: Optica 5.2 (2018), pp. 127−137.
[41] Norbert Buch, Sergio A Velastin, and James Orwell. “A review of computer vision techniques for the analysis of urban traffic”. In: IEEE Transactions on intelligent transportation systems 12.3 (2011), pp. 920−939.
[45] Peter J Burt and Edward H Adelson. “A multiresolution spline with application to image mosaics”. In: ACM Transactions on Graphics (TOG) 2.4 (1983), pp. 217−236.
[47] Jose Caballero et al. “Real-time video super-resolution with spatiotemporal networks and motion compensation”. In: Proceedings of the IEEE conference on computer vision and pattern recognition. 2017, pp. 4778−4787.
[52] Xun Cao et al. “Computational snapshot multispectral cameras: Toward dynamic capture of the spectral world”. In: IEEE Signal Processing Magazine 33.5 (2016), pp. 95−108.
[53] J F Cardenas-Garcia, HG Yao, and S Zheng. “3D reconstruction of objects using stereo imaging”. In: Optics and Lasers in Engineering 22.3 (1995), pp. 193−213.
[54] Marcela Carvalho et al. “Deep depth from defocus: how can defocus blur improve 3D estimation using dense neural networks?” In: Proceedings of the European Conference on Computer Vision (ECCV) Workshops. 2018.
[55] W. T. Cathey et al. “Image gathering and processing for enhanced resolution”. In: JOSA A 1.3 (1984), pp. 241−250.
[57] Chin-Cheng Chan and Homer H Chen. “Autofocus by deep reinforcement learning”. In: Electronic Imaging 2019.4 (2019), pp. 577−1.
[60] Chih-Yung Chen, Rey-Chue Hwang, and Yu-Ju Chen. “A passive auto-focus camera control system”. In: Applied Soft Computing 10.1 (2010), pp. 296−303.
[62] Weifeng Chen et al. “Single-image depth perception in the wild”. In: Advances in neural information processing systems 29 (2016).
[64] Yeou-Yen Cheng and James C Wyant. “Phase shifter calibration in phase-shifting interferometry”. In: Applied optics 24.18 (1985), pp. 3049−3052.
[75] Daniel DeTone, Tomasz Malisiewicz, and Andrew Rabinovich. “Deep image homography estimation”. In: arXiv preprint arXiv: 1606.03798 (2016).
[83] Ronald G Driggers, Van Hodgkin, and Richard Vollmerhausen. “What good is SWIR? Passive day comparison of VIS, NIR, and SWIR”. In: Infrared Imaging Systems: Design, Analysis, Modeling, and Testing XXIV. Vol. 8706. SPIE. 2013, pp. 187−201.
[86] Matthew Dunlop-Gray et al. “Experimental demonstration of an adaptive architecture for direct spectral imaging classification”. In: Optics express 24.16 (2016), pp. 18307−18321.
[91] Harold E Edgerton. Computers and strobes. 1985.
[98] Florian Engels et al. “Automotive radar signal processing: Research directions and practical challenges”. In: IEEE Journal of Selected Topics in Signal Processing 15.4 (2021), pp. 865−878.
[101] Robert D Fiete. Modeling the imaging chain of digital cameras. SPIE press Bellingham, Washington, 2010.
[102] William J Fleming. “Overview of automotive sensors”. In: IEEE sensors journal 1.4 (2001), pp. 296-308.
[103] Sergi Foix, Guillem Alenya, and Carme Torras. “Lock-in Time-of-Flight (ToF) Cameras: A Survey”. In: IEEE Sensors Journal 11.9 (2011), pp. 1917−1926.
[104] E. R. Fossum. “CMOS image sensors: electronic camera-on-a-chip”. In: IEEE Transactions on Electron Devices 44.10 (1997), pp. 1689−1698.
[109] J. G. D. M. Franca et al. “A 3D scanning system based on laser triangulation and variable field of view”. In: IEEE International Conference on Image Processing 2005. Vol. 1. 2005, pp. I-425. doi: 10. 1109/ICIP.2005.1529778.
[110] Guillermo Gallego et al. “Event-based vision: A survey”. In: IEEE transactions on pattern analysis and machine intelligence 44.1 (2020), pp. 154−180.
[111] Mark Gamadia and Nasser Kehtarnavaz. “A filter-switching autofocus framework for consumer camera imaging systems”. In: IEEE Transactions on Consumer Electronics 58.2 (2012).
[112] Mark Gamadia and Nasser Kehtarnavaz. “Performance metrics for auto-focus in digital and cell-phone cameras”. In: Consumer Electronics (ICCE), 2010 Digest of Technical Papers International Conference on. IEEE. 2010, pp. 69−70.
[118] Nahum Gat. “Imaging spectroscopy using tunable filters: a review”. In: Wavelet Applications VII 4056 (2000), pp. 50−64.
[118] M.J.E. Golay. “Multislit spectroscopy”. In: J. Opt. Soc. Amer. 39 (1949), pp. 437−444.
[124] Jinwei Gu et al. “Coded rolling shutter photography: Flexible spacetime sampling”. In: 2010 IEEE International Conference on Computational Photography (ICCP). IEEE. 2010, pp. 1−8.
[126] Brian Guenter et al. “Highly curved image sensors: a practical approach for improved optical performance”. In: Optics express 25.12 (2017), pp. 13010−13023.
[127] Chenzi Guo et al. “Fast auto-focusing search algorithm for a highspeed and high-resolution camera based on the image histogram feature function”. In: Applied Optics 57.34 (2018), F44-F49.
[128] Junpeng Guo and David Brady. “Fabrication of thin-film micropolarizer arrays for visible imaging polarimetry”. In: Applied Optics 39.10 (2000), pp. 1486−1492.
[129] Chen Guojin et al. “The image auto-focusing method based on artificial neural networks”. In: Computational Intelligence for Measurement Systems and Applications (CIMSA), 2010 IEEE International Conference on. IEEE. 2010, pp. 138−141.
[131] Masataka Hamada. Imaging device including phase detection pixels arranged to perform capturing and to detect phase difference. U.S. Pat. No. 9,197,807. 2015.
[133] Jong-Woo Han et al. “A novel training based auto-focus for mobilephone cameras”. In: IEEE Transactions on Consumer Electronics 57.1 (2011).
[136] Jie He, Rongzhen Zhou, and Zhiliang Hong. “Modified fast climbing search auto-focus algorithm with adaptive step size searching technique for digital camera”. In: IEEE transactions on Consumer Electronics 49.2 (2003), pp. 257−262.
[137] Dennis Healy and David J. Brady. “Compression at the Physical Interface”. In: IEEE Signal Processing Magazine 25.2 (2008), pp. 67−71. doi: 10.1109/MSP.2007.914996.
[140] Rainer Heintzmann and Thomas Huser. “Super-resolution structured illumination microscopy”. In: Chemical reviews 117.23 (2017), pp. 13890−13908.
[141] Stefan W Hell and Jan Wichmann. “Breaking the diffraction resolution limit by stimulated emission: stimulated-emission-depletion fluorescence microscopy”. In: Optics letters 19.11 (1994), pp. 780−782.
[143] Simon Hill. “From J-Phone to Lumia 1020: A complete history of the camera phone”. In: Digital Trends 11 (2013), p. 19. url: https://www.digitaltrends.com/mobile/camera-phone-history/.
[145] Seung-Hyun Hong, Ju-Seog Jang, and Bahram Javidi. “Three-dimensional volumetric object reconstruction using computational integral imaging”. In: Optics Express 12.3 (2004), pp. 483−491.
[148] Radu Horaud et al. “An overview of depth cameras and range scanners based on time-of-flight technologies”. In: Machine vision and applications 27.7 (2016), pp. 1005−1020.
[149] Ryoichi Horisaki and Jun Tanida. “Multi-channel data acquisition using multiplexed imaging with spatial encoding”. In: Opt. Express 18.22 (2010), pp. 23041−23053. doi: 10.1364/OE.18.023041. url: https://opg. optica. org/oe/abstract. cfm? URI=oe18 22-23041.
[153] Richard Howells. “Louis Le Prince: the body of evidence”. In: Screen 47.2 (2006), pp. 179−200.
[154] Chi-Chang Hsieh, Yan-Huei Li, and Chih-Ching Hung. “Modular design of the LED vehicle projector headlamp system”. In: Applied optics 52.21 (2013), pp. 5221−5229.
[155] Minghao Hu et al. “Sampling for Snapshot Compressive Imaging”. In: Intelligent Computing 2 (2023), p. 0038.
[156] Qian Huang, Minghao Hu, and David J Brady. “Array Camera Image Fusion using Physics-Aware Transformers”. In: Journal of Imaging Science and Technology 66 (2022), pp. 1−14.
[159] Chuan-Cheng Hung et al. “Optical design of automotive headlight system incorporating digital micromirror device”. In: Applied optics 49.22 (2010), pp. 4182−4187.
[161] Aapo Hyvarinen and Erkki Oja. “Independent component analysis: algorithms and applications”. In: Neural networks 13.4-5 (2000), pp. 411−430.
[163] Jinbeum Jang et al. “Sensor-based auto-focusing system using multiscale feature extraction and phase correlation matching”. In: Sensors 15.3 (2015), pp. 5747−5762.
[164] Shaowei Jiang et al. “Transform-and multi-domain deep learning for single-frame rapid autofocusing in whole slide imaging”. In: Biomedical optics express 9.4 (2018), pp. 1601−1612.
[165] Ian T Jolliffe and Jorge Cadima. “Principal component analysis: a review and recent developments”. In: Philosophical transactions of the royal society A: Mathematical, Physical and Engineering Sciences 374.2065 (2016), p. 20150202.
[166] Kelsey M Judd, Michael P Thornton, and Austin A Richards. “Automotive sensing: Assessing the impact of fog on LWIR, MWIR, SWIR, visible, and lidar performance”. In: Infrared Technology and Applications XLV. Vol. 11002. SPIE. 2019, pp. 322−334.
[172] Spyros Kavadias et al. “A logarithmic response CMOS image sensor with on-chip calibration”. In: IEEE Journal of Solid-state circuits 35.8 (2000), pp. 1146−1152.
[173] Steven Kay. “A fast and accurate single frequency estimator”. In: IEEE Transactions on Acoustics, Speech, and Signal Processing 37.12 (1989), pp. 1987−1990.
[174] Nasser Kehtarnavaz and H-J Oh. “Development and real-time implementation of a rule-based auto-focus algorithm”. In: Real-Time Imaging 9.3 (2003), pp. 197−203.
[175] Bernhard Kerbl et al. “3d gaussian splatting for real-time radiance field rendering”. In: ACM Transactions on Graphics 42.4 (2023), pp. 1−14.
[178] Rudolf Kingslake. A history of the photographic lens. Academic press, 1989.
[179] Rudolf Kingslake and R Barry Johnson. Lens design fundamentals. academic press, 2009.
[181] Pavan Chandra Konda et al. “Fourier ptychography: current applications and future promises”. In: Optics express 28.7 (2020), pp. 9603−9630.
[184] Alex Krizhevsky, Geoffrey Hinton, et al. “Learning multiple layers of features from tiny images”. In: (2009).
[197] Marc Levoy and Turner Whitted. “The use of points as a display primitive”. In: (1985).
[199] You Li and Javier Ibanez-Guzman. “Lidar for autonomous driving: The principles, challenges, and trends for automotive lidar and perception systems”. In: IEEE Signal Processing Magazine 37.4 (2020), pp. 50-61.
[200] You Li, Julien Moreau, and Javier Ibanez-Guzman. “Emergent visual sensors for autonomous vehicles”. In: IEEE Transactions on Intelligent Transportation Systems 24.5 (2023), pp. 4716−4737.
[205] Peidong Liu et al. “Deep shutter unrolling network”. In: Proceedings of the IEEE/CVF Conference on Computer Vision and Pattern Recognition. 2020, pp. 5941−5949.
[206] Peng Liu et al. “A Heterogeneous Architecture for the Vision Processing Unit with a Hybrid Deep Neural Network Accelerator”. In: Micromachines 13.2 (2022), p. 268.
[208] Gareth A Lloyd and Steven J Sasson. Electronic still camera. U.S. Pat. No. 4,131,919. 1978.
[209] Patrick Llull et al. “Characterization of the AWARE 40 wide-field-of-view visible imager”. In: Optica 2.12 (2015), pp. 1086−1089.
[210] Patrick Llull et al. “Coded aperture compressive temporal imaging”. In: Optics express 21.9 (2013), pp. 10526−10545.
[211] Patrick Llull et al. “Image translation for single-shot focal tomography”. In: Optica 2.9 (2015), pp. 822-825.
[212] Adolf W. Lohmann. “Scaling laws for lens systems”. In: Appl. Opt. 28.23 (1989), p. 4996.
[216] Rudolf Karl Luneburg. Mathematical theory of optics. Univ of California Press, 1966.
[218] Richard F Lyon. “A brief history of ‘pixel’”. In: Digital Photography II. Vol. 6069. SPIE. 2006, p. 606901.
[219] Xiao Ma, Xin Yuan, and Gonzalo R Arce. “High Resolution LED-based Snapshot Compressive Spectral Video Imaging with Deep Neural Networks”. In: IEEE Transactions on Computational Imaging (2023).
[220] Abhijit Mahalanobis et al. “Recent developments in coded aperture multiplexed imaging systems”. In: Visual Information Processing XVII 6978 (2008), pp. 115−122.
[226] Rafal Mantiuk, Karol Myszkowski, and Hans-Peter Seidel. “A perceptual framework for contrast processing of high dynamic range images”. In: ACM Transactions on Applied Perception (TAP) 3.3 (2006), pp. 286−308.
[231] Daniel L Marks and David J Brady. “Wide-field astronomical multiscale cameras”. In: The Astronomical Journal 145.5 (2013), p. 128.
[233] Daniel L Marks et al. “Characterization of the AWARE 10 two-gigapixel wide-field-of-view visible imager”. In: Applied optics 53.13 (2014), pp. C54-C63.
[234] Manuel Martinez-Corral and Bahram Javidi. “Fundamentals of 3D imaging and displays: a tutorial on integral imaging, light-field, and plenoptic systems”. In: Advances in Optics and Photonics 10.3 (2018), pp. 512-566.
[236] Olha Melnyk et al. “Fast switching dual-frequency nematic liquid crystal tunable filters”. In: ACS photonics 8.4 (2021), pp. 1222−1231.
[237] Yitzhak Mendelson. “Pulse oximetry: theory and applications for noninvasive monitoring”. In: Clinical chemistry 38.9 (1992), pp. 1601−1607.
[238] Ziyi Meng et al. “Self-Supervised Neural Networks for Spectral Snapshot Compressive Imaging”. In: Proceedings of the IEEE/CVF International Conference on Computer Vision (ICCV). 2021, pp. 2622−2631.
[239] Ben Mildenhall et al. “Nerf: Representing scenes as neural radiance fields for view synthesis”. In: Communications of the ACM 65.1 (2021), pp. 99−10⁶.
[241] Hashim Mir et al. “An autofocus heuristic for digital cameras based on supervised machine learning”. In: Journal of Heuristics 21.5 (2015), pp. 599−616.
[244] Eadweard Muybridge. Animal locomotion. Vol. 534. Da Capo Press Cambridge, MA, 1887.
[247] M. A. Neifeld and P. Shankar. “Feature-specific imaging”. In: Appl. Opt. 42.17 (2003), pp. 3379−3389.
[250] Ren Ng. “Fourier slice photography”. In: SIGGRAPH ‘05: ACM SIGGRAPH 2005 Papers. Los Angeles, California: ACM, 2005, pp. 735−744.
[252] Felix Nobis et al. “A deep learning-based radar and camera sensor fusion architecture for object detection”. In: 2019 Sensor Data Fusion: Trends, Solutions, Applications (SDF). IEEE. 2019, pp. 1−7.
[255] Omar E Olarte et al. “Light-sheet microscopy: a tutorial”. In: Advances in Optics and Photonics 10.1 (2018), pp. 111−179.
[257] World Health Organization. Global status report on road safety 2023. World Health Organization, 2023.
[259] David Padua. Encyclopedia of parallel computing. Springer Science & Business Media, 2011.
[260] Russ Palum. “How many photons are there?” In: IS and TS PICS conference. Society for Imaging Science and Technology. 2002, pp. 203−206.
[261] Wubin Pang and David J Brady. “Field of view in monocentric multiscale cameras”. In: Applied optics 57.24 (2018), pp. 6999−7005.
[267] Andrew D Payne et al. “Multiple frequency range imaging to remove measurement ambiguity”. In: Optical 3-d measurement techniques. 2009.
[268] Alexandros Pertsinidis, Yunxiang Zhang, and Steven Chu. “Subnanometre single-molecule localization, registration and distance measurements”. In: Nature 466.7306 (2010), pp. 647−651.
[270] Duc Truong Pham and Veysel Aslantas. “Depth from defocusing using a neural network”. In: Pattern Recognition 32.5 (1999), pp. 715−727.
[272] Henry Pinkard et al. “Deep learning for single-shot autofocus microscopy”. In: Optica 6.6 (2019), pp. 794−797.
[273] Tomi Pitka “aho, Aki Manninen, and Thomas J Naughton. “Performance of autofocus capability of deep convolutional neural networks in digital holographic microscopy”. In: Digital Holography and Three Dimensional Imaging. Optical Society of America. 2017, W2A-5.
[278] Dalong Qi et al. “Single-shot compressed ultrafast photography: a review”. In: Advanced Photonics 2.1 (2020), p. 014003. doi: 10.1117/1.AP.2.1.014003. url: https://doi.org/10.1117/1.AP.2.1. 014003.
[279] Barry G Quinn and Edward James Hannan. The estimation and tracking of frequency. 9. Cambridge University Press, 2001.
[282] Aakanksha Rana et al. “Deep tone mapping operator for high dynamic range images”. In: IEEE Transactions on Image Processing 29 (2019), pp. 1285−1298.
[283] Ramesh Raskar, Amit Agrawal, and Jack Tumblin. “Coded exposure photography: motion deblurring using fluttered shutter”. In: Acm Siggraph 2006 Papers. 2006, pp. 795−804.
[285] Erik Reinhard and Kate Devlin. “Dynamic range reduction inspired by photoreceptor physiology”. In: IEEE transactions on visualization and computer graphics 11.1 (2005), pp. 13−24.
[286] Zhenbo Ren, Zhimin Xu, and Edmund Y Lam. “Learning-based nonparametric autofocusing for digital holography”. In: Optica 5.4 (2018), pp. 337−344.
[300] Jos′e Sasia′n. Introduction to aberrations in optical imaging systems. Cambridge University Press, 2013.
[301] Jos′e Sasia′n. Introduction to lens design. Cambridge University Press, 2019.
[303] Manish Saxena, Gangadhar Eluru, and Sai Siva Gorthi. “Structured illumination microscopy”. In: Advances in Optics and Photonics 7.2 (2015), pp. 241−275.
[307] Eli Schwartz, Raja Giryes, and Alex M Bronstein. “Deepisp: Toward learning an end-to-end image processing pipeline”. In: IEEE Transactions on Image Processing 28.2 (2018), pp. 912−923.
[311] J. Sharpe. “Optical projection tomography”. In: Annual Review of Biomedical Engineering 6 (2004), pp. 209−228.
[316] Rui Shogenji et al. “Multispectral imaging using compact compound optics”. In: Optics Express 12.8 (2004), pp. 1643−1655.
[318] David Silver et al. “Mastering the game of Go with deep neural networks and tree search”. In: nature 529.7587 (2016), pp. 484−489.
[323] Przemyslaw S′liwin′ski and Pawel Wachel. “A simple model for on-sensor phase-detection autofocusing algorithm”. In: Journal of Computer and Communications 1.06 (2013), pp. 11−17.
[326] Norman L Stauffer. Active auto focus system improvement. U.S. Pat. No. 4,367,027. 1983.
[327] Stanley S Stevens and Eugene H Galanter. “Ratio scales and category scales for a dozen perceptual continua.” In: Journal of experimental psychology 54.6 (1957), p. 377.
[330] Ching-Cherng Sun et al. “Review of optical design for vehicle forward lighting based on white LEDs”. In: Optical Engineering 60.9 (2021), pp. 091501−091501.
[331] Yongjin Sung et al. “Optical diffraction tomography for high resolution live cell imaging”. In: Opt. Express 17.1 (2009), pp. 266−277. doi: 10.1364/OE.17.000266. url: http://opg.optica.org/oe/abstract.cfm?URI=oe-17−1−266.
[333] Takashi Suzuki, Susumu Matsumura, and Keiji Ohtaka. Camera with active optical range finder. U.S. Pat. No. 4,534,637. 1985.
[335] Ichiro Tamitani et al. “A real-time video signal processor suitable for motion picture coding applications”. In: IEEE Transactions on Circuits and Systems 36.10 (1989), pp. 1259−1266.
[336] Yang Tan et al. “CrossNet++: Cross-Scale Large-Parallax Warping for Reference-Based Super-Resolution”. In: IEEE Transactions on Pattern Analysis and Machine Intelligence 43.12 (2021), pp. 4291−4305.
[343] Tsung-Han Tsai and David J Brady. “Coded aperture snapshot spectral polarization imaging”. In: Applied optics 52.10 (2013), pp. 2153−2161.
[344] Tsung-Han Tsai et al. “Spectral-temporal compressive imaging”. In: Optics letters 40.17 (2015), pp. 4054−4057.
[345] Kevin K. Tsia et al. “Performance of serial time-encoded amplified microscope”. In: Opt. Express 18.10 (2010), pp. 10016−10028. doi: 10. 1364/OE. 18. 010016. url: https://opg. optica. org/oe/abstract.cfm?URI=oe-18-10-10016.
[349] Robert K Tyson and Benjamin West Frazier. Principles of adaptive optics. CRC press, 2022.
[351] Shikhar Uttam et al. “Optically multiplexed imaging with superposition space tracking”. In: Opt. Express 17.3 (2009), pp. 1691−1713.
[354] Ashok Veeraraghavan, Dikpal Reddy, and Ramesh Raskar. “Coded Strobing Photography: Compressive Sensing of High Speed Periodic Videos”. In: IEEE Transactions on Pattern Analysis and Machine Intelligence 33.4 (2011), pp. 671−686. doi: 10.1109/TPAMI.2010.87.
[355] Esteban Vera, Felipe Guzma′n, and Nelson D′iaz. “Shuffled rolling shutter for snapshot temporal imaging”. In: Opt. Express 30.2 (2022), pp. 887−901. doi: 10.1364/OE.444864. url: https://opg.optica. org/oe/abstract.cfm?URI=oe-30-2-887.
[359] Chengyu Wang et al. “Deep learning for camera autofocus”. In: IEEE Transactions on Computational Imaging 7 (2021), pp. 258−271.
[365] Lishun Wang et al. “Spatial-temporal transformer for video snapshot compressive imaging”. In: IEEE Transactions on Pattern Analysis and Machine Intelligence (2022).
[366] Ping Wang et al. “Full-resolution and full-dynamic-range coded aperture compressive temporal imaging”. In: Opt. Lett. 48.18 (2023), pp. 4813−4816. doi: 10.1364/OL.499735. url: https://opg.optica.org/ol/abstract.cfm?URI=ol-48−18−4813.
[367] Xiao Wang et al. “Integrated photonic encoder for terapixel image processing”. In: arXiv preprint arXiv: 2306.04554 (2023).
[368] Zhaoyang Wang, Dung A Nguyen, and John C Barnes. “Some practical considerations in fringe projection profilometry”. In: Optics and Lasers in Engineering 48.2 (2010), pp. 218−225.
[370] Zhou Wang et al. “Image quality assessment: from error visibility to structural similarity”. In: IEEE transactions on image processing 13.4 (2004), pp. 600−612.
[371] Ling Wei and Elijah Roberts. “Neural network control of focal position during time-lapse microscopy of cells”. In: Scientific reports 8.1 (2018), pp. 7313.1−7313.10.
[381] Jing Xu and Song Zhang. “Status, challenges, and future perspectives of fringe projection profilometry”. In: Optics and Lasers in Engineering 135 (2020), p. 106193.
[382] Nancy Xu et al. “Image keypoint matching using graph neural networks”. In: Complex Networks & Their Applications X: Volume 2, Proceedings of the Tenth International Conference on Complex Networks and Their Applications COMPLEX NETWORKS 2021 10. Springer. 2022, pp. 441−451.
[383] Xuefei Yan et al. “Compressive sampling for array cameras”. In: SIAM Journal on Imaging Sciences 14.1 (2021), pp. 156−177.
[385] Yi Yao et al. “Evaluation of sharpness measures and search algorithms for the auto focusing of high-magnification images”. In: Visual Information Processing XV. Vol. 6246. International Society for Optics and Photonics. 2006, 62460G.
[386] Yuhong Yao. Wide field of view five element lens system. U.S. Pat. No. 10,921,558. 2021.
[388] Fumihito Yasuma et al. “Generalized assorted pixel camera: postcapture control of resolution, dynamic range, and spectrum”. In: IEEE transactions on image processing 19.9 (2010), pp. 2241−2253.
[389] Kentaro Yoshioka. “A tutorial and review of automobile direct ToF LiDAR SoCs: Evolution of next-generation LiDARs”. In: IEICE Transactions on Electronics 105.10 (2022), pp. 534−543.
[391] Siamak Yousefi, M Rahman, and Nasser Kehtarnavaz. “A new autofocus sharpness function for digital and smart-phone cameras”. In: IEEE Transactions on Consumer Electronics 57.3 (2011).
[392] Xiaoyun Yuan et al. “A modular hierarchical array camera”. In: Light: Science & Applications 10.1 (2021), p. 37.
[394] Xin Yuan et al. “Efficient patch-based approach for compressive depth imaging”. In: Applied Optics 55.27 (2016), pp. 7556−7564.
[395] Franco Zappa et al. “Principles and features of single-photon avalanche diode arrays”. In: Sensors and Actuators A: Physical 140.1 (2007), pp. 103-112.
[397] Lingzhi Zhang, Tarmily Wen, and Jianbo Shi. “Deep image blending”. In: Proceedings of the IEEE/CVF winter conference on applications of computer vision. 2020, pp. 231−240.
[401] Xiaojin Zhao et al. “Thin photo-patterned micropolarizer array for CMOS image sensors”. In: IEEE Photonics Technology Letters 21.12 (2009), pp. 805−807.
[402] G Zheng, R Horstmeyer, and CI Yang. “Wide-field, high-resolution Fourier ptychographic microscopy”. In: Nature Photonics 7.9 (2013), pp. 739−745.
[404] Guoan Zheng et al. “Concept, implementations and applications of Fourier ptychography”. In: Nature Reviews Physics 3.3 (2021), pp. 207−223.
[405] Ziguo Zhong et al. “Camera radar fusion for increased reliability in ADAS applications”. In: Electronic Imaging 30 (2018), pp. I-4.
[407] Yong Zhou et al. “Review on millimeter-wave radar and camera fusion technology”. In: Sustainability 14.9 (2022), p.5114.
[408] Jiejie Zhu et al. “Fusion of time-of-flight depth and stereo for high accuracy depth maps”. In: 2008 IEEE conference on computer vision and pattern recognition. IEEE. 2008, pp. 1−8.
[409] Blahnik et al, Smartphone imaging technology and its applications, Advanced Optical Technologies, 2021 Jun. 1;10 (3): 145-232.
[410] Yan et al, Compressive sampling for array cameras, SIAM Journal on Imaging Sciences. 2021; 14 (1): 156-77.
[411] Wang et al, Integrated photonic encoder for low power and high-speed image processing. Nature Communications. 2024 May 27;15 (1): 4510.

1. A heterogeneous camera array comprising plural imagers, wherein one of said imagers produces monochromatic data, one of said imagers includes a filter array and produces plural differently-filtered channels of data, one of said imagers has a first focal length, one of said imagers has a second focal length different than the first focal length, one of said imagers produces data at a first frame rate, and one of said imagers produces data at a second frame rate different than the first frame rate.

2. The heterogeneous camera array of claim 1 in which first and second of said plural imagers each includes a lens assembly comprising plural lens elements and a variable focus actuator, wherein the variable focus actuator of the first imager serves to move one or more—but not all—of the lens elements of the first imager lens assembly.

3. The heterogeneous camera array of claim 2 in which the variable focus actuator of the second imager serves to move all of the lens elements of the second imager lens assembly.

4. The heterogeneous camera array of claim 1 in which plural of said imagers produce monochromatic data.

5. The heterogeneous camera array of claim 1 in which plural of said imagers include a filter array and produce plural differently-filtered channels of data.

6. The heterogeneous camera array of claim 1 in which plural of said imagers has said first focal length.

7. The heterogeneous camera array of claim 1 in which plural of said imagers has said second focal length.

8. The heterogeneous camera array of claim 1 in which plural of said imagers produce data at said first frame rate.

9. (canceled)

10. A heterogeneous camera array comprising multiple imagers, wherein plural of said imagers produce monochromatic data, plural of said imagers include a filter array and produce plural differently-filtered channels of data, plural of said imagers produce data at a first frame rate, and plural of said imagers produce data at a second frame rate different than the first frame rate.

11. The heterogeneous camera array of claim 10 in which first and second of said plural imagers each includes a lens assembly comprising plural lens elements and a variable focus actuator, wherein the variable focus actuator of the first imager serves to move one or more—but not all—of the lens elements of the first imager lens assembly.

12. The heterogeneous camera array of claim 11 in which the variable focus actuator of the second imager serves to move all of the lens elements of the second imager lens assembly.

13. The heterogeneous camera array of any of claim 10 in which said multiple imagers include imagers having three different focal lengths.

14. The heterogeneous camera array of claim 10 in which said multiple imagers include imagers having four different focal lengths.

15. (canceled)

16. (canceled)

17. (canceled)

18. The heterogeneous camera array of claim 10 in which plural of said imagers include a color filter array.

19. (canceled)

20. (canceled)

21. (canceled)

22. The heterogeneous camera array of claim 25 in which most of said N camera modules are microcameras comprising a lens and an electronic sensor forever coupled together.

23. The heterogeneous camera array of claim 25 in which two of said camera modules have focal lengths in a ratio k, where 1<k<1.4.

24. The heterogeneous camera array of claim 25 in which two of said camera modules have focal lengths in a ratio k, where k≥10.

25. An array camera system including first and second imagers, each including a lens assembly comprising plural lens elements and a variable focus actuator, wherein the variable focus actuator of the first imager serves to move one or more—but not all—of the lens elements of the first imager lens assembly.

26. The array camera system of claim 25 in which the variable focus actuator of the second imager serves to move all of the lens elements of the second imager lens assembly.

27. The array camera system of claim 25 comprising N camera modules of M different capture configurations, where M is at least 4, and N is at least 2, 3, 5 or 10 times greater than M.
